(19) United States
(12) Patent Application Publication
(10) Pub. No.: US 2026/0230972 A1
(43) Pub. Date: Aug. 6, 2026

(54) MANAGING USER EQUIPMENT ACCESS TO A CELL IN A FAST SERVING CELL CHANGE

(71) Applicant: GOOGLE LLC, Mountain View, CA (US)

(72) Inventor: Chih-Hsiang Wu, Taoyuan City (TW)

(21) Appl. No.: 19/155,091

(22) PCT Filed: Feb. 13, 2024
(86) PCT No.: PCT/US2024/015459

§ 371 Date: Aug. 8, 2025

Related U.S. Application Data
(60) Provisional application No. 63/445,700, filed on Feb. 14, 2023.

(51) Int. Cl. H04W 36/08

(52) U.S. Cl. CPC H04W 36/08

(57) ABSTRACT

A radio access network (RAN) node can implement a method for managing lower layer triggered mobility protocol procedure(s). The method includes: transmitting, from the RAN node to a user equipment (UE) communicatively coupled to the RAN node via a serving cell, a lower layer triggered mobility (LTM) configuration to configure a non-serving cell for the UE; in a first instance, when the non-serving cell is synchronized with the serving cell, transmitting, from the RAN node to the UE, a first indication for the UE to perform a serving cell change to the non-serving cell and refrain from performing a random access procedure; and in a second instance, when the non-serving cell is not synchronized with the serving cell, transmitting, from the RAN node to the UE, a second indication for the UE to perform the serving cell change and perform the random access procedure.

### CROSS-REFERENCE TO RELATED APPLICATIONS

This application claims priority to and the benefit of the filing date of provisional U.S. Patent Application No. 63/445,700 entitled “MANAGING USER EQUIPMENT ACCESS TO A CELL IN A FAST SERVING CELL CHANGE,” filed on Feb. 14, 2023. The entire contents of the provisional applications are hereby expressly incorporated herein by reference.

### FIELD OF THE DISCLOSURE

This disclosure relates to wireless communications and, more particularly, to managing user equipment (UE) access to a cell in a fast serving cell change.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP technical specification (TS) 36.323) and New Radio (NR) (see 3GPP TS 38.323) provides sequencing of protocol data units (PDUs) in the uplink direction (from a user device, also known as a user equipment (UE), to a base station) as well as in the downlink direction (from the base station to the UE). Further, the PDCP sublayer provides signaling radio bearers (SRBs) and data radio bearers (DRBs) to the Radio Resource Control (RRC) sublayer. Generally speaking, in some examples, the UE and a base station use SRBs to exchange RRC messages as well as non-access stratum (NAS) messages, and can use DRBs to transport data on a user plane.

Depending on the scenario, UEs use several types of SRBs and DRBs. When operating in dual connectivity (DC), the cells associated with the base station operating the master node (MN) define a master cell group (MCG), and the cells associated with the base station operating as the secondary node (SN) define the secondary cell group (SCG). SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN. The SRB1 and SRB 2 resources can be referred to as MCG SRBs. SRB3 resources allow the UE and the SN to exchange RRC messages related to the SN and can be referred to as SCG SRBs. Split SRBs allow the UE to exchange RRC messages directly with the MN via lower layer resources of the MN and the SN. Further, DRBs using the lower-layer resources of only the MN can be referred as MCG DRBs, DRBs using the lower-layer resources of only the SN can be referred as SCG DRBs, and DRBs using the lower-layer resources of both the MCG and the SCG can be referred to as split DRBs.

The UE, in some scenarios, concurrently utilizes resources of multiple radio access network (RAN) nodes (e.g., base stations or components of a distributed base station), interconnected by a backhaul. When such network nodes support different radio access technologies (RATs), this type of connectivity is referred to as Multi-Radio Dual Connectivity (MR-DC). When a UE operates in MR-DC, one base station operates as a master node (MN) that covers a primary cell (PCell), and the other base station operates as a secondary node (SN) that covers a primary secondary cell (PSCell). The UE communicates with the MN (via the PCell) and the SN (via the PSCell). In other scenarios, the UE utilizes resources of one base station at a time. One base station and/or the UE determines that the UE should establish a radio connection with another base station. For example, one base station determines to hand the UE over to the second base station and initiate a handover procedure.

When the UE moves from the coverage area of one cell to another cell in a RAN, the RAN should configure the UE for a serving cell change. To perform the serving cell change, the RAN configures the UE to transmit Layer 3 (L3) measurement results. Based on L3 measurement results received from the UE, the RAN transmits an RRC reconfiguration message, configuring Reconfiguration with Synchronization (e.g., the RRC reconfiguration message includes a Reconfiguration WithSync IE) for the change of the serving cell (e.g., PCell or PSCell). In cases where the UE operates in carrier aggregation (CA) of at least one secondary cell (SCell) with the PCell or PSCell, the RAN releases the at least one SCell due to the change of the PCell or PSCell. The serving cell change involves complete L2 (and L1) resets, leading to longer latency, larger overhead, and longer interruption time. Thus, it is desirable to develop new mobility procedures to reduce latency and overhead for fast serving cell change. However, it is not clear how to configure and manage the UE to access a new serving cell in the new mobility procedures.

### SUMMARY

An example embodiment of the techniques of this disclosure is a method implemented in a radio access network (RAN) node, the method comprising: transmitting, from the RAN node to a user equipment (UE) communicatively coupled to the RAN node via a serving cell, a lower layer triggered mobility (LTM) configuration to configure a non-serving cell for the UE; in a first instance, when the non-serving cell is synchronized with the serving cell, transmitting, from the RAN node to the UE, a first indication for the UE to perform a serving cell change to the non-serving cell and refrain from performing a random access procedure; and in a second instance, when the non-serving cell is not synchronized with the serving cell, transmitting, from the RAN node to the UE, a second indication for the UE to perform the serving cell change and perform the random access procedure.

Another example embodiment of these techniques is a method implemented in a user equipment (UE), the method comprising: receiving, at the UE from a radio access network (RAN) node communicatively coupled to UE via a serving cell, a lower layer triggered mobility (LTM) configuration to configure a non-serving cell for the UE; in a first instance, when the non-serving cell is synchronized with the serving cell, receiving, from the RAN node, a first indication to perform a serving cell change to the non-serving cell and refrain from performing a random access procedure; and in a second instance, when the non-serving cell is not synchronized with the serving cell, transmitting, from the RAN node, a second indication to perform the serving cell change and perform the random access procedure.

Another example embodiment of these techniques is an apparatus, operating as a radio access network (RAN) node, comprising processing hardware and configured to implement the methods above.

Another example embodiment of these techniques is an apparatus, operating as a user equipment (UE), comprising processing hardware and configured to implement the methods above.

### BRIEF DESCRIPTION OF THE DRAWINGS

FIG. 1A is a block diagram of an example system in which a radio access network (RAN) and a user device can implement the techniques of this disclosure for managing conditional procedures related to a secondary node (SN);

FIG. 1B is a block diagram of an example base station including a centralized unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3 is a messaging diagram of an example scenario where a CU provides a reference lower layer triggered mobility configures to a DU for generating a configuration for a UE;

FIG. 4 is a messaging diagram of an example scenario similar to that of FIG. 3, but in which the base station includes a source DU (S-DU) and target DU (T-DU);

FIG. 5A is a messaging diagram of an example scenario similar to that of FIG. 3, but in which the UE communicates in DC with an MN and an SN;

FIG. 5B is a messaging diagram of an example scenario similar to that of FIG. 5A, but in which the CU provides the reference lower layer triggered mobility configuration to the UE via the MN;

FIG. 6A is a messaging diagram of an example scenario similar to that of FIG. 3, but in which the CU communicates with an S-DU and a T-DU in the SN;

FIG. 6B is a messaging diagram of an example scenario similar to that of FIG. 6A, but in which the CU provides the reference lower layer triggered mobility configuration to the UE via the MN;

FIG. 7A is a messaging diagram of an example scenario similar to that of FIG. 3, but in which the CU communicates with an M-DU and an S-DU;

FIG. 7B is a messaging diagram of an example scenario similar to that of FIG. 7A, but in which the CU provides the reference lower layer triggered mobility configuration to the UE via the M-DU;

FIG. 8A is a messaging diagram of an example scenario similar to that of FIG. 3, but in which the CU communicates with an M-DU, an S-DU, and a T-DU;

FIG. 8B is a messaging diagram of an example scenario similar to that of FIG. 8A, but in which the CU provides the reference lower layer triggered mobility configuration to the UE via the M-DU;

FIG. 9A is a flow diagram depicting an example method, implemented in a DU, in which the DU determines whether to generate an LTM configuration that configures the UE to perform or not perform a random access procedure based on whether a cell synchronizes with a serving cell;

FIG. 9B is a flow diagram depicting an example method similar to that of FIG. 9A, but in which the DU makes the determination based on whether the DU is a serving DU of the UE;

FIG. 9C is a flow diagram depicting an example method similar to that of FIG. 9A, but in which the DU makes the determination based on whether a message from the CU is a UE context setup request or a UE context modification request message;

FIG. 9D is a flow diagram depicting an example method similar to that of FIG. 9A, but in which the DU makes the determination based on whether the UE supports RACH-less LTM;

FIG. 9E is a flow diagram depicting an example method similar to that of FIG. 9A, but in which the DU makes the determination based on whether the UE supports deriving uplink transmission timing based on reference signal(s);

FIG. 9F is a flow diagram depicting an example method similar to that of FIG. 9A, but in which the DU makes the determination based on whether a message from the CU requests to configure the UE to perform a random access procedure upon receipt of an LTM command;

FIG. 10 is a flow diagram depicting an example method, implemented in a CU, in which the CU determines whether to generate a message requesting a DU to configure the UE to perform or not perform a random access procedure based on whether the UE supports RACH-less LTM;

FIG. 11A is a flow diagram depicting an example method, implemented in a RAN node, in which the RAN node generates an LTM configuration that does not include a reconfiguration with a synchronization field and includes a serving cell configuration and/or UE ID;

FIG. 11B is a flow diagram depicting an example method similar to that of FIG. 11A, but in which the RAN node generates an LTM configuration including an indication to configure the UE not to perform a random access procedure;

FIG. 12A is a flow diagram depicting an example method, implemented in a RAN node, in which the RAN node determines whether to transmit an LTM command that orders the UE to perform or not perform a random access procedure alongside a serving cell change based on whether a cell synchronizes with the serving cell;

FIG. 12B is a flow diagram depicting an example method similar to that of FIG. 12A, but in which the RAN node makes the determination based on whether the cell and serving cell are operated by the RAN node;

FIG. 12C is a flow diagram depicting an example method similar to that of FIG. 12A, but in which the RAN node makes the determination based on whether the UE supports RACH-less LTM;

FIG. 12D is a flow diagram depicting an example method similar to that of FIG. 12A, but in which the RAN node makes the determination based on whether the UE supports deriving uplink transmission timing based on reference signal(s);

FIG. 12E is a flow diagram depicting an example method similar to that of FIG. 12A, but in which the RAN node makes the determination based on whether the UE is configured with reference signal(s) for deriving uplink transmission timing;

FIG. 12B is a flow diagram depicting an example method similar to that of FIG. 12A, but in which the RAN node makes the determination based on whether the UE activates reception of reference signal(s) for deriving uplink transmission timing;

FIG. 13A is a flow diagram depicting an example method, implemented in a RAN node, in which the RAN node transmits an LTM configuration and a non-LTM configuration to a UE before transmitting an LTM command to cause the UE to perform a serving cell change;

FIG. 13B is a flow diagram depicting an example method similar to that of FIG. 13A, but in which the RAN node transmits the LTM command to cause the UE to additionally receive reference signal(s);

FIG. 13C is a flow diagram depicting an example method similar to that of FIG. 13A, but in which the RAN node determines whether to transmit the non-LTM configuration based on whether the UE supports deriving uplink transmission timing based on reference signal(s);

FIG. 13B is a flow diagram depicting an example method similar to that of FIG. 13C, but in which the RAN node transmits the LTM command to cause the UE to additionally receive the reference signal(s) when the UE supports deriving uplink transmission timing based on reference signal(s);

FIG. 14A is a flow diagram depicting an example method, implemented in a RAN node, in which the RAN node determines whether to perform a random access procedure with a UE or attempt to receive a physical uplink control channel (PUCCH) transmission from the UE based on whether the RAN node configures the UE to perform the random access procedure; and

FIG. 14B is a flow diagram depicting an example method similar to that of FIG. 14A, but in which the RAN node determines whether to perform the random access procedure or attempt to receive a physical uplink shared channel (PUSCH) transmission from the UE.

### DETAILED DESCRIPTION OF THE DRAWINGS

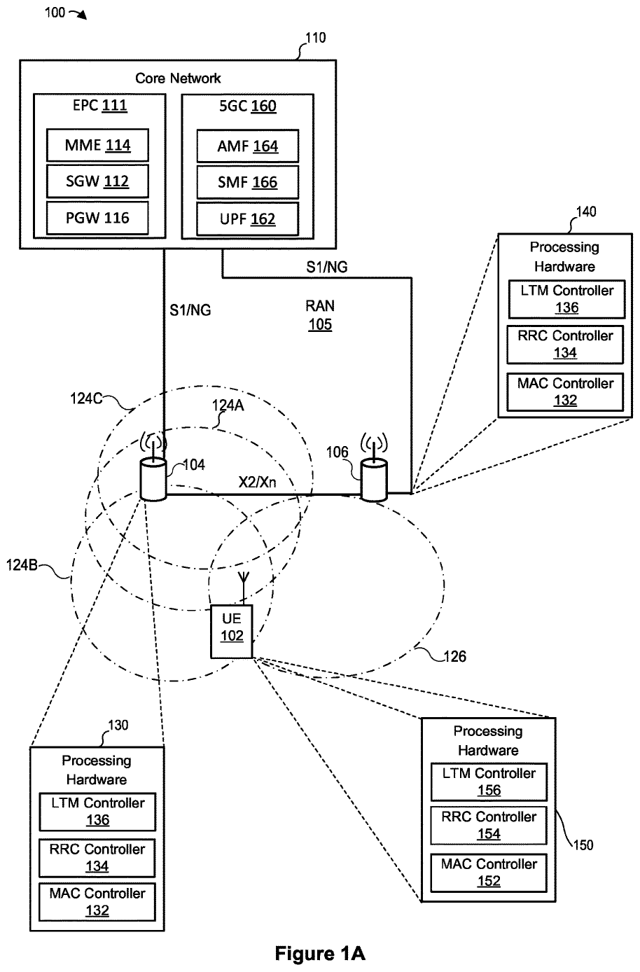

FIG. 1A depicts an example wireless communication system 100 in which communication devices can implement these techniques. The wireless communication system 100 includes a UE 102, a base station (BS) 104, a base station 106 and a core network (CN) 110. The UE 102 initially connects to the base station 104. In some scenarios, the base station 104 can perform an SN addition to configure the UE 102 to operate in dual connectivity (DC) with the base station 104 and the base station 106. The base stations 104 and 106 operate as an MN and an SN for the UE 102, respectively.

In various configurations of the wireless communication system 100, the base station 104 can be implemented as a master eNB (MeNB) or a master gNB (MgNB), and the base station 106 can be implemented as a secondary gNB (SgNB). The UE 102 can communicate with the base station 104 and the base station 106 via the same RAT such as EUTRA or NR, or different RATs. When the base station 104 is an MeNB and the base station 106 is a SgNB, the UE 102 can be in EUTRA-NR DC (EN-DC) with the MeNB and the SgNB.

In some cases, an MeNB or an SeNB is implemented as an ng-eNB rather than an eNB. When the base station 104 is a Master ng-eNB (Mng-eNB) and the base station 106 is a SgNB, the UE 102 can be in next generation (NG) EUTRA-NR DC (NGEN-DC) with the Mng-eNB and the SgNB. When the base station 104 is an MgNB and the base station 106 is an SgNB, the UE 102 may be in NR-NR DC (NR-DC) with the MgNB and the SgNB. When the base station 104 is an MgNB and the base station 106 is a Secondary ng-eNB (Sng-eNB), the UE 102 may be in NR-EUTRA DC (NE-DC) with the MgNB and the Sng-eNB.

In the scenarios where the UE 102 hands over from the base station 104 to the base station 106, the base stations 104 and 106 operate as the source base station (S-BS) and a target base station (T-BS), respectively. The UE 102 can operate in DC with the base station 104 and an additional base station (not shown in FIG. 1A) for example prior to the handover. The UE 102 can continue to operate in DC with the base station 106 and the additional base station or operate in single connectivity (SC) with the base station 106, after completing the handover. The base stations 104 and 106 in this case operate as a source MN (S-MN) and a target MN (T-MN), respectively.

A core network (CN) 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. To directly exchange messages with each other during the scenarios discussed below, the base stations 104 and 106 can support an X2 or Xn interface. Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports cell 124A, and the base station 106 supports a cell 126. The cells 124A and 126 can partially overlap, so that the UE 102 can communicate in DC with the base station 104 and the base station 106, where one of the base stations 104 and 106 is an MN and the other is an SN. The base station 104 can support additional cell(s) such as cells 124B and 124C, and the base station 106 can support additional cell(s) (not shown in FIG. 1A). The cells 124A, 124B and 124C can partially overlap, so that the UE 102 can communicate in carrier aggregation (CA) with the base station 104. The base station 104 can operate the cells 124A, 124B and 124C via one or more transmit and receive points (TRPs). More particularly, when the UE 102 is in DC with the base station 104 and the base station 106, one of the base stations 104 and 106 operates as an MeNB, an Mng-eNB or an MgNB, and the other operates as an SgNB or an Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

With continued reference to FIG. 1A, the base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller (not shown)configured to transmit data and control signal on physical downlink (DL) channels and DL reference signals with one or more user devices (e.g., UE 102) via one or more cells (e.g., the cell(s) 124A, 124B and/or 124C) and/or one or more TRPs. The PHY controller is also configured to receive data and control signal on physical uplink (UL) channels and/or UL reference signals with the one or more user devices via one or more cells (e.g., the cell(s) 124A, 124B and/or 124C) and/or one or more TRPs.

The processing hardware 130 in an example implementation includes a MAC controller 132 configured to perform MAC functions with one or more user devices. The MAC functions include a random access (RA) procedure, managing UL timing advance for the one or more user devices, and/or communicating UL/DL MAC PDUs with the one or more user devices. The processing hardware 130 can further include an RRC controller 134 to implement procedures and messaging at the RRC sublayer of the protocol communication stack. For example, the RRC controller 134 may be configured to support RRC messaging associated with handover procedures, and/or to support the necessary operations when the base station 104 operates as an MN relative to an SN or as an SN relative to an MN. The base station 106 can include processing hardware 140 that is similar to processing hardware 130. In particular, components 142, 144, and 146 can be similar to the components 132, 134, and 136, respectively.

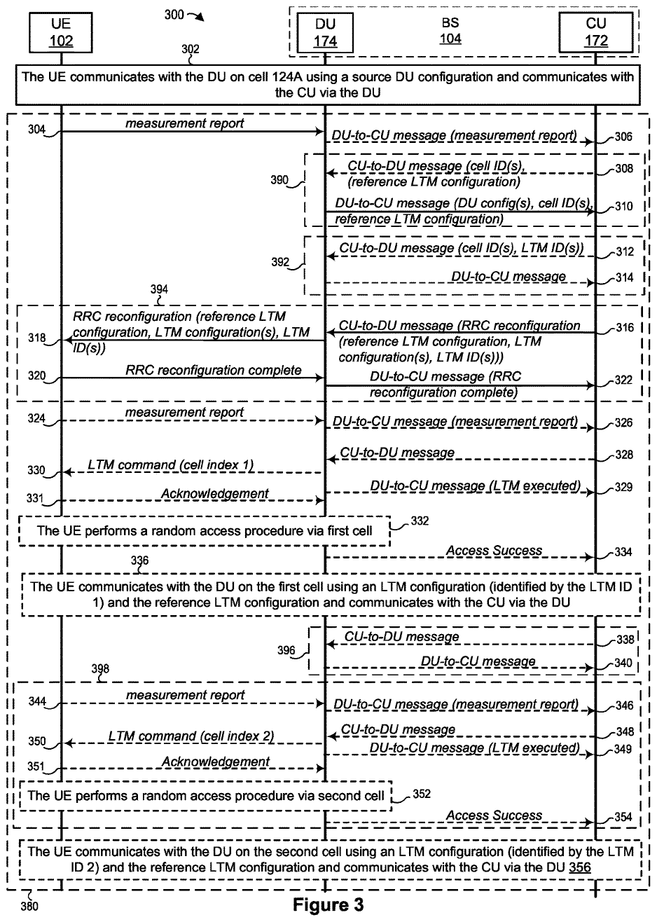

The processing hardware 130 also can include an LTM controller 136 configured to implement at least some of the techniques below discussed with reference to FIGS. 3-14B.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. A PHY controller (not shown) is also configured to receive data and control signal on physical DL channels and/or DL reference signals with the base station 104 or 106 via one or more cells (e.g., the cell(s) 124A, 124B, 124C and/or 126) and/or one or more TRPs. The PHY controller is also configured to transmit data and control signal on physical UL channels and/or UL reference signals with the base station 104 or 106 via one or more cells (e.g., the cell(s) 124A, 124B, 124C and/or 126) and/or one or more TRPs. The processing hardware 150 in an example implementation includes a MAC controller 152 configured to perform MAC functions with base station 104 or 106. For example, the MAC functions include a random access procedure, managing UL timing advance for the one or more user devices, and communicating UL/DL MAC PDUs with the base station 104 or 106. The processing hardware 150 can further include an RRC controller 154 to implement procedures and messaging at the RRC sublayer of the protocol communication stack. Further, the processing hardware 150 also can include an LTM controller 156 configured to implement at least some of the techniques below discussed with reference to FIGS. 3-14B.

In operation, the UE 102 in DC can use a radio bearer (e.g., a DRB or an SRB) that at different times terminates at the MN 104 or the SN 106. The UE 102 can apply one or more security keys when communicating on the radio bearer, in the uplink (UL) (from the UE 102 to a base station) and/or downlink (from a base station to the UE 102) direction.

FIG. 1B depicts an example distributed implementation of a base station such as the base station 104 or 106. The base station in this implementation can include a centralized unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an SN RRC controller (not shown) configured to manage or control one or more RRC configurations and/or RRC procedures when the base station 106 operates as an SN. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 106 operates as an MN or an SN. The process hardware may include further a physical layer controller configured to manage or control one or more physical layer operations or procedures.

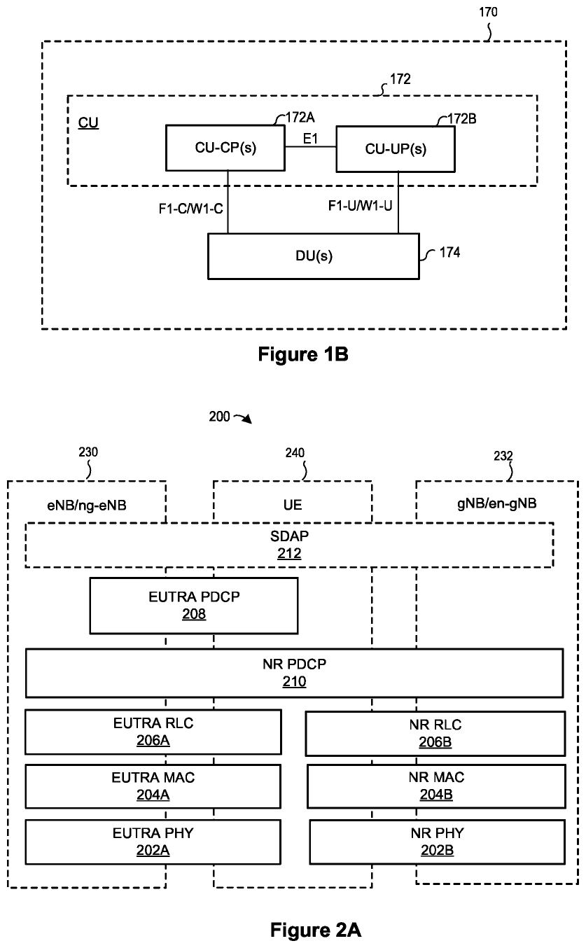

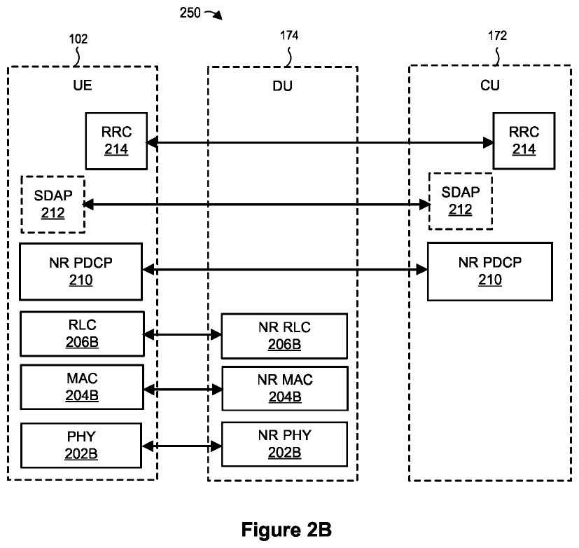

FIG. 2A illustrates, in a simplified manner, an example protocol stack 200 according to which a UE 240 (which can be implemented as the UE 102 for example) can communicate with an eNB/ng-eNB 230 (which can be implemented as the base station 104 or 106, for example) or a gNB (which can be implemented as the base station 104, for example).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B.

The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

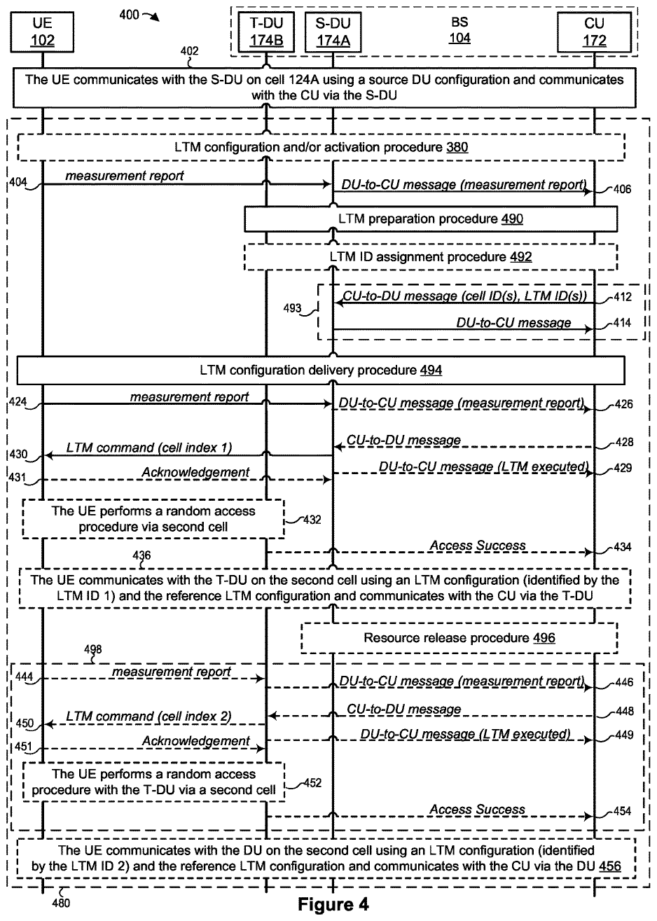

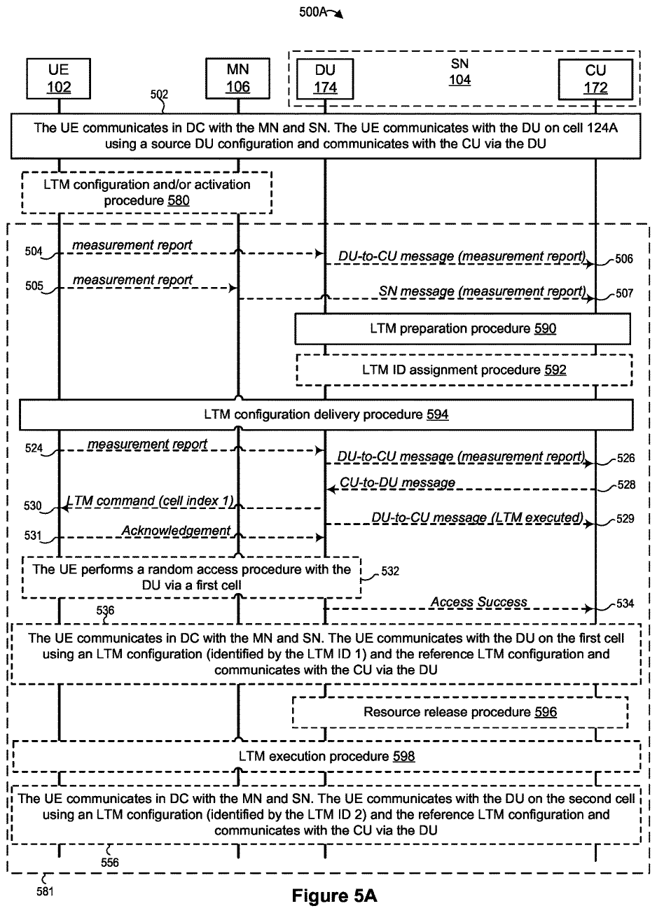

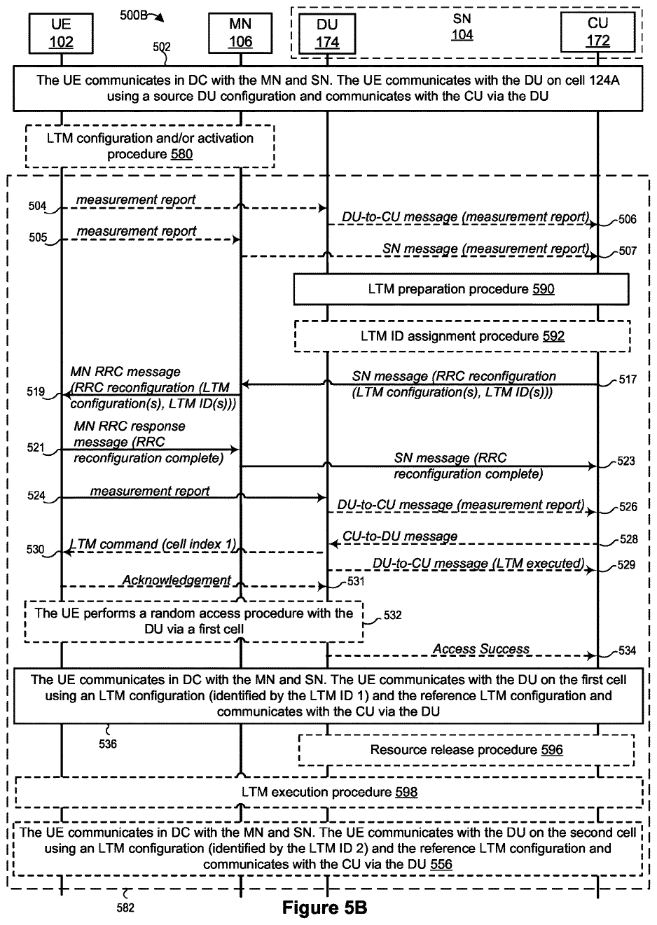

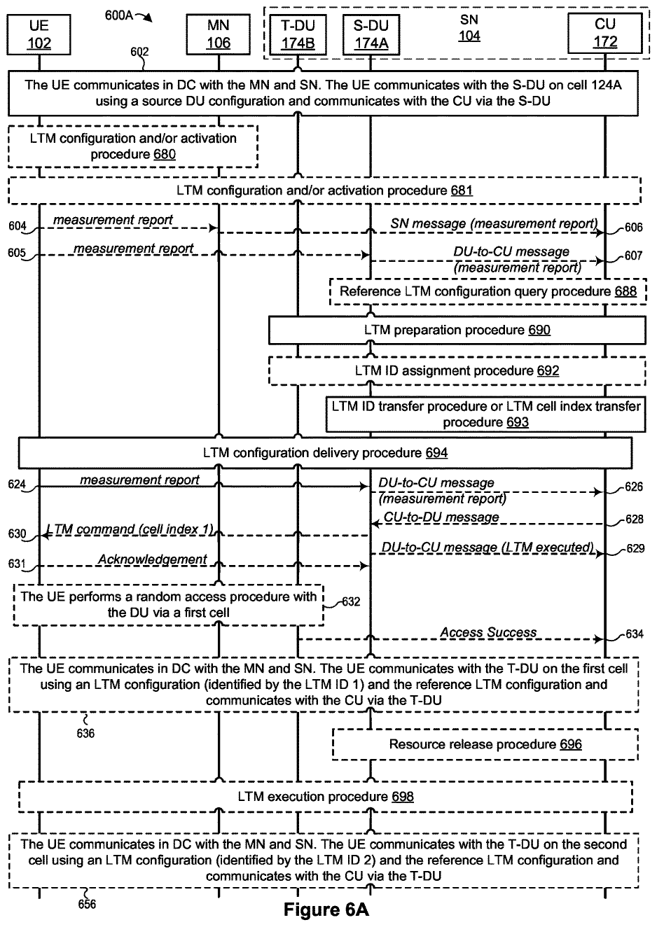

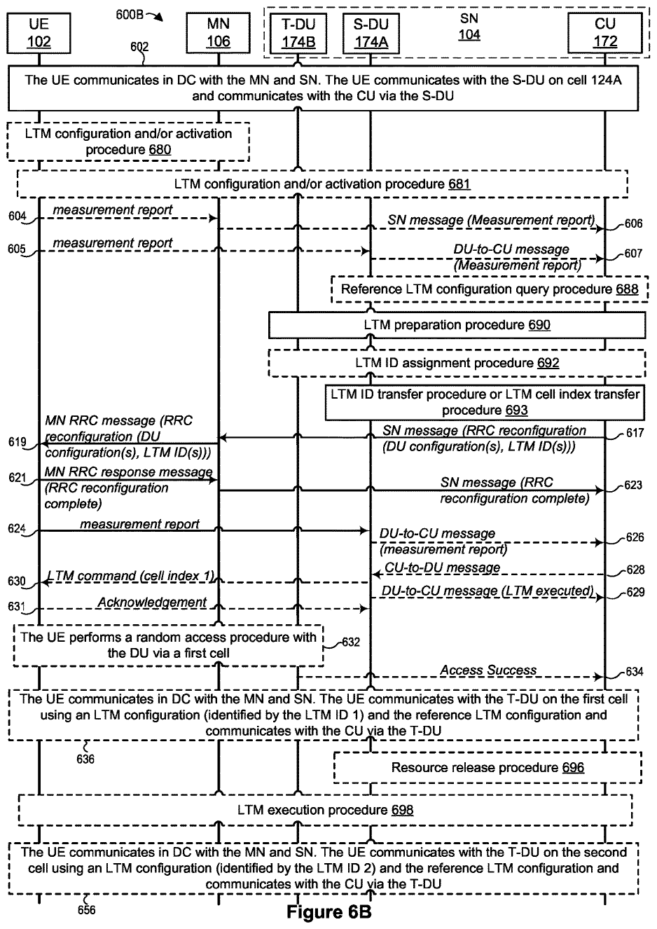

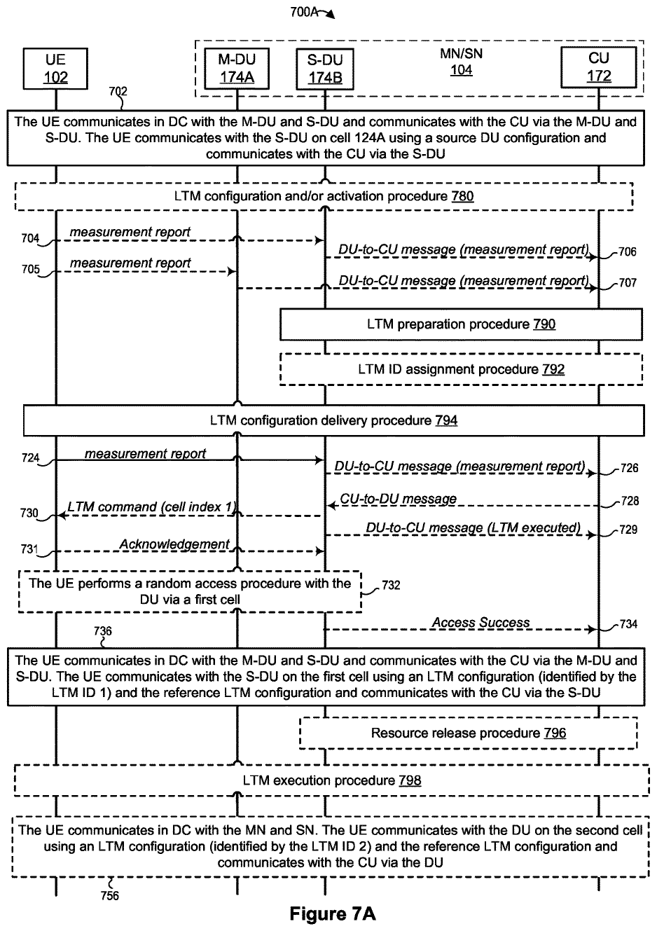

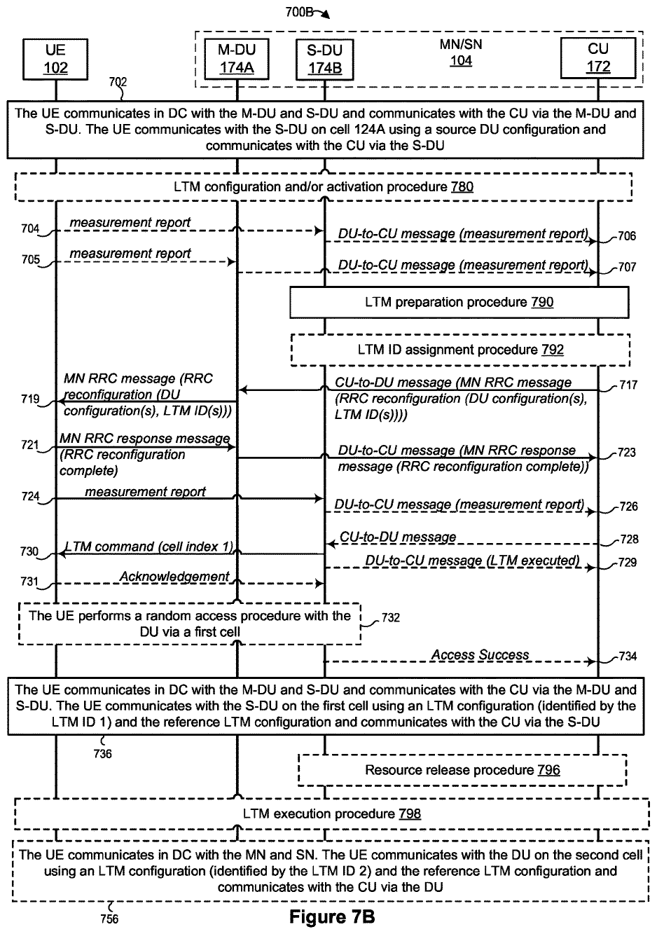

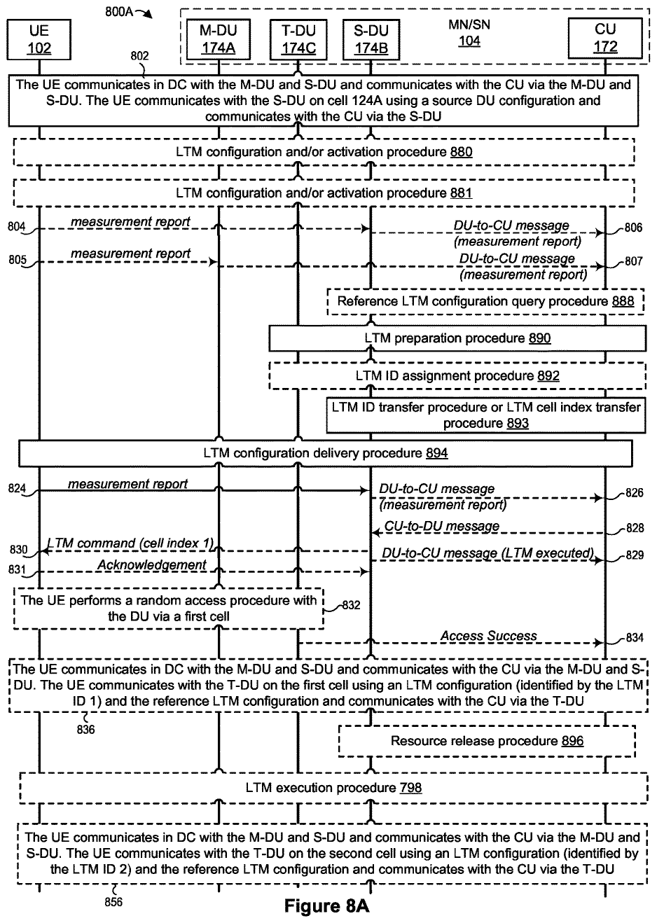

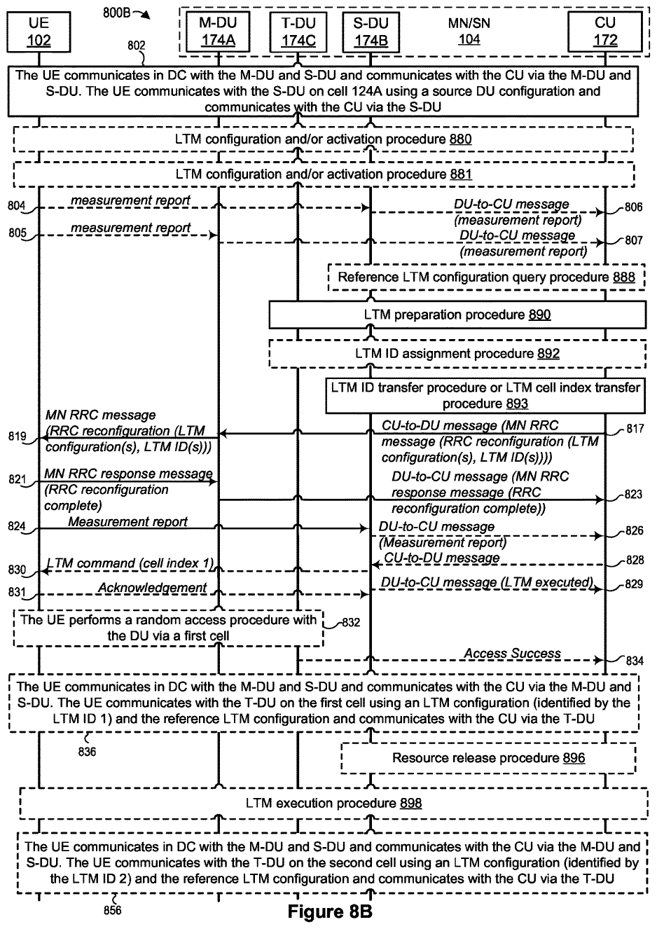

Next, several example scenarios in which the base station operating in the system of FIG. 1A transmits a configuration to the UE 102 and later activates a configuration for communication between the UE 102 and base station. Generally speaking, events in FIGS. 3-8B that are similar are labeled with similar reference numbers (e.g., event 316 is similar to event 416 of FIGS. 4A and 4B, event 516 of FIG. 5A, event 517 of FIG. 5B, event 616 of FIG. 6A, event 617 of FIG. 6B, event 716 of FIG. 7A, event 717 of FIG. 7B, event 816 of FIG. 8A, and event 817 of FIG. 8B), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Referring first to FIG. 3, in a scenario 300, the base station 104 includes a CU 172 and a DU 174 and the DU 174 operates the cell 124A. The UE 102 initially communicates 302 with the DU 174 on the cell 124A using a serving DU configuration, and communicates with the CU 172 via the DU 174 (e.g., using a serving CU configuration). In some implementations, the UE 102 in carrier aggregation (CA) communicates with the DU 174 on the cell 124A and other cell(s) (e.g., cell 124D not shown in FIG. 1A) using the serving DU configuration. The DU 174 operates the other cell(s). In other implementations, the UE 102 in communicates with the DU 174 on the cell 124A only. In some implementations, the UE 102 communicates with the DU 174 on the cell 124A and/or other cell(s) via one or multiple TRPs. In some implementations, the cell 124A is a PCell. In such cases, the other cell(s) include SCell(s) and/or additional cell(s) associated with the PCell or an SCell. In other implementations, the cell 124A is an SCell, and one of the other cell(s) is a PCell. In such cases, the rest of the cells include SCell(s) and/or additional cell(s) associated with the PCell or an SCell. In the following description, depending on the implementation, the base station 104 is the DU 174, the CU 172, or the DU 174 and CU 172.

In some implementations, in the event 302, the UE 102 transmits UL PDUs and/or UL control signals to the base station 104 on the cell 124A and/or other cell(s) via one or multiple TRPs. In some implementations, the UE 102 communicates UL PDUs and/or DL PDUs with the base station 104 via radio bearers which include SRBs and/or DRB(s). In further implementations, the base station 104 configures the radio bearers for the UE 102. In some implementations, UL control signals include UL control information, channel state information, hybrid automatic repeat request (HARQ) acknowledgements (ACKs), HARQ negative ACKs, scheduling request(s), and/or sounding reference signal(s). Similarly, in further implementations the UE 102 receives DL PDUs and/or DL control signals from the base station 104 on the cell 124A and/or other cell(s) via one or multiple TRPs. In some implementations, the DL control signals include downlink control information (DCIs) and reference signals (e.g., synchronization signal block, channel state information reference signal(s) (CSI-RS(s)), and/or tracking reference signal(s)). In some implementations, the base station 104 transmits the DCIs on physical downlink control channel(s) (PDCCH(s)) monitored by the UE 102, on the cell 124A and/or other cell(s) via one or multiple TRPs.

In some implementations, the serving DU configuration includes physical layer configuration parameters, MAC configuration parameters, and/or RLC configuration parameters. In some implementations, the DU 174 transmits the configuration parameters to the CU 172. The CU 172 generates one or more messages (e.g., RRC reconfiguration message(s)) including the configuration parameters and transmits the one or more messages to the UE 102 via the DU 174. In other implementations, the DU 174 transmits the configuration parameters to the UE 102 directly. In some implementations, the serving DU configuration is CellGroupConfig IE (e.g., defined in 3GPP TS 38.331). In other implementations, the serving DU configuration includes configuration parameters in the CellGroupConfig IE. In some implementations, the serving CU configuration includes PDCP configuration parameters, measurement configuration parameters, and/or radio bearer configuration parameters. In some implementations, the serving CU configuration includes a MeasConfig IE and/or a RadioBearerConfig IE (e.g., defined in 3GPP TS 38.331) or includes configuration parameters in the MeasConfig IE and/or RadioBearerConfig IE. In some implementations, the serving DU configuration includes a CSI-MeasConfig IE or configuration parameters for channel state information (CSI) measurement and reporting. In other implementations, the serving CU configuration includes a CSI-MeasConfig IE or configuration parameters for channel state information (CSI) measurement and reporting. In some implementations, the UE 102 receives the serving CU configuration or the configuration parameters in the serving CU configuration from the CU 172 via the DU 174. In other implementations, the UE 102 receives a portion of the serving CU configuration and/or a portion of the serving DU configuration from a base station other than the base station 104 and the remaining portion of these configuration parameters from the base station 104.

While communicating with the base station 104, the UE 102 transmits 304 at least one measurement report to the DU 174. In some implementations, the at least one measurement report includes Layer 1 (L1) measurement report(s) and/or Layer 3 (L3) measurement report(s) for at least one serving cell of the UE 102 and/or at least one non-serving cell. For each of the L3 measurement report(s), the DU 174 transmits 306 a DU-to-CU message including the L3 measurement report to the CU 172. In some implementations, the DU-to-CU message(s) of the event 306 is/are F1 application protocol (F1AP) message(s) (e.g., UL RRC Message Transfer message(s)). In some implementations, the DU 174 does not transmit or refrains from transmitting the L1 measurement report(s) to the CU 172. The at least one serving cell includes the cell 124A and/or other cell(s), and the at least one non-serving cell includes the cell 124B and/or cell 124C. In some implementations, the serving DU configuration or the serving CU configuration includes at least one measurement configuration. In some implementations, the UE 102 receives one or more RRC messages (e.g., RRCReconfiguration message(s)) including the at least one measurement configuration from the CU 172 via the DU 174 in the event 302. In accordance with the at least one measurement configuration, the UE 102 performs measurements and transmits 304 the at least one measurement report to the DU 174. In some implementations, the at least one measurement configuration includes L3 measurement configuration(s) (e.g., MeasConfig IE(s)) and/or L1 measurement configuration(s). In some implementations, the L1 measurement configuration(s) (e.g., CSI-MeasConfig IE(s)) includes L1 measurement resource configuration(s) and/or L1 measurement reporting configuration(s). In further implementations, the L1 measurement resource configuration(s) configure resources of reference signal(s) (e.g., CSI-RS(s)) for the UE 102 to measure and obtain L1 measurement results. For example, the L1 measurement resource configuration(s) is/are CSI-ResourceConfig IE(s). In another example, the L1 measurement reporting configuration(s) configure way(s) the UE 102 uses to transmit L1 measurement results/reports. For example, the L1 measurement report configuration(s) is/are CSI-ReportConfig IE(s). For example, the UE 102 transmits the L3 measurement report(s) to the CU 172 via the DU 174 in accordance with the L3 measurement configuration(s). The UE 102 transmits the L1 measurement report(s) to the DU 174 in accordance with the L1 measurement configuration(s) or L1 measurement reporting configuration(s). In some implementations, the DU 174 does not transmit the L1 measurement report(s) to the CU 172.

In some implementations, the L1 measurement configuration(s) are RRC IE(s) specifically defined (e.g., in 3GPP TS 38.331) for a lower layer triggered mobility (LTM). In some implementations, the L1 measurement resource configuration(s) are RRC IE(s) specifically defined (e.g., in 3GPP TS 38.331) for the LTM. In some implementations, the L1 measurement reporting configuration(s) are RRC IE(s) specifically defined (e.g., in 3GPP TS 38.331) for the LTM. In some implementations, each of the L1 measurement reporting configuration(s) includes a trigger event configuration configuring a trigger event to trigger the UE 102 to transmit an L1 measurement report. If the UE 102 detects the trigger event, the UE 102 transmits an L1 measurement report to the DU 174.

In some implementations, (each of) the L1 measurement report(s) includes at least one L1 measurement result. In some implementations, the at least L1 measurement result includes at least one L1-reference signal received power (L1-RSRP) value, L1-reference signal received quality (L1-RSRQ), and/or L1-Signal to Interference Noise Ratio (L1-SINR) value. For each of the L1 measurement report(s), the UE 102 transmits a PUCCH transmission including the L1 measurement report to the DU 174, in some implementations. That is, the UE 102 transmits the each of the L1 measurement report(s) on a PUCCH to the DU 174. In other implementations, for each of the L1 measurement report(s), the UE 102 transmits a PUSCH transmission including the L1 measurement report to the DU 174. That is, the UE 102 transmits each of the L1 measurement report(s) on a PUSCH to the DU 174. In yet other implementations, the UE 102 transmits a portion of the L1 measurement report(s) on PUCCH(s) and the rest of the L1 measurement report(s) on physical UL shared channel(s) (PUSCH(s)) to the DU 174. That is, for each portion of the L1 measurement report(s), the UE 102 transmits a PUCCH transmission including the L1 measurement report to the DU 174, and for each of the remainder of the L1 measurement report(s), the UE 102 transmits a PUSCH transmission including the L1 measurement report to the DU 174. In some implementations, each of the L1 measurement report(s) Is a part of the channel state information (CSI) (i.e., a CSI component) or CSI. In some implementations, the UE 102 includes other CSI component(s) in (each of) the PUCCH transmission(s) and/or PUSCH transmission(s) described above. In some implementations, the other CSI component(s) include a channel quality indicator (CQI), a Precoding Matrix Indicator (PMI), a CSI-RS Resource Indicator (CRI), a Synchronization Signal (SS)/ Physical Broadcast Channel (PBCH) Resource Block Indicator (SSBRI), a Layer Indicator (LI), and/or a Rank Indicator (RI). In some implementations, the UE 102 does not transmit the L1 measurement report(s) in the format of RRC message(s) to the DU 174. In some implementations, each of the L1 measurement report(s) includes an L1 event ID to identify or indicate the trigger L1 event. Alternatively, each of the L1 measurement report(s) does not include an L1 event ID to identify or indicate the trigger L1 event.

In some implementations, each of the L3 measurement report(s) includes at least one L3 measurement result. In some implementations, the at least one L3 measurement result includes at least one RSRP (value) and/or at least one SINR (value). In some implementations, the UE 102 transmits each of the L3 measurement report(s) on a PUSCH to the CU 172 via the DU 174. In some implementations, each of the L3 measurement report(s) is an RRC message (e.g., MeasurementReport message). In some implementations, each of the L3 measurement configuration(s) includes a particular measurement identity (e.g., measId), and each of the L3 measurement report(s) includes a particular measurement identity in a particular L3 measurement configuration. In some implementations, when the CU 172 receives an L3 measurement report, including a measurement identity and an L3 measurement result, from the UE 102 via the DU 174, the CU 172 determines that the L3 measurement report is associated with an L3 measurement configuration identified by the measurement identity.

In some alternative implementations, for each of the at least one measurement report (e.g., L1 measurement report(s)), the UE 102 transmits a MAC control element (CE), including the measurement report, to the DU 174 in the event 304. To transmit the MAC CE(s), the UE 102 generates one or more MAC PDUs, each including one or more of the MAC CE(s), to the DU 174 in the event 304.

In some implementations, the UE 102 performs measurements on one or more reference signals in accordance with the at least one measurement configuration. Depending on the implementation, the one or more reference signals include one or more Synchronization Signal (SS)/Physical Broadcast Channel (PBCH) Resource Blocks (SSBs) and/or one or more CSI-RSs. The UE 102 obtains the at least one L1 measurement result and/or at least one L3 measurement result from the measurements. The DU 174 transmits the one or more reference signals on the cell 124A and other cell(s) (e.g., the cell 124B, the cell 124C, and/or cell(s) not shown in FIG. 1A).

After (e.g., in response to) receiving one or some of the at least one measurement report(s) from the UE 102, the base station 104 (i.e., the CU 172 or DU 174) determines to prepare a first cell (e.g., the cell 124B) for LTM for the UE 102. In some implementations, the base station 104 determines to prepare the first cell for the UE 102 because the at least one measurement report indicates that the first cell could be used by the base station 104 to communicate with the UE 102. In some implementations, the base station 104 determines to prepare the first cell for the UE 102 because the at least one measurement report indicates that the first cell qualifies to be a candidate cell that could be used for communication with the UE 102. In some implementations, if the L3 measurement report(s) indicates that signal strength and/or quality of the first cell is above a first predetermined threshold, is better than strength and/or quality of the cell 124A, and/or is better than strength and/or quality of the cell 124A by a first predetermined threshold, the CU 172 determines to prepare the first cell for the UE 102. In other implementations, if the L1 measurement report(s) indicate that signal strength and/or quality of the first cell is above a first predetermined threshold, is better than signal strength and/or quality of the cell 124A, and/or is better than signal strength and/or quality of the cell 124A by a first predetermined threshold, the DU 174 determines to prepare the first cell for the UE 102. Alternatively, the base station 104 determines to prepare the first cell for the UE 102 regardless of whether a measure report is received from the UE 102 or not.

In cases where the CU 172 determines to prepare the first cell for LTM, the CU 172 transmits 308 a first CU-to-DU message to the DU 174 to prepare the first cell for the UE 102. In some implementations, the CU 172 includes a cell identity (ID) of the first cell in the first CU-to-DU message to request the DU 174 to prepare the first cell for LTM for the UE 102. For example, the cell ID is cell global identity (CGI). In another example, the cell ID is a portion of the CGI. In yet another example, the cell ID is a physical cell ID (PCI). In response to the first CU-to-DU message, the DU 174 generates a first LTM configuration (referred to herein after as LTM configuration 1) for the UE 102, which configures the first cell for LTM. The DU 174 then transmits 310 a first DU-to-CU message, including the LTM configuration 1, to the CU 172 in response to the first CU-to-DU message. In some implementations, the DU 174 includes the cell ID 1 together with the LTM configuration 1 in an IE of the first DU-to-CU message to indicate that the LTM configuration 1 is associated with the first cell (i.e., the cell ID 1). In cases where the DU 174 determines to prepare the first cell, the DU 174 initiates transmission of the first DU-to-CU message to the CU 172 instead of in response to a CU-to-DU message received from the CU 172.

In some implementations, the DU 174 includes, in the first DU-to-CU message, the cell ID of the first cell associated with the LTM configuration 1 to indicate that the LTM configuration 1 is configured for or associated with the first cell. The CU 172 identifies that the LTM configuration 1 is configured for or associated with the first cell. In some scenarios and implementations, the CU 172 includes additional cell ID(s) (e.g., cell ID(s) 2, . . . , N) in the first CU-to-DU message to prepare additional cell(s) (e.g., cell(s) 2, . . . , N) for LTM for the UE 102, and the DU 174 includes additional LTM configuration(s) (e.g., LTM configuration(s) 2, . . . , N), each configuring a particular cell of the additional cell(s), as described below. In such cases, the DU 174 includes, in the first DU-to-CU message, the additional cell ID(s) respectively associated with the additional LTM configuration(s) to indicate which LTM configuration is associated to which cell (ID). The cell(s) 1 and/or 2, . . . , N are candidate cell(s).

In some implementations, the CU 172 does not include a (reference) LTM configuration in the first CU-to-DU message. In such cases, the DU 174 generates a reference LTM configuration, generates the LTM configuration(s) 1 and/or 2, . . . , N (i.e., non-reference LTM configuration(s)) based on the reference LTM configuration, and includes the reference LTM configuration in the first DU-to-CU message. In other implementations, the CU 172 includes a reference LTM configuration in the first CU-to-DU message. In such cases, the DU 174 generates the LTM configuration(s) 1 and/or 2, . . . , N, which are delta configuration(s) to augment the reference LTM configuration. In yet other implementations, the CU 172 includes a reference LTM configuration (e.g., a first reference LTM configuration) in the first CU-to-DU message. In such cases, the DU 174 generates a reference LTM configuration (e.g., a second reference LTM configuration) replacing the first reference LTM configuration, generates the LTM configuration(s) 1 and/or 2, . . . , N based on the second reference LTM configuration, and includes the second reference LTM configuration in the first DU-to-CU message.

In some implementations, the reference LTM configuration includes physical layer configuration parameters, MAC configuration parameters, and/or RLC configuration parameters. In some implementations, the reference LTM configuration is a CellGroupConfig IE (e.g., as defined in 3GPP TS 38.331). In other implementations, the reference LTM configuration includes configuration parameters in the CellGroupConfig IE. In some implementations, the reference LTM configuration includes a CSI-MeasConfig IE or configuration parameters for channel state information (CSI) measurement and/or reporting.

In some implementations, the reference LTM configuration is different from the serving DU configuration. In some implementations, a portion of the reference LTM configuration is the same as a portion of the serving DU configuration, and the rest of the reference LTM configuration is different from the rest of the serving DU configuration. In other implementations, the reference LTM configuration is the same as the serving DU configuration.

After receiving the first DU-to-CU message, the CU 172 generates an RRC reconfiguration message (e.g., an RRCReconfiguration message), including the LTM configuration 1, and transmits 316 a second CU-to-DU message including the RRC reconfiguration message to the DU 174. In some implementations, the CU 172 includes the reference LTM configuration in the RRC reconfiguration message 316. In other implementations, the CU 172 does not include a reference LTM configuration in the RRC reconfiguration message 316. In some implementations, if the CU 172 transmits the reference LTM configuration to the UE 102 during the event 302, the CU 172 does not include the reference LTM configuration in the RRC reconfiguration message 316. In other implementations, if the CU 172 receives the reference LTM configuration from the DU 174, the CU 172 includes the LTM configuration in the RRC reconfiguration message 316. Otherwise, if the CU 172 does not receive a reference LTM configuration from the DU 174, the CU 172 does not include the reference LTM configuration in the RRC reconfiguration message 316.

After receiving the RRC reconfiguration message 316, the DU 174 transmits 318 the RRC reconfiguration message to the UE 102. In response, the UE 102 transmits 320 an RRC reconfiguration complete message (e.g., an RRCReconfigurationComplete message) to the DU 174, which in turn transmits 322 a second DU-to-CU message including the RRC reconfiguration complete message to the CU 172. In some implementations, the CU 172 performs security protection (e.g., integrity protection and/or encryption) on the RRC reconfiguration message. For example, the CU 172 generates a message authentication code for integrity (MAC-I) for the RRC reconfiguration message, encrypts the RRC reconfiguration message and the MAC-I to obtain an encrypted RRC reconfiguration message and an encrypted MAC-I, and transmits a PDCP PDU including the encrypted RRC reconfiguration message and encrypted MAC-I to the UE 102 via the DU 174 in the events 316 and 318. When the UE 102 receives the PDCP PDU from the CU 172 via the DU 174 (i.e., events 316 and 318), the UE 102 decrypts the encrypted RRC reconfiguration and encrypted MAC-I to obtain the RRC reconfiguration message and MAC-I and verifies whether the MAC-I is valid. If the UE 102 verifies the MAC-I is invalid, the UE 102 discards or ignores the RRC reconfiguration message. In some implementations, the UE 102 performs an RRC connection reestablishment procedure in response to the invalid MAC-I. Otherwise, in further implementations, if the UE 102 verifies the MAC-I is valid, the UE 102 processes the RRC reconfiguration. The UE 102 refrains from applying (i.e., executing) the LTM configuration 1 until receiving a configuration activation command activating the LTM configuration 1 (e.g., the event 330).

The events 308 (optional) and 310 are collectively referred to in FIG. 3 as an LTM preparation procedure 390. The events 316, 318, 320, 322 are collectively referred to in FIG. 3 as an LTM configuration delivery procedure 394.

In some implementations, the DU 174 transmits the reference LTM configuration to the UE 102 in procedures similar to the procedures 390 and 392 before receiving the first CU-to-DU message. In such cases, the DU 174 does not include the reference LTM configuration in the first DU-to-CU message.

In some implementations, in the case that the CU 172 performs the multiple LTM preparation procedures 390, the DU 174 includes the reference LTM configuration in the first DU-to-CU message in the first LTM preparation procedure of the LTM preparation procedures 390. In some such cases, the DU 174 does not include the reference LTM configuration in DU-to-CU messages in the rest of the LTM preparation procedures 390.

In some implementations, the first CU-to-DU message is a UE Context Modification Request message, and the first DU-to-CU message is a UE Context Modification Response message or UE Context Modification Required message. In some cases including the UE Context Modification Required message, the CU 172 transmits a UE Context Modification Confirm message to the DU 174 in response to UE Context Modification Required message. In some implementations, the second CU-to-DU message is a DL RRC Message Transfer message. In other implementations, the second CU-to-DU message is a UE Context Modification Request message, and the DU 174 transmits a second DU-to-CU message (e.g., UE Context Modification Response message) to the CU 172 in response to the second CU-to-DU message.

In some implementations, the CU 172 includes the LTM configuration 1 in a first container (e.g., a field/IE) and includes the first container in the RRC reconfiguration message of the events 316 and 318. In such cases, the CU 172 generates the first container. The first container is to indicate to the UE 102 not to apply the LTM configuration 1 immediately. In some scenarios or implementations, the UE 102 receives an RRC reconfiguration message (e.g., the RRC reconfiguration message of the event 318) including a configuration (e.g., the LTM configuration 1). If the configuration is included in the first container, the UE 102 refrains from immediately applying the configuration. Otherwise, in further implementations, if the configuration is not included in the first container, the UE 102 applies the configuration immediately. In some implementations, the first container is a first addition or modification list (e.g., ltm-ConfigToAddModList field, LTM-ConfigToAddModList IE, ltm-CandidateConfigToAddModList field, or LTM-CandidateConfigToAddModList IE). The CU 172 includes the LTM configuration 1 in a first element (referred to herein after as element 1) of the first addition or modification list. For example, the element 1 is an addition or modification IE (ltm-ConfigToAddMod field, LTM-ConfigToAddMod IE, ltm-CandidateConfigToAddMod field, or LTM-CandidateConfigToAddMod IE). In some implementations, when the UE 102 receives the first addition or modification list, the UE 102 stores the first addition or modification list (e.g., in a variable in the random access memory (RAM)). In other alternative implementations, the DU 174 generates the first container and includes the first container in the first DU-to-CU message. In yet other alternative implementations, the DU 174 generates the element 1 and includes the element 1 in the first DU-to-CU message.

### The CU Assigns an ID for the LTM Configuration 1

In some implementations, the CU 172 includes, in the RRC reconfiguration message, a first LTM ID (referred to herein after as ID 1) for identifying the LTM configuration 1 or the element 1. In some implementations, the CU 172 includes the ID 1 in the first container or element 1. In some implementations, the CU 172 assigns the ID 1. In other implementations, the CU 172 receives the ID 1 from the DU 174 in the first DU-to-CU message, as described below.

In some implementations where the CU 172 assigns or generates the ID 1, the CU 172 transmits the ID 1 to the DU 174, and the DU 174 associates the ID 1 with the LTM configuration 1. In some implementations, in the first CU-to-DU message, the CU 172 includes the ID 1 and indicates that the ID 1 is associated with the LTM configuration 1. In other implementations, after receiving the first DU-to-CU message, the CU 172 transmits 312 a third CU-to-DU message including the ID 1 to the DU 174 instead of including the ID 1 in the first CU-to-DU message. In some implementations, in the third CU-to-DU message, the CU 172 includes the LTM configuration 1 and the ID 1. The CU 172 further indicates the association between the ID 1 and LTM configuration 1. Thus, the DU 174 directly associates the ID 1 with the LTM configuration 1. In other implementations, in the third CU-to-DU message, the CU 172 includes the cell ID 1 and the ID 1 (i.e., the first LTM ID), and indicates the association between the cell ID 1 and the ID 1. Thus, in some such implementations, the DU 174 associates the ID 1 with the LTM configuration 1 based on the association between the cell ID 1 and the ID 1 and the association between the cell ID 1 and the LTM configuration 1. In yet other implementations, in the third CU-to-DU message, the CU 172 includes the LTM configuration 1, the cell ID 1, and the ID 1, and indicates the association between the ID 1, LTM configuration 1, and the cell ID 1. In some implementations, the DU 174 transmits 314 a third DU-to-CU message to the CU 172 in response to the third CU-to-DU message. In some implementations, the third CU-to-DU message and third DU-to-CU message are a UE Context Modification Request message and UE Context Modification Response message. The events 312 (optional) and 314 (optional) are collectively referred to in FIG. 3 as an LTM ID assignment procedure 392. In other implementations, the CU 172 includes the ID 1, the cell ID 1, and/or the LTM configuration 1 in the second CU-to-DU message, as described above. Thus, the CU 172 can omit the third CU-to-DU message.

In some implementations where the CU 172 includes the ID 1 in the first CU-to-DU message, the DU 174 includes the ID 1 in the LTM configuration 1, first container or element 1. Alternatively, the DU 174 does not include the ID 1 in the LTM configuration 1, first container and/or element 1.

### DU Assigns an ID for the LTM Configuration 1

In some alternative implementations, the DU 174 assigns the ID 1 identifying the LTM configuration 1. In some implementations, the DU 174 includes the ID 1 in the first DU-to-CU message. In some implementations, the CU 172 includes the ID 1 in the RRC reconfiguration message as described above. In other implementations, the DU 174 includes the ID 1 in the LTM configuration 1, first container, or element 1. Thus, the CU 172 does not include an ID identifying the LTM configuration 1 in the RRC reconfiguration message, first container and/or element 1.

In some implementations, the CU 172 includes the reference LTM configuration in the first container. For example, the CU 172 includes the reference LTM configuration in a field of the first container, different from a field of the first container including the LTM configuration 1. In other implementations, the CU 172 includes the reference LTM configuration in the RRC reconfiguration message 316 and outside the first container. For example, the CU 172 generates a third container (e.g., a field/IE) to include the first container and the reference LTM configuration and includes the third container in the RRC reconfiguration message 316. In yet other implementations, the DU 174 includes the reference LTM configuration in the first container. For example, the DU 174 includes the reference LTM configuration in a field of the first container, different from a field of the first container including the LTM configuration 1. In yet other implementations, the DU 174 generates a fourth container (e.g., a field/IE) to include the first container and the reference LTM configuration and includes the fourth container in the first DU-to-CU message 310. In such cases, the CU 172 includes the fourth container in the RRC reconfiguration message 316. Alternatively, the CU 172 retrieves the reference LTM configuration and the LTM configuration 1 from the fourth container and includes the reference LTM DU configuration and the LTM DU configuration 1 as described above.

In some implementations, neither the CU 172 nor the DU 174 assign an ID to identify the reference LTM configuration. In such cases, there is no ID for the reference LTM configuration.

In some implementations, the LTM configuration 1 includes a plurality of configuration parameters for the UE 102 to communicate with the DU 174 on the first cell. In some implementations, the plurality of configuration parameters includes physical layer configuration parameters (e.g., PhysicalCellGroupConfig IE), MAC layer configuration parameters (e.g., MAC-CellGroupConfig IE), and/or RLC configuration parameters (e.g., RLC-BearerConfig IE(s)). In some further implementations, the plurality of configuration parameters includes a special cell configuration (e.g., SpCellConfig IE) and/or one or more SCell configurations (e.g., SCellConfig IE(s)). In some implementations, the LTM configuration 1 is a CellGroupConfig IE (e.g., defined in 3GPP TS 38.331). In other implementations, the LTM configuration 1 includes configuration parameters in the CellGroupConfig IE.

In some implementations, the DU 174 includes a random access configuration in the LTM configuration 1. In other implementations, the DU 174 does not include a random access configuration in the LTM configuration 1. In some implementations, if the cell 124A and first cell are not synchronized, the DU 174 determines to include the random access configuration in the LTM configuration 1. Otherwise, if the cell 124A and first cell are synchronized, the DU 174 determines to not include the random access configuration in the LTM configuration 1. In other implementations, if the DU 174 determines that the UE 102 has not synchronized in UL with the first cell, the DU 174 determines to include the random access configuration in the LTM configuration 1. Otherwise, if the DU 174 determines that the UE 102 has synchronized in UL with the first cell, the DU 174 determines to not include the random access configuration in the LTM configuration 1. If the LTM configuration 1 includes the random access configuration, the UE 102 performs the random access procedure in the event 332 in accordance with the random access configuration, as described below. Otherwise, if the LTM configuration 1 does not include the random access configuration, the UE 102 skips or refrains from performing the random access procedure of the event 332 in response to the LTM configuration 1 excluding the random access configuration.

In some implementations, the DU 174 includes random access configuration parameters in the LTM configuration 1 and/or the reference LTM configuration regardless of whether the cell 124A and first cell are synchronized or not. The UE 102 performs the random access procedure in the event 332 in accordance with the random access configuration parameters, as described below.

In some implementations, if the cell 124A and first cell are synchronized, the DU 174 determines to include, in the LTM configuration 1, a first indication configuring the UE 102 not to perform a random access procedure on the first cell. Otherwise, if the cell 124A and first cell are not synchronized, the DU 174 determines to not include the first indication in the LTM configuration 1. In other implementations, if the DU 174 determines that the UE 102 has synchronized in UL with the first cell, the DU 174 determines to include the first indication in the LTM configuration 1. Otherwise, if the DU 174 determines that the UE 102 has not synchronized in UL with the first cell, the DU 174 determines to not include the first indication in the LTM configuration 1. If the LTM configuration 1 includes the first indication, the UE 102 skips or refrains from performing the random access procedure of the event 332 in accordance with or in response to the first indication. Otherwise, if the LTM configuration 1 does not include the first indication, the UE 102 performs the random access procedure in accordance with the random access configuration in the event 332, in response to the LTM configuration 1 excluding the first indication, as described below.

In some implementations, the DU 174 includes a reconfiguration with sync configuration (e.g., Reconfiguration WithSync IE) in the LTM configuration 1 or special cell configuration. In other implementations, the DU 174 does not include a reconfiguration with sync configuration (e.g., Reconfiguration WithSync IE) in the LTM configuration 1 or special cell configuration. In some implementations, if the cell 124A and first cell are not synchronized, the DU 174 determines to include the reconfiguration with sync configuration in the LTM configuration 1. Otherwise, if the cell 124A and first cell are synchronized, the DU 174 determines to not include the reconfiguration with sync configuration in the LTM configuration 1. In other implementations, if the DU 174 determines that the UE 102 has not synchronized in UL with the first cell, the DU 174 determines to include the reconfiguration with sync configuration in the LTM configuration 1. Otherwise, if the DU 174 determines that the UE 102 has synchronized in UL with the first cell, the DU 174 determines to not include the reconfiguration with sync configuration in the LTM configuration 1. In some implementations, if the LTM configuration 1 includes the reconfiguration with sync configuration, the UE 102 performs the random access procedure in the event 332 as described below, in response to or in accordance with the reconfiguration with sync configuration. Otherwise, if the LTM configuration 1 does not include the reconfiguration with sync configuration, the UE 102 skips or refrains from performing the random access procedure of the event 332. In some implementations, the DU 174 includes a cell ID (i.e., cell ID 1) of cell 1 (i.e., the first cell) in the LTM configuration 1. In some implementations, the cell ID 1 is a PCI. In further implementations, the cell ID 1 is a CGI. In some implementations, the cell ID 1 included in the LTM configuration 1 is a PCI, while the cell ID 1 included in the first CU-to-DU message is a CGI. In some further implementations, the LTM configuration 1 includes a cell index 1 indexing the cell ID 1 or the first cell (e.g., the cell index 1 is not a cell ID). The cell index takes fewer bits than the cell ID. In some implementations, the CU 172 sets the cell index 1 to a value and includes the cell index 1 in the first CU-to-DU message of the event 308.

In some implementations, after (e.g., in response to) receiving one or some of the at least one measurement report of the event 304, the base station 104 (i.e., the CU 172 or DU 174) determines to prepare additional cell(s) (i.e., cell(s) 2, . . . , N) of the base station 104 for LTM for the UE 102. In some implementations, the base station 104 determines to prepare the additional cell(s) for LTM for the UE 102 because the at least one measurement report indicates that the base station 104 can use the additional cell(s) to communicate with the UE 102. In some implementations, the additional cell(s) include the cell 124C and/or cell(s) other than the cells 124A, 124B, and 124C. In some implementations, if the L3 measurement report(s) indicate that signal strength and/or quality of a particular cell of the additional cell(s) is above a respective predetermined threshold and/or is better than the cell 124A, the CU 172 determines to prepare the particular cell for LTM for the UE 102. In other implementations, if the L1 measurement report(s) indicate that signal strength and/or quality of a particular cell of the additional cell(s) is above a first predetermined threshold and/or is better than the cell 124A, the DU 174 determines to prepare the particular cell for LTM for the UE 102. In some implementations, the respective predetermined threshold(s) for the additional cells are different from the first predetermined threshold. In further implementations, the respective predetermined threshold(s) for the additional cell(s) are the same as the first predetermined threshold. In some implementations, the respective predetermined thresholds for the additional cells are the same or different. Alternatively, the base station 104 determines to prepare the additional cell(s) for the UE 102 regardless of whether a measurement report is received from the UE 102 or not.

In cases where the CU 172 determines to prepare the additional cell(s), the CU 172 initiates and performs at least one additional LTM preparation procedure with the DU 174 to prepare the additional cell(s) for LTM, where each of the LTM preparation procedure(s) is similar to the procedure 390. In cases where the DU 174 determines to prepare the additional cell(s), the DU 174 initiates and performs at least one additional LTM preparation procedure with the CU 172 to prepare the additional cell(s) for LTM, where each of the LTM preparation procedure(s) is similar to the procedure 390.

In some implementations, the CU 172 and DU 174 perform LTM preparation procedure(s) 2, . . . , N to prepare the cell(s) 2, . . . , N, respectively, similar to the procedure 390. In some implementations, the CU 172 includes the cell ID(s) 2, . . . , N in CU-to-DU message(s) 2, . . . , N in the LTM preparation procedure(s) 2, . . . , N, respectively, similar to the first CU-to-DU message. In the LTM preparation procedure(s) 2, . . . , N, the DU 174 generates LTM configuration(s) 2, . . . , N configuring the cell(s) 2, . . . , N and includes the LTM configuration(s) 2, . . . , N in DU-to-CU message(s) 2, . . . , N, respectively, as described for the LTM configuration 1. In cases where the DU 174 receives the CU-to-DU message(s) 2, . . . , N, the DU-to-CU message(s) 2, . . . , N responds to the CU-to-DU message(s) 2, . . . , N, respectively. “N” is an integer and larger than one. For example, “N” is 2, 3, 4, 5, 6, 7, 8, 9, 10, 11, 12, 13 14, 15, 16, etc. In another example, the maximum number of “N” is 4, 8, 16, 32, etc. Examples and implementations of the LTM configuration 1 can apply to the LTM configuration(s) 2, . . . , N.

In other implementations, the CU 172 and DU 174 performs a single LTM preparation procedure (i.e., the LTM preparation procedure 390) to prepare the cell(s) 1, 2, . . . , N. In such cases, the DU 174 includes the LTM configuration(s) 1, 2, . . . , N for the cell(s) 1, 2, . . . , N, respectively in the first DU-to-CU message. In some implementations, in the first DU-to-CU message, the DU 174 includes the cell ID(s) 1, 2, . . . , N respectively associated with the LTM configuration(s) 1, 2, . . . , N to indicate that the LTM configuration(s) 1, 2, . . . , N are configured for the cell ID(s) 1, 2, . . . , N, respectively. In cases where the CU 172 determines to perform the LTM preparation procedure 390, the CU 172 includes the cell ID(s) 1, 2, . . . , N in the first CU-to-DU message to request the DU 174 to prepare the cell(s) 1, 2, . . . , N, respectively, for LTM.

In some implementations, after receiving the LTM configuration(s) 2, . . . , N from the DU 174, the CU 172 includes the LTM configuration(s) 2, . . . , N in the first container. In some implementations, the CU 172 includes the LTM configuration(s) 2, . . . , N in element(s) 2, . . . , N, respectively, and includes the element(s) 2, . . . , N in the first container. In some implementations, the CU 172 includes, in the RRC reconfiguration message, LTM ID(s) (i.e., ID(s) 2, . . . , N) for identifying the LTM configuration(s) 2, . . . , N, respectively. In some implementations, the CU 172 includes the ID(s) 2, . . . , N in the first container. For example, the CU 172 includes the ID(s) 2, . . . , N and LTM configuration(s) 2, . . . , N in the element(s) 2, . . . , N in the first addition or modification list.

In some implementations, the CU 172 assigns the ID(s) 2, . . . , N for the LTM configuration(s) 2, . . . , N, respectively. In other implementations, the CU 172 receives the ID(s) 2, . . . , N from the DU 174 in the first DU-to-CU message of the procedure 390. In yet other implementations, the CU 172 receives, from the DU 174, the ID(s) 2, . . . , N in the DU-to-CU message(s) 2, . . . , N of the LTM preparation procedure(s) 2, . . . , N, respectively.

In some implementations, the CU 172 performs an LTM ID assignment procedure with the DU 174 for each of the LTM configuration(s) 2, . . . , N, similar to the procedure 392. In other implementations, the CU 172 includes the ID(s) 2, . . . , N and the LTM configuration(s) 2, . . . , N in the third CU-to-DU message and indicates the association between the ID(s) 2, . . . , N and the LTM configuration(s) 2, . . . , N, respectively. Thus, in some implementations, the DU 174 associates the LTM configuration(s) 2, . . . , N with the ID(s) 2, . . . , N, respectively. In yet other implementations, the CU 172 includes the cell ID(s) 2, . . . , N and the ID(s) 2, . . . , N in the third CU-to-DU message and indicates the association between the cell ID(s) 2, . . . , N and the ID(s) 2, . . . , N, respectively. Thus, in further implementations, the DU 174 associates the LTM configuration(s) 2, . . . , N with the ID(s) 2, . . . , N, respectively, based on the association between the cell ID(s) 2, . . . , N and the ID(s) 2, . . . , N, and the association between the cell ID(s) 2, . . . , N and the LTM configuration(s) 2, . . . , N, respectively. In other implementations, the CU 172 includes the ID(s) 2, . . . , N, the cell ID(s) 2, . . . , N and/or the LTM configuration(s) 2, . . . , N in the second CU-to-DU message as described above. Thus, the CU 172 can omit the third CU-to-DU message. In yet other implementations, the CU 172 includes the ID(s) 2, . . . , N in the first CU-to-DU message and indicates that the ID(s) 2, . . . , N are respectively associated with the cell ID(s) 2, . . . , N.

In some implementations, the DU 174 includes the ID(s) 2, . . . , N in the LTM configuration(s) 2, . . . , N. Thus, the CU 172 does not include the ID(s) 2, . . . , N in the RRC reconfiguration message, first container, and/or element(s) 2, . . . , N.

In some alternative implementations, the DU 174 assigns the ID(s) 2, . . . , N. In some implementations, the DU 174 includes the ID(s) 2, . . . , N in the first DU-to-CU message of the procedure 390. In yet other implementations, the DU 174 includes the ID(s) 2, . . . , N in the DU-to-CU message(s) 2, . . . , N of the LTM preparation procedure(s) 2, . . . , N. In some implementations, the CU 172 includes the ID(s) 2, . . . , N in the RRC reconfiguration message. In other implementations, the DU 174 includes the ID(s) 2, . . . , N in the LTM configuration(s) 2, . . . , N. Thus, the CU 172 does not include an ID (e.g., LTM ID) identifying each of the LTM configuration(s) 2, . . . , N in the RRC reconfiguration message, first container, and/or element 1.

In some alternative implementations, the CU 172 generates a second container including the LTM configuration(s) 2, . . . , N or element(s) 2,. . . , N instead of using the first container. The CU 172 then transmits an additional RRC reconfiguration message, including the second container, to the UE 102 via the DU 174, similar to the events 316 and 318. In response, the UE 102 transmits an additional RRC reconfiguration complete message to the CU 172 via the DU 174, similar to the events 320 and 322. In some implementations, the second container is a second addition or modification list (e.g., ltm-ConfigToAddModList field, LTM-ConfigToAddModList IE, Itm-CandidateConfigToAddModList field, or LTM-CandidateConfigToAddModList IE), and each of the element(s) 2, . . . , N is an addition or modification IE (e.g., ltm-ConfigToAddMod field, LTM-ConfigToAddMod IE, ltm-CandidateConfigToAddMod field, or LTM-CandidateConfigToAddMod IE). In some implementations, when the UE 102 receives the second addition or modification list, the UE 102 stores the second addition or modification list together with the first addition or modification list (e.g., in a variable in the random access memory (RAM)).

In some implementations, the DU 174 includes cell ID(s) 2, . . . , N in the LTM configuration(s) 2, . . . , N to identify the cell(s) 2, . . . , N, respectively. In some implementations, each of the cell ID(s) 2, . . . , N is a PCI. In some further implementations, the LTM configuration(s) 2, . . . , N includes cell index(es) 2, . . . , N indexing the cell ID(s) 2, . . . , N or the cell(s) 2, . . . , N, respectively. In some cases where the CU 172 prepares the cell(s) 2, . . . , N for LTM in the procedure 390, the CU 172 sets the cell index(es) 2, . . . , N to different value(s) and includes the cell index(es) 2, . . . , N in the first CU-to CU-to-DU message of the event 308. In some cases where the CU 172 prepares the cell(s) 2, . . . , N in the additional LTM preparation procedure(s), the CU 172 sets the cell index(es) 2, . . . , N to different values and includes the cell index(es) 2, . . . , N in CU-to-DU message(s) of the additional LTM preparation procedure(s).). The CU 172 sets the cell index(es) 1, . . . , N to different values. In some implementations, the cell ID(s) 1, . . . , N in the LTM configuration(s) 1, . . . , N are different from the cell ID(s) 1, . . . , N in the CU-to-DU message(s) described above.

In some implementations, each of the LTM configuration(s) 1, . . . , N includes physical configuration parameters, MAC configuration parameters, RLC configuration parameters, and/or L1 measurement configuration(s). In some implementations, each of the LTM configuration(s) 1, . . . , N is a CellGroupConfig IE (e.g., as defined in 3GPP TS 38.331). In other implementations, each of the LTM configuration(s) 1, . . . , N include configuration parameters included in a CellGroupConfig IE (e.g., as defined in 3GPP TS 38.331). In some further implementations, the plurality of configuration parameters in each of the LTM configuration(s) include a particular special cell configuration (e.g., SpCellConfig IE) and/or one or more SCell configurations (e.g., SCellConfig IE(s)). In some implementations, the LTM configuration(s) 1, . . . , N are CellGroupConfig IE(s) (e.g., defined in 3GPP TS 38.331). In other implementations, the LTM configuration(s) 1, . . . , N include configuration parameters in the CellGroupConfig IE.

In some implementations, the CU 172 determines to release the LTM configuration M of the LTM configuration(s) 1, . . . , N (or the element M of the element(s) 1, . . . , M), where 1≤M≤N. In response to the determination, the CU 172 transmits an RRC reconfiguration message to the UE 102 via the DU 174 to indicate to the UE 102 to release the LTM configuration M or element M. In some implementations, the CU 172 generates a release list including the ID (i.e., LTM ID) M for releasing the LTM configuration M or element M and includes the release list in the RRC reconfiguration message. In response to the RRC reconfiguration message, the UE 102 releases the LTM configuration M or element M and transmits an RRC reconfiguration complete message to the CU 172 via the DU 174. In response to the determination, the CU 172 transmits a CU-to-DU message to the DU 174 to indicate to the DU 174 to release the LTM configuration M. In some implementations, to indicate to the DU 174 to release the LTM configuration M, the CU 172 includes the cell ID M or the ID (i.e., LTM ID) M in a release indication (e.g., a field or IE) in the CU-to-DU message. In response, the DU 174 releases the LTM configuration M and transmits a DU-to-CU message to the CU 172. In some implementations, the CU-to-DU message and DU-to-CU message are a UE Context Modification Request message and a UE Context Modification Response message, respectively.

In other implementations, the DU 174 determines to release the LTM configuration K. In response to the determination, the DU 174 transmits a DU-to-CU message to the CU 172 to release the LTM configuration K. In some implementations, to indicate that the LTM configuration K is released, the DU 174 includes the cell ID K or the ID (i.e., LTM ID) K in a release indication (e.g., a field or IE) in the DU-to-CU message. Further, 1≤K ≤N. After (e.g., in response to) receiving the DU-to-CU message, the CU 172 generates a release list including the ID (i.e., LTM ID) K to release the LTM configuration K or element K and transmits an RRC reconfiguration message including the release list to the UE 102 via the DU 174. In response, the UE 102 releases the LTM configuration K or element K and transmits an RRC reconfiguration complete message to the UE 102 via the DU 174. In some implementations, the CU 172 transmits a CU-to-DU message to the DU 174 in response to the DU-to-CU message. In some implementations, the DU-to-CU message and CU-to-DU message are a UE Context Modification Required message and a UE Context Modification Confirm message, respectively.

After receiving the RRC reconfiguration in the event 318 or transmitting the RRC reconfiguration complete message in the event 320, the UE 102 transmits 324 at least one measurement report to the DU 174, similar to the event 304. In some implementations, the DU 174 transmits 326 a DU-to-CU message, including the at least one measurement report, to the CU 172, similar to the event 306. In other implementations, the DU 174 does not transmit the at least one measurement report to the CU 172. In some implementations, the at least one measurement report of the event 324 includes L1 measurement report(s) or L3 measurement repot(s), as described for the event 304. In some implementations, the UE 102 transmits 324 the at least one measurement report on PUCCH(s) and/or PUSCH(s) to the DU 174, similar to the event 304. In other implementations, the UE 102 transmits 324 at least one MAC CE including the at least one measurement report to the DU 174, similar to the event 304. In some implementations, the UE 102 does not transmit the L1 measurement report(s) in format of RRC message(s) to the DU 174.

In some implementations, the UE 102 transmits 324 the at least one measurement report to the DU 174 in accordance with at least one measurement configuration. The at least one measurement configuration configures the UE 102 to perform measurements and report measurement results. The CU 172 transmits the at least one measurement configuration to the UE 102 via the DU 174. For example, the CU 172 transmits one or more RRC messages (e.g., RRCReconfiguration message(s)), including the at least one measurement configuration, to the UE 102 via the DU 174 in the event 302 and/or 316 and/or after the event 306 or 316. Depending on the implementation, the one or more RRC messages do or do not include the RRC reconfiguration message of the event 316. In accordance with the at least one measurement configuration, the UE 102 performs measurements on one or more reference signals. In some implementations, the one or more reference signals include one or more SSBs and/or one or more CSI-RSs. The UE 102 obtains the at least one L1 measurement result and/or at least one L3 measurement result from the measurements and includes the at least one L1 measurement result and/or at least one L3 measurement result in the at least measurement report of the event 324. The DU 174 transmits the one or more reference signals on the cell 124A, the cell 1, and/or the cell(s) 2, . . . , N. Depending on the implementation, the one or more reference signals are CSI-RS(s) or SSB(s).

In some implementations, the at least one measurement configuration includes L3 measurement configuration(s) (e.g., MeasConfig IE(s)), as described for the event 304. In other implementations, the at least one measurement configuration includes L1 measurement configuration(s), as described for the event 304. For example, the L1 measurement configuration(s) are CSI-MeasConfig IE(s) (e.g., defined in 3GPP TS 38.331). In some implementations, the L1 measurement configuration(s) include measurement report configuration(s). The UE 102 transmits the L1 measurement report(s) on PUCCH(s) or MAC CE(s) to the DU 174 in accordance with the measurement report configuration(s). The DU 174 receives the L1 measurement report(s) on PUCCH(s) or MAC CE(s) in accordance with the measurement report configuration(s). In some implementations, the measurement report configuration(s) are CSI-ReportConfig IE(s). In other implementations, each of the measurement report configuration(s) is a specifically-defined RRC IE. In some implementations, (each of) the measurement report configuration(s) configures periodically reporting and/or event-triggered reporting of the L1 measurement result(s).

In yet other implementations, the at least one measurement configuration includes specifically defined type measurement configuration(s) (e.g., LTM measurement configuration(s)). In some implementations, the specifically defined type measurement configuration(s) are specifically defined (e.g., in a 3GPP TS) for LTM. In some implementations, the specifically defined type measurement configuration(s) include reference signal resource configuration(s) configuring resources where the DU 174 transmits reference signal(s). For example, the reference signal resource configuration(s) include CSI-RS(s) and/or SSB(s). In some implementations, the reference signal resource configuration(s) are CSI-ResourceConfig IE(s). In further implementations, the specifically defined type measurement configuration(s) include measurement report configuration(s), as described above. The UE 102 transmits the measurement report(s) on PUCCH(s) or MAC CE(s) to the DU 174 in accordance with the measurement report configuration(s). The DU 174 receives the measurement report(s) on PUCCH(s) or MAC CE(s) in accordance with the measurement report configuration(s). In some such cases, the measurement report(s) are L1 measurement report(s) or specifically defined type measurement report(s) (e.g., LTM measurement report(s)). In some implementations, the specifically defined type measurement configuration includes configuration parameters (e.g., specifically defined in a 3GPP TS).

After (e.g., in response to) receiving the at least one measurement report in the event 324, the DU 174 generates a first LTM command to activate the LTM configuration 1 (i.e., the first LTM command commands the UE 102 to apply the LTM configuration 1 or to perform a serving cell change to the cell 1). The DU 174 then transmits 330 the first LTM command to the UE 102. In some implementations, the DU 174 transmits the first LTM command on the cell 124A to the UE 102. In other implementations, the DU 174 transmits the first LTM command on the cell 124D to the UE 102. In some implementations, the DU 174 includes the ID 1 in the first LTM command to indicate the LTM configuration 1, and the UE 102 determines (e.g., identifies) the LTM configuration 1 or element 1 in accordance with the ID 1. In other implementations, the DU 174 includes the cell index 1 indexing the cell ID 1 in the first LTM command. The UE 102 determines (e.g., identifies) the LTM configuration 1 or element 1 based on the cell index 1. After determining the LTM configuration 1 or element 1, the UE 102 then applies the LTM configuration 1 in response to receiving the first LTM command.

In yet other implementations, the DU 174 includes a bit map in the first LTM command to activate the LTM configuration 1, instead of the ID 1 or cell index 1. The number of bits in the bit map is larger than or equal to “N”. In some implementations, bit 1, . . . , N corresponds to the cell index(es) 1, . . . , N; the ID(s) 1, . . . , N; the LTM configuration(s) 1, . . . , N; or the element(s) 1, . . . , N, respectively, and the DU 174 sets a corresponding bit (e.g., bit 1) in the bit map to a first value to indicate the cell index 1, the ID 1, the LTM configuration 1, or the element 1. Thus, in some such implementations, the UE 102 determines the cell index 1, the ID 1, LTM configuration 1, or element 1 in accordance with the bit 1 set to the first value in the bit map. In further implementations, bit 0, . . . , N-1 corresponds to the cell index(es) 1, . . . , N; the ID(s) 1, . . . , N; the LTM configuration(s) 1, . . . , N; or the element(s) 1, . . . , N, respectively, and the DU 174 sets a corresponding bit (e.g., bit 0) in the bit map to a first value to indicate the cell index 1, the ID 1, the LTM configuration 1, or the element 1. Thus, in some such implementations, the UE 102 determines the cell index 1, the ID 1, LTM configuration 1, or the element 1 in accordance with the bit 0 set to the first value in the bit map. In such implementations, the DU 174 sets the remaining bits in the bit map to a second value to indicate that the rest of the LTM configuration(s) 1, . . . , N are not activated. In some implementations, the first value is one and the second value is zero.

In other implementations, the first value is zero and the second value is one. Generally, depending on the implementation, if the DU 174 determines to activate the LTM configuration L or change a serving cell to the cell L, the DU 174 sets the corresponding bit (e.g., bit L or bit L-1) in the bit map to the first value and sets the remaining bits to the second value, where 1≤L≤N. In some implementations, the DU 174 sets at most one bit in the bit map to the first value.

In some implementations, the at least one measurement report (e.g., L1 measurement report(s) or specifically defined type measurement report(s)) of the event 324 includes at least one measurement result for the first cell, TRP(s) of the first cell or reference signal(s) transmitted on the first cell. In some implementations, the reference signal(s) are CSI-RS(s) or SSB(s). The DU 174 determines to activate the LTM configuration 1 or transmit the first LTM command, based on the at least one measurement result. In some implementations, the DU 174 determines to activate the LTM configuration 1 because, when, or if the at least one measurement result is above a second predetermined threshold. In some implementations, the at least one measurement result includes L1-RSRP value(s), L1-RSRQ value(s) and/or L1-SINR value(s). In other implementations, the at least one measurement result includes RSRP value(s), RSRQ value(s), and/or SINR value(s) for the specifically defined type measurement report(s). In some implementations, the second predetermined threshold is different from the first predetermined threshold. In some implementations, the second predetermined threshold is larger than the first predetermined threshold. In this case, the at least one measurement result indicates that the first cell is suitable for communication with the UE 102. In another implementation, the second predetermined threshold is equal to the first predetermined threshold. In such cases, the at least one measurement result indicates that the first cell has been continuously above the second predetermined threshold or the first predetermined threshold. Such indicates that the first cell is suitable for communication with the UE 102. Thus, the DU 174 determines to activate the LTM configuration 1 in response to the signal strength or quality of the first cell being above the second predetermined threshold for the UE 102.

In some implementations, the at least one measurement report (e.g., L3 measurement report(s)) of the events 324 and 326 includes at least one measurement result for the first cell. The CU 172 determines to activate the LTM configuration 1 or transmit the first LTM command, because the at least one measurement result indicates that signal strength or quality of the first cell is above a second predetermined threshold. The second predetermined threshold is different from the first predetermined threshold. In some implementations, the second predetermined threshold is larger than the first predetermined threshold. In such an implementation, the at least one measurement report of the event 326 indicates that signal strength or quality of the first cell is suitable for communication with the UE 102. In further implementations, the second predetermined threshold is equal to the first predetermined threshold. In such an implementation, the at least one measurement report of the event 326 indicates that signal strength or quality of the first cell has been continuously above the second predetermined threshold or the first predetermined threshold, further indicating that the first cell is suitable for communication with the UE 102. Thus, the CU 172 determines to activate the LTM configuration 1 in response to the signal strength or quality of the first cell being above the second predetermined threshold. In response to the determination, the CU 172 transmits 328 a fourth CU-to-DU message to the DU 174 to activate the LTM configuration 1 or trigger a serving cell change to the cell 1 for the UE 102. In some implementations, the CU 172 includes the ID 1 in the fourth CU-to-DU message. In other implementations, the CU 172 includes the cell index 1 in the fourth CU-to-DU message. In response to the fourth CU-to-DU message, the DU 174 transmits 330 the first LTM command to the UE 102 and, optionally, transmits a fourth DU-to-CU message to the CU 172. In some implementations, the CU 172 includes the cell index 1 in the fourth CU-to-DU message. Thus, in some such implementations, the DU 174 determines to activate the LTM configuration 1 in accordance with the cell index 1. In other implementations, the CU 172 can include the cell ID 1 in the fourth CU-to-DU message. Thus, the DU 174 determines to activate the LTM configuration 1 in accordance with the cell ID 1. In yet other implementations, the CU 172 can include the ID 1 in the fourth CU-to-DU message. Thus, the DU 174 can determine to activate the LTM configuration 1 in accordance with the ID 1. In some implementations, the fourth CU-to-DU message and fourth DU-to-CU message are a UE Context Modification Request message and a UE Context Modification Response message, respectively. In other implementations, the fourth CU-to-DU message and/or fourth DU-to-CU message are specifically defined interface messages (e.g., F1 application protocol (F1AP) messages (e.g., specifically defined in 3GPP TS 38.473)) for such purposes.

In some implementations, when or in response to determining to activate the LTM configuration 1 or transmit the first LTM command, the DU 174 transmits 329 to the CU 172 a DU-to-CU message indicating that LTM is (being) executed. In some implementations, the DU 174 includes the cell ID 1 or the ID 1 (i.e., LTM ID) in the DU-to-CU message 329 to indicate that the DU 174 is to activate the LTM configuration 1. Depending on the implementation, the DU transmits the DU-to-CU message 329 to the CU 172 before or after transmitting the LTM command 330.

In some implementations, the first LTM command is a MAC CE included in a MAC PDU that the UE 102 receives from the DU 174 in the event 330. In some implementations, the MAC CE is a specifically defined MAC CE (e.g., in 3GPP TS 38.321). In some implementations, the DU 174 includes a subheader identifying the specifically defined MAC CE in the MAC PDU, and the UE 102 identifies the specifically defined MAC CE in the MAC PDU in accordance with the subheader. In some implementations, the subheader includes a logical channel ID or extended logical channel ID (e.g., defined in a 3GPP TS) to identify the specifically defined MAC CE. For example, the logical channel ID or extended logical channel ID are specifically defined (e.g., in 3GPP TS 38.321) for identifying the specifically defined MAC CE. In other implementations, the first LTM command is a DCI that the UE 102 receives on a PDCCH from the DU 174 in the event 330. The DU 174 generates a CRC for the DCI, scrambles the CRC with a first C-RNTI of the UE 102, and transmits the DCI and scrambled CRC on the PDCCH in the event 330. In some implementations, a format of the DCI is an existing DCI format (e.g., defined in 3GPP TS 38.212). In further implementations, the format of the DCI is a specifically defined DCI format (e.g., defined in 3GPP TS 38.212) for such.

In some implementations, the DU 174 does not perform security protection (e.g., integrity protection and/or encryption) on the first LTM command. This speeds up processing the first LTM command in the UE 102 because the UE 102 does not perform a security check (e.g., decryption and/or integrity check) on the first LTM command.

In some implementations, after receiving the first LTM command, the UE 102 transmits 331 an acknowledgement to the DU 174 on the cell 124A or cell 124D to indicate that the UE 102 receives the first LTM command. In some implementations, the acknowledgement is a HARQ ACK. In other implementations, the acknowledgement is a MAC CE. For example, the MAC CE is an existing MAC CE (e.g., defined in 3GPP TS 38.321). In another example, the MAC CE is a specifically defined MAC CE (e.g., defined in 3GPP TS 38.321). In yet other implementations, the acknowledgement is a PUCCH transmission.

In some implementations, the CU 172 transmits 316 the RRC reconfiguration message in response to the L3 measurement report 306 for the first cell. In some implementations, to configure the UE 102 to transmit the L3 measurement report 306, the CU 172 transmits a first RRC reconfiguration message, including the L3 measurement configuration (e.g., a MeasConfig IE), to the UE 102 before the event 306. In some implementations, the DU 174 transmits 330 the first LTM command in response to the L1 measurement report(s) 324 for the first cell. In some implementations, to configure the UE 102 to transmit the L1 or specifically defined type measurement report(s) 324, the CU 172 transmits a second RRC reconfiguration message including the L1 or specifically defined type measurement configuration(s) to the UE 102. In some implementations, the first and second RRC reconfiguration messages are the same message (i.e., the same instance). In other implementations, the first and second RRC reconfiguration messages are different messages. In some implementations, the second RRC reconfiguration message is the RRC reconfiguration message of the event 316. In other implementations, the second RRC reconfiguration message is different from the RRC reconfiguration message of the event 316.

After (e.g., in response to) receiving the first LTM command, the UE 102 identifies the LTM configuration 1 in accordance with the ID 1 and applies the LTM configuration 1. In some implementations, the UE 102 performs 332 a random access procedure on the first cell with the DU 174 in response to applying the LTM configuration 1 or receiving the first LTM command. In some implementations, the UE 102 disconnects from the cell 124A after (e.g., in response to) receiving the first LTM command or after transmitting the acknowledgement. In other words, the UE 102 stops communicating on the cell 124A after (e.g., in response to) receiving 330 the first LTM command or transmitting 331 the acknowledgement. In such cases, the UE 102 performs 332 the random access procedure after disconnecting from the cell 124A. In some implementations, the UE 102 determines whether to perform the random access procedure in accordance with the LTM configuration 1. In some implementations, if the LTM configuration 1 configures the UE 102 to perform a random access procedure, the UE 102 performs the random access procedure in the event 332. For example, the LTM configuration 1 includes a reconfiguration with sync configuration (e.g., Reconfiguration WithSync IE) to configure the UE 102 to perform a random access procedure. Otherwise, if the LTM configuration 1 does not configure the UE 102 to perform a random access procedure or configures the UE 102 to skip a random access procedure, the UE 102 refrains from performing a random access procedure with the DU 174 upon receiving the first LTM command. In such cases, the UE 102 skips the event 316. For example, if the LTM configuration 1 excludes a reconfiguration with sync configuration, the LTM configuration 1 configures the UE 102 not to perform a random access procedure. In some implementations, the random access procedure is a four-step random access procedure. In other implementations, the random access procedure is a two-step random access procedure. In some implementations, the random access procedure is a contention-free random access procedure. In other implementations, the random access procedure is a contention-based random access procedure.

In cases where the UE 102 performs 332 the random access procedure, the UE 102 communicates 336 with the DU 174 on the first cell using the LTM configuration 1 and reference LTM configuration, and communicates with the CU 172 via the DU 174, after successfully completing the random access procedure. In such cases, the DU 174 communicates with the UE 102 on the first cell using the LTM configuration 1 in the event 332 and/or event 336. In some scenarios or implementations, the UE 102 communicates UL PDUs, DL PDUs, and/or physical layer signals (e.g., PUCCH transmissions and PDCCH transmissions) with the base station 104 in the event 336. In some implementations, the UE 102 determines that the UE 102 successfully completes the random access procedure when the UE 102 receives a contention resolution from the DU 174. In cases where the random access procedure is a four-step random access procedure, the UE 102 transmits a Message 3 including a UE identity to the DU 174 via the first cell in the random access procedure. In cases where the random access procedure is a two-step random access procedure, the UE 102 transmits a Message A including the UE identity to the DU 174 via the first cell in the random access procedure. In some implementations, if the LTM configuration 1 includes a second C-RNTI, the UE identity is the second C-RNTI of the UE 102. Otherwise, if the LTM configuration 1 does not include a C-RNTI, the UE identity is the first C-RNTI. In cases where the random access procedure is a contention free random access procedure, the UE 102 transmits the dedicated random access preamble to the DU 174 via the first cell. In such cases, the LTM configuration 1 includes the dedicated random access preamble.

The DU 174 identifies or determines that the UE 102 connects to the first cell upon receiving the UE identity or the dedicated preamble from the UE 102 in the random access procedure 332.

In cases where the UE 102 skips the random access procedure, the UE 102 directly communicates 336 with the DU 174 on the first cell in accordance with the LTM configuration 1 and communicates with the CU 172 via the DU 174, after (e.g., in response to) receiving the first LTM command. For example, the UE 102 directly communicates UL PDUs, DL PDUs, and/or physical layer signals (e.g., PUCCH transmissions and PDCCH transmissions) with the base station 104 in the event 336. In some implementations, the DU 174 includes, in the LTM configuration 1, configuration parameters configuring resources for the UE 102 to transmit the at least one PUCCH or PUSCH transmission, and the UE 102 transmits the at least one PUCCH or PUSCH transmission on the resources, using the configuration parameters, to indicate that the UE 102 connects to the first cell. In other implementations, the DU 174 transmits, to the UE 102, at least one DCI on a PDCCH on the first cell to command the UE 102 to transmit the at least one PUCCH or PUSCH transmission, after transmitting the first LTM command. The at least one DCI configures resources for the UE 102 to transmit the at least one PUCCH or PUSCH transmission, and the UE 102 transmits the at least one PUCCH or PUSCH transmission on the resources. The DU 174 identifies or determines that the UE 102 connects to the first cell upon receiving the PUCCH or PUSCH transmission. The DU 174 identifies or determines that the UE 102 connects to the first cell upon receiving the PUCCH or PUSCH transmission on the resources configured in the LTM configuration 1 or the at least one DCI.

In cases where the UE 102 receives the reference LTM configuration as described above, the UE 102 communicates 336 with the DU 174 on the first cell in accordance with the LTM configuration 1 and at least a portion of the reference LTM configuration. In other words, the UE 102 communicates 336 with the DU 174 in accordance with configuration parameters in the LTM configuration 1 and the reference LTM configuration. Similarly, the DU 174 communicates 336 with the UE 102 on the first cell in accordance with the LTM configuration 1 and at least a portion of the reference LTM configuration. In other words, the DU 174 communicates 336 with the UE 102 in accordance with configuration parameters in the LTM configuration 1 and the reference LTM configuration.

In some implementations, the UE 102 transmits an RRC message (e.g., RRC reconfiguration complete message) to the CU 172 via the DU 174 and the first cell to indicate that the UE 102 applies the LTM configuration 1. In some implementations where the UE 102 performs the random access procedure 332, the UE 102 includes the RRC message in the Message 3 or Message A. Alternatively, the UE 102 transmits the RRC message after completing the random access procedure. In cases where the UE 102 skips the random access procedure 332, the UE 102 includes the RRC message in a PUSCH transmission of the at least one PUSCH transmission. In some implementations, if the UE 102 maintains communication on the cell 124A with the base station 104 (i.e., the UE 102 does not disconnect from the cell 124A), the UE 102 transmits the RRC message to the base station 104 via the cell 124A. When the DU 174 receives the RRC message, the DU 174 transmits the RRC message to the CU 172.

In other implementations, the UE 102 refrains from transmitting the RRC message to the base station 104 in response to applying the LTM configuration 1 or receiving the first LTM command. In some such cases, the UE 102 includes or transmits data in the Message 3, Message A or PUSCH transmission as described above. In some implementations, the UE 102 generates a MAC PDU and/or an RLC PDU, including the data, and transmits or includes the MAC PDU and/or RLC PDU in the PUSCH transmission. For example, depending on the implementation, the data is a PDCP PDU, an SDAP PDU, an LTE Positioning Protocol (LPP) PDU, an RRC PDU, and/or a NAS PDU. The RRC PDU includes a UL-DCCH-Message excluding an RRC reconfiguration complete message. The NAS PDU includes a Mobility Management (MM) message or a Session Management (SM) message. Depending on the implementation, the MM message is a 5G MM message or a 6G MM message, and the SM message is a 5G SM message or a 6G SM message. When the DU 174 receives the data, the DU 174 transmits the data to the CU 172.

In some implementations, when the DU 174 determines that the UE 102 successfully connects to the first cell in the event 332 or 336, the DU 174 transmits 334 a DU-to-CU message (e.g., Access Success message) to the CU 172 (e.g., a CP of the CU 172). In some implementations, the DU 174 includes the cell ID 1 of the first cell in the DU-to-CU message of the event 334. In some implementations, the cell ID is a PCI or a CGI. Thus, the CU 172 determines that the UE 102 connects to the first cell upon receiving the DU-to-CU message of the event 334. In some implementations, when the DU 174 determines that the UE 102 successfully connect to the first cell in the event 332 or 336, the DU 174 transmits a DL Data Delivery Status message or frame to the CU 172 (e.g., a UP of the CU 172).

In some implementations, when determining that the UE 102 connects to the first cell, transmitting 330 the first LTM command, or receiving 331 the acknowledgement, the DU 174 stops communicating with the UE 102 on the cell 124A and/or releases resources of the cell 124A configured for the UE 102.

In some implementations, the DU 174 generates some or all of the LTM configuration 1 and/or LTM configuration(s) 2, . . . , N as full configuration(s) to replace the serving DU configuration. If the LTM configuration 1 is a full configuration, the UE 102 and DU 174 communicate 336 with each other in accordance with the LTM configuration 1 instead of the serving DU configuration. In some implementations, the DU 174 includes an indication that the LTM configuration 1 is a full configuration in the LTM configuration 1.

In some implementations, in each of the LTM configuration(s) 2, . . . , N, the DU 174 includes an indication to indicate that the corresponding DU configuration is a full configuration. In some implementations, each of the indication(s) in the LTM configuration(s) 1, . . . , N is a field or IE (i.e., the same field or IE). In other implementations, the CU 172 includes, in the RRC reconfiguration message of the events 316, 318, a single indication that the LTM configuration(s) 1 and/or 2, . . . , N is/are full configuration(s). In some cases, for the second container, the CU 172 includes, in the additional RRC reconfiguration message, a single indication that the LTM configuration(s) 2, . . . , N is/are full configuration(s). In yet other implementations, the CU 172 includes, in the first container, a single indication that the LTM configuration(s) 1 and/or 2, . . . , N is/are full configuration(s). In yet other implementations, for each of the LTM configuration(s) 2, . . . , N, the CU 172 includes, in the first container, a particular indication that the corresponding LTM configuration is a full configuration. In some cases, for the second container, the CU 172 includes, in the second container, a single indication that the LTM configuration(s) 2, . . . , N is/are full configuration(s). In yet other implementations, the CU 172 includes, in the element 1, an indication that the LTM configuration 1 is a full configuration. In some implementations, in each of the element(s) 2, ..., N, the CU 172 includes an indication that the corresponding LTM configuration is a full configuration. In some implementations, the UE 102 determines that the LTM configuration 1 and/or LTM configuration(s) 2, . . . , N are full configuration(s) based on the indication(s) above. In some implementations, each of the indication(s) above is different from a fullConfig field (e.g., as defined in the current 3GPP TS). In some implementations, each of the indication(s) above is a fullConfig field (e.g., as defined in the current 3GPP TS). In cases where the LTM configuration 1 is a full configuration, the UE 102 in the event 336 does not apply the reference LTM configuration if received from the base station 104 (e.g., in the RRC reconfiguration message 318). In some such cases, the DU 174 does not include a reference LTM configuration in the first DU-to-CU message 310.

In other implementations, the DU 174 generates the LTM configuration 1 and/or LTM configuration(s) 2, . . . , N as delta configuration(s) that augment at least a portion of the reference LTM configuration. In other words, the DU 174 generates the LTM configuration(s) 1, ... N based on the reference LTM configuration. For example, if the LTM configuration 1 is a delta configuration, the UE 102 and DU 174 augment at least the portion of the reference LTM configuration with the LTM configuration 1. Thus, the UE 102 and DU 174 communicate 336 with each other in accordance with the LTM configuration 1 and unaugmented portion of the reference LTM configuration. In some implementations, the LTM configuration(s) 1 and/or 2 ..., N, first container, second container, or element(s) 1, . . . , N exclude indication(s) indicating that the LTM configuration(s) 1 and/or 2 ..., N are full configuration(s) to indicate that the LTM configuration(s) 1 and/or 2, . . . , N are delta configuration(s). In some implementations, the UE 102 determines that each of the LTM configuration(s) 1 and/or 2, . . . , N is a delta configuration based on the indication being excluded in the LTM configuration(s) 1 and/or 2, . . . , N, first container, second container, or element(s) 1 and/or 2, . . . , N.

In some implementations, if the UE 102 does not receive a reference LTM configuration for the LTM configuration 1 and/or the LTM configuration(s) 2, . . . , N, the UE 102 determines that the LTM configuration 1, and/or the LTM configuration(s) 2, . . . , N are full configuration(s). Correspondingly, if the DU 174 does not obtain a reference LTM configuration for the UE 102 (i.e., the DU 174 does not generate a reference LTM configuration for the UE 102 and/or receive a reference LTM configuration for the UE 102 from the CU 172), the DU 174 generates the LTM configuration 1, and/or the LTM configuration(s) 2, . . . , N as full configuration(s).

In other implementations, if the UE 102 does not receive a reference LTM configuration for the LTM configuration 1 and/or the LTM configuration(s) 2, . . . , N, the UE 102 determines that the LTM configuration 1 and/or the LTM configuration(s) 2, . . . , N are delta configuration(s) to augment the serving DU configuration. In such cases, the UE 102 communicates 336 with the DU 174 in accordance with the LTM configuration 1 and at least a portion of the serving DU configuration not augmented by LTM configuration 1.

Correspondingly, if the DU 174 does not obtain a reference LTM configuration for the UE 102 (i.e., the DU 174 does not generate a reference LTM configuration for the UE 102 and/or receive a reference LTM configuration for the UE 102 from the CU 172), the DU 174 generates the LTM configuration 1 and/or the LTM configuration(s) 2, . . . , N as delta configuration(s) to augment the serving DU configuration. In such cases, the DU 174 communicates 336 with the UE 102 in accordance with the LTM configuration 1 and the at least a portion of the serving DU configuration.

In some implementations, the UE 102 uses a UE MAC entity (e.g., MAC 204B) to communicate with a DU MAC entity (e.g., MAC 204B) of the DU 174 (e.g., the events 302, 304, 318, 320, 324, 330, and/or 331). In some implementations, the UE 102 resets the UE MAC entity, after or in response to receiving the first LTM command and before performing 332 the random access procedure or communicating 336 with the DU 174 via the first cell. In some implementations, the DU 174 resets the DU MAC entity after (e.g., in response to) transmitting the first LTM command, receiving the acknowledgement 331, or determining that the UE 102 connects to the first cell.

In some implementations, when the UE 102 resets the UE MAC entity, the UE 102 performs at least one of the following actions for the UE MAC entity (i.e., UE MAC reset or full UE MAC reset): (i) initialize Bj for configured logical channel(s) to zero; (ii) stop one or more timers; (iii) consider timeAlignmentTimer(s) as expired if the UE 102 is configured to perform the random access procedure (e.g., the event 332) in the configuration (e.g., the configuration 1); (iv) set new data indicator(s) (NDI(s)) for UL HARQ process(es) to value 0; (v) set NDI(s) for HARQ process ID(s) to value 0 for monitoring PDCCH in Sidelink resource allocation mode 1; (vi) flush Msg3 buffer; (vii) flush MSGA buffer; (viii) cancel, if any, triggered Scheduling Request procedure; (ix) cancel, if any, triggered Buffer Status Reporting procedure; (x) cancel, if any, triggered Power Headroom Reporting procedure; (xi) cancel, if any, triggered consistent LBT failure; (xii) cancel, if any, triggered BFR; (xiii) cancel, if any, triggered Sidelink Buffer Status Reporting procedure; (xiv) cancel, if any, triggered Pre-emptive Buffer Status Reporting procedure; (xv) cancel, if any, triggered Timing Advance Reporting procedure; (xvi) cancel, if any, triggered Recommended bit rate query procedure; (xvii) cancel, if any, triggered configured uplink grant confirmation; (xviii) cancel, if any, triggered configured sidelink grant confirmation; (xix) cancel, if any, triggered Desired Guard Symbol query; (xx) cancel, if any, triggered Positioning Measurement Gap Activation/Deactivation Request procedure; (xxi) flush soft buffers for DL HARQ process(es); (xxii) for each of the DL HARQ process(es), consider the next received transmission for a TB as the very first transmission; (xxiii) release, if any, Temporary C-RNTI; and/or (xiv) reset one or more counters (e.g., BFI_COUNTERs and/or LBT_COUNTERs).

In some implementations, when the DU 174 resets the DU MAC entity, the DU 174 performs at least one of the following actions for the DU MAC entity (i.e., DU MAC reset or full DU MAC reset): (i) stop one or more timers; (ii) consider timeAlignmentTimer(s) that the DU 174 starts and/or maintains for the UE 102 as expired if the UE 102 is configured to perform the random access procedure (e.g., the event 332) in the configuration (e.g., the configuration 1); (iii) set NDI(s) for DL HARQ process(es) to value 0; (iv) flush soft buffers for UL HARQ process(es); (v) for each of the UL HARQ process(es), consider the next received transmission for a TB as the very first transmission; and/or (vi) reset one or more counters (e.g., BFI_COUNTERs and/or LBT_COUNTERs).

Depending on implementations, the UE 102 determines to partially or fully reset the UE MAC entity. In some implementations, when the UE 102 resets the UE MAC entity as described above, the UE 102 fully resets the UE MAC entity (i.e., a full UE MAC reset). In the full UE MAC reset, the UE 102 performs some or all of the actions described above. In other implementations, when the UE 102 resets the UE MAC entity as described above, the UE 102 partially resets the UE MAC entity (i.e., a partial UE MAC reset). In the partial UE MAC reset, the UE 102 performs a subset or portion of the some or all of the actions in the full UE MAC reset.

In some implementations, the partial UE MAC reset includes at least one of the following actions: (i) consider timeAlignmentTimer(s) of the UE 102 as expired if the UE 102 is configured to perform the random access procedure (e.g., the event 332) in the configuration (e.g., the configuration 1); (ii) flush Msg3 buffer; (iii) flush MSGA buffer; (iv) release, if any, Temporary C-RNTI; and/or (v) reset one or more counters (e.g., BFI_COUNTERs and/or LBT_COUNTERs).

In some implementations, the partial UE MAC reset further includes at least one of the following actions: (i) cancel, if any, triggered Scheduling Request procedure; (ii) cancel, if any, triggered Buffer Status Reporting procedure; (iii) cancel, if any, triggered Power Headroom Reporting procedure; (iv) cancel, if any, triggered consistent LBT failure; (v) cancel, if any, triggered BFR; (vi) cancel, if any, triggered Sidelink Buffer Status Reporting procedure; (vii) cancel, if any, triggered Pre-emptive Buffer Status Reporting procedure; (viii) cancel, if any, triggered Timing Advance Reporting procedure; (ix) cancel, if any, triggered Recommended bit rate query procedure; (x) cancel, if any, triggered configured uplink grant confirmation; (xi) cancel, if any, triggered configured sidelink grant confirmation; (xii) cancel, if any, triggered Desired Guard Symbol query; and/or (xiii) cancel, if any, triggered Positioning Measurement Gap Activation/Deactivation Request procedure.

In some implementations, the partial UE MAC reset further includes at least one of the following actions: (i) stop a first portion of the one or more timers and retain the rest of the one or more timers; (ii) set new data indicator(s) (NDI(s)) for UL HARQ process(es) to value 0; (iii) set NDI(s) for HARQ process ID(s) to value 0 for monitoring PDCCH in Sidelink resource allocation mode 1; (iv) flush soft buffers for DL HARQ process(es); and/or (v) for each of the DL HARQ process(es), consider the next received transmission for a TB as the very first transmission;

Depending on implementations, the DU 174 determines to partially or fully reset the DU MAC entity. In some implementations, when the DU 174 resets the DU MAC entity as described above, the DU 174 fully resets the DU MAC entity (i.e., a full DU MAC reset). In the full DU MAC reset, the DU 174 performs some or all of the actions described above. In other implementations, when the DU 174 resets the DU MAC entity as described above, the DU 174 partially resets the DU MAC entity (i.e., a partial DU MAC reset). In the partial DU MAC reset, the DU 174 performs a subset or portion of the some or all of the actions in the full DU MAC reset.

In some implementations, the partial DU MAC reset includes at least one of the following actions in the partial MAC reset: (i) consider timeAlignmentTimer(s) that the DU 174 starts and/or maintains for the UE 102 as expired if the UE 102 is configured to perform the random access procedure (e.g., the event 332) in the configuration (e.g., the configuration 1) and/or (ii) reset one or more counters (e.g., BFI_COUNTERs and/or LBT_COUNTERs).

In some implementations, when the partial DU MAC reset includes at least one of the following actions for the MAC entity (i.e., DU MAC reset): (i) stop a first portion of the one or more timers and retain the rest of the one or more timers; (ii) set NDI(s) for DL HARQ process(es) to value 0; (iii) flush soft buffers for UL HARQ process(es); (iv) for each of the UL HARQ process(es), consider the next received transmission for a TB as the very first transmission; and/or (v) reset one or more counters (e.g., BFI_COUNTERs and/or LBT_COUNTERs).

In other implementations, the UE 102 refrains from resetting the UE MAC entity in response to receiving the first LTM command. Similarly, the DU 174 refrains from resetting the DU MAC entity after (e.g., in response to) transmitting the first LTM command, receiving the acknowledgement 331 or determining that the UE 102 connects to the first cell. In other words, the UE 102 communicates with the DU 174 on the first cell using the UE MAC entity (not reset). Similarly, the DU 174 communicates with the UE 102 using the DU MAC entity (not reset) on the first cell during or after the random access procedure 332 or after determining that the UE 102 connects to the first cell.

In some implementations, the UE 102 uses at least one UE RLC entity (e.g., RLC 206B) to communicate RLC PDUs with at least one DU RLC entity (e.g., RLC 206B) of the DU 174 (e.g., the events 302, 304, 318, 320, 324, 330 and/or 331). In some implementations, the UE 102 reestablishes some or all of the at least one UE RLC entity, after or in response to receiving the first LTM command and before performing 332 the random access procedure or communicating 336 with the DU 174 via the first cell. In some implementations, the DU 174 reestablishes some or all of the at least one DU RLC entity after (e.g., in response to) transmitting the first LTM command, receiving the acknowledgement 331 or determining that the UE 102 connects to the first cell.

In some implementations, the LTM configuration 1 does or does not include one or more RLC reestablishment indications (e.g., reestablishRLC field(s)) configuring the UE 102 to reestablish some or all of the at least one UE RLC entity. If the LTM configuration 1 includes the an RLC reestablishment indication configuring the UE 102 to reestablish a first UE RLC entity of the at least one UE RLC entity that the UE 102 uses to communicate RLC PDU(s) with the DU 174, the UE 102 reestablishes the first UE RLC entity in response to the RLC reestablishment indication and the first LTM command. In some implementations, the UE 102 reestablishes the first UE RLC entity before performing 332 the random access procedure or communicating 336 with the DU 174 via the first cell. In other implementations, the UE 102 reestablishes the first UE RLC entity while or after performing 332 the random access procedure. Otherwise, if the LTM configuration 1 does not include the RLC reestablishment indication, the UE 102 refrains from reestablishing the first UE RLC entity in response to the first LTM command.

In some implementations, when the UE 102 reestablishes the first UE RLC entity, the UE 102 performs at least one of the following actions for the first UE RLC entity: (i) discard RLC SDU(s), RLC SDU segment(s), and RLC PDU(s), if any; (ii) stop and reset timer(s), if running; and/or (iii) reset state variables to initial values. In some implementations, the state variables and timer(s) are pre-defined (e.g., in 3GPP TS 38.322).

Otherwise, if the LTM configuration 1 does not include the RLC reestablishment indication for the first UE RLC entity, the UE 102 refrains from reestablishing the first UE RLC entity upon or when receiving the first LTM command. In other words, the UE 102 refrains from preforming the actions for reestablishing the first UE RLC entity of the UE 102 upon or when receiving the first LTM command. In some implementations, if the LTM configuration 1 or element 1 does not include the RLC reestablishment indication and includes an indication that the configuration 1 is a full configuration, the UE 102 reestablishes the first UE RLC entity of the UE 102 upon or when receiving the first LTM command. Otherwise, if the LTM configuration 1 or element 1 does not include the RLC reestablishment indication and the indication indicating that the configuration 1 is a full configuration, the UE 102 refrains from reestablishing the first UE RLC entity upon or when receiving the first LTM command.

Similarly, the DU 174 reestablishes some or all of at least one DU RLC entity (e.g., NR RLC 206B) that the DU 174 uses to communicate with the at least one UE RLC entity of the UE 102 (e.g., the events 302, 304, 318, 320, 324, 330, and/or 331) in response to the RLC reestablishment indication. In some implementations, the DU 174 reestablishes a first DU RLC entity of the at least one DU RLC entity after transmitting the first LTM command, receiving an acknowledgement for the first LTM command from the UE 102, or determining that the UE 102 connects to the first cell. In some implementations, the acknowledgement is a HARQ ACK. In other implementations, the acknowledgement is a MAC CE. In yet other implementations, the acknowledgement is a PUCCH transmission. In some implementations, when the base station 104 reestablishes the first DU RLC entity, the DU 174 performs at least one of the following actions for the first DU RLC entity: (i) discard RLC SDU(s), RLC SDU segment(s), and RLC PDU(s), if any; (ii) stop and reset timer(s), if running; and/or (iii) reset state variables to initial values. In some implementations, the state variables and timer(s) are pre-defined (e.g., in 3GPP TS 38.322).

In other implementations, the UE 102 refrains from reestablishing some or all of the at least one UE RLC entity in response to receiving the first LTM command. Similarly, the DU 174 refrains from reestablishing some or more of the at least one DU RLC entity after (e.g., in response to) transmitting the first LTM command, receiving the acknowledgement 331 or determining that the UE 102 connects to the first cell. In other words, the UE 102 communicates with the DU 174 on the first cell using the some or all of the at least one UE RLC entity (not reestablished). For example, the some or all of the at least one UE RLC entity includes the first UE RLC entity and/or a second UE RLC entity. Similarly, the DU 174 communicates with the UE 102 using the some or all of the at least one DU RLC entity (not reestablished) on the first cell during or after the random access procedure 332 or after determining that the UE 102 connects to the first cell. For example, the some or all of the at least one DU RLC entity includes the first DU RLC entity and/or a second DU RLC entity.

In some implementations, the UE 102 uses at least one UE PDCP entity (e.g., PDCP 210) to communicate UL PDCP PDUs and/or DL PDCP PDUs with at least one CU PDCP entity (e.g., PDCP 210) of the CU 172 in the event 302. In some implementations, the UE 102 performs a PDCP recovery procedure for some or all of the at least one UE PDCP entity, after or in response to receiving the first LTM command. For example, the UE 102 performs a PDCP recovery procedure for a first UE PDCP entity of the at least one UE PDCP entity, after or in response to receiving the first LTM command. Depending on the implementation, in the PDCP recovery procedure, the UE 102 does or does not reestablish the first UE PDCP entity. In some implementations, after or in response to performing the PDCP recovery procedure, the UE 102 retransmits at least a portion of the UL PDCP PDUs to the CU 172 via the DU 174 and the first cell in the event 336. Similarly, the CU 172 performs a PDCP recovery procedure for some or all of the at least one CU PDCP entity after or in response to transmitting the first LTM command. For example, the CU 172 performs a PDCP recovery procedure for a first CU PDCP entity of the at least one CU PDCP entity, after or in response to transmitting the first LTM command. In some implementations, the CU 172 performs the PDCP recovery procedure for the first CU PDCP entity in response to receiving the DU-to-CU message 329 or 334. In other implementations, the CU 172 performs the PDCP recovery procedure for the first CU PDCP entity in response to receiving the DL Data Delivery Status message. Depending on the implementation, in the PDCP recovery procedure, the CU 172 does or does not reestablish the first CU PDCP entity. In some implementations, after or in response to performing the PDCP recovery procedure, the CU 172 retransmits at least a portion of the DL PDCP PDUs to the UE 102 via the DU 174 and the first cell in the event 336.

In other implementations, the UE 102 refrains from reestablishing some or all of the at least one UE PDCP entity in response to receiving the first LTM command. For example, the some or all of the at least one UE PDCP entity includes the first UE PDCP entity and/or a second UE PDCP entity. Similarly, the CU 172 refrains from reestablishing some or more of the at least one CU PDCP entity, after (e.g., in response to) receiving the DU-to-CU message 329 or 340 or after (e.g., in response to) receiving the DL Data Delivery Status message. In other words, the UE 102 communicates with the CU 172 via the DU 174 and the first cell using the some or all of the at least one UE PDCP entity (not reestablished). For example, the some or all of the at least one UE PDCP entity includes the first UE PDCP entity and/or a second UE PDCP entity. Similarly, the CU 172 communicates with the UE 102 using the some or all of the at least one CU PDCP entity (not reestablished) via the DU 174 and the first cell. For example, the some or all of the at least one CU PDCP entity includes the first CU PDCP entity and/or a second CU PDCP entity.

In some implementations, after determining that the UE 102 connects to the first cell, the CU 172 transmits 338 a CU-to-DU message (e.g., a UE Context Modification Request message) to the DU 174 to indicate to the DU 174 to stop communicating with the UE 102 and/or to release or suspend resources, of the cell 124A, configured for the UE 102. In some implementations, in response, the DU 174 stops communicating on the cell 124A with the UE 102 and/or releases or suspends resources, of the cell 124A, configured for the UE 102, and transmits 340 a DU-to-CU message (e.g., a UE Context Modification Response message) to the CU-172. The events 338 (optional) and 340 (optional) are collectively referred to in FIG. 3 as a resource release procedure 396.

Depending on the implementation, after or while communicating with the DU 174 on the first cell, events 344, 346, 348, 350, 351, 352, 354, and/or 356 occur, similar to the events 324, 326, 328, 330, 331, 332, 334, and/or 336, respectively. The UE 102 transmits 344 at least one measurement report to the DU 174. The at least one measurement report includes at least one measurement result for a second cell (i.e., the cell 2). The at least one measurement result indicates that the second cell is suitable for communication with UE 102 and/or the first cell is not suitable for communication with the UE 102. After (e.g., in response to) receiving the at least one measurement report, the DU 174 determines to activate the LTM configuration 2 and generates a second LTM command to activate the LTM configuration 2 (i.e., the second LTM command commands the UE 102 to apply the LTM configuration 2). The DU 174 then transmits 350 the second LTM command to the UE on the first cell to the UE 102.

In some implementations, when or in response to determining to activate the LTM configuration 2 or transmit the second LTM command, the DU 174 transmits 349 to the CU 172 a DU-to-CU message indicating LTM (being) executed. In some implementations, the DU 174 includes the cell ID 2 or the ID 2 (i.e., LTM ID) in the DU-to-CU message 349 to indicate that the DU 174 is to activate the LTM configuration 2. In some implementations, the DU transmits the DU-to-CU message 349 to the CU 172 before or after transmitting the LTM command 350.

The descriptions for the events 324, 326, 328, 330, 331, 332, 334, and/or 336 can be applied to the events 344, 346, 348, 350, 351, 352, 354, and/or 356 with simple changes. For example, “cell 124A”, “first LTM command”, “first cell”, “ID 1”, and/or “LTM configuration 1” are replaced with “first cell”, “second LTM command”, “second cell”, “ID 2”, and/or “LTM configuration 2”, respectively.

The events 344, 346, 348, 350, 351, 352, 354 are collectively referred to in FIG. 3 as an LTM execution procedure 398. The events 304, 306, 390, 392, 394, 324, 326, 328, 329, 330, 331, 332, 334, 336, 396, 398, 356 are collectively referred to in FIG. 3 as an LTM configuration and/or activation procedure 380.

Referring next to FIG. 4, in a scenario 400, the base station 104 includes a CU 172, a source DU (S-DU) 174A, and a target DU (T-DU) 174B. The S-DU 174A operates the cell 124A and optionally additional cell(s), while the T-DU 174B operates a first cell (e.g., cell 124C). The scenario 400 is similar to the scenario 300. Thus, the descriptions for the scenario 300 can generally apply to the scenario 400. The differences between the scenarios 300 and 400 are described below.

Initially, the UE 102 communicates 402 with the S-DU 174A on cell 124A using a serving DU configuration and communicates with the CU 172 via the S-DU 174A. During the communication 402, the UE 102 transmits 404, 406 at least one measurement report (e.g., L3 measurement report(s)) to the CU 172 via the S-DU 174A. Based on the at least one measurement report, the CU 172 determines to prepare cell(s) 1, . . . , N (operated by the T-DU 174B) for LTM for the UE 102, where N is a positive integer larger than 0 or 1. The cell(s) 1, . . . , N are identified by cell ID(s) 1, . . . , N, respectively. In response to the determination, the CU 172 performs 490 an LTM preparation procedure with the T-DU 174B to (request the T-DU 174B to) prepare cell(s) 1, . . . , N for LTM for the UE 102. In some implementations, N is a positive integer larger than 0 or 1. In the LTM preparation procedure 490, the CU 172 transmits a CU-to-DU message, including the cell ID(s) 1, . . . , N, to the T-DU 174B to request the T-DU 174B to prepare the cell(s) 1, . . . , N for LTM for the UE 102, similar to the event 308. In response, the T-DU 174B transmits a DU-to-CU message, including the LTM configuration(s) 1, . . . , N, to the CU 172, similar to the event 310. The LTM configuration(s) 1, . . . , N configure the cell(s) 1, . . . , N for LTM, respectively. In detail, the LTM configuration(s) 1, . . . , N include configuration parameters for communication on the cell(s) 1, . . . , N, respectively. In some implementations, the CU-to-DU message and DU-to-CU message in the procedure 490 are a UE Context Setup Request message and UE Context Setup Response message, respectively. The CU 172 then transmits the LTM configuration(s) 1, . . . , N in an RRC reconfiguration message in an LTM configuration delivery procedure 494, similar to the LTM configuration delivery procedure 394. In some implementations, the T-DU 174B includes cell index(es) 1, . . . , N in the LTM configuration(s) 1, . . . , N, respectively. In some implementations, the CU 172 sets the cell index(es) 1, . . . , N to different values and includes the cell index(es) 1, . . . , N in the CU-to-DU message of the procedure 490.

In some implementations, after performing the LTM preparation procedure 490, the CU 172 performs an additional LTM preparation procedure(s) with the T-DU 174B to prepare cell(s) N+1, . . . , N+M for LTM for the UE 102, where M is a positive integer larger than zero. In further implementations, the CU 172 determines to do so based on one or more measurement reports received from the UE 102 via the S-DU 174A, similar to the events 404, 406. In the additional LTM preparation procedure, the CU 172 transmits a CU-to-DU message, including cell ID(s) N+1, . . . , N+M, to the T-DU 174B to request the T-DU 174B to prepare the cell(s) N+1, . . . , N+M for LTM for the UE 102. The cell ID(s) N+1, . . . , N+M identify the cell(s) N+1, . . . , N+M, respectively. In response to the CU-to-DU message, the T-DU 174B transmits a DU-to-CU message, including the LTM configuration(s) N+1, . . . , N+M, to the CU 172. The LTM configuration(s) N+1, . . . , N+M configure the cell(s) N+1, . . . , N+M for LTM, respectively. In detail, the LTM configuration(s) N+1, . . . , N+M include configuration parameters for communication on the cell(s) N+1, . . . , N+M, respectively. The CU 172 then transmits the LTM configuration(s) N+1, . . . , N+M in an RRC reconfiguration message in an additional LTM configuration delivery procedure, similar to the LTM configuration delivery procedure 394 or 494.

In some implementations, the LTM preparation procedure 490 is a UE Context Setup procedure, and the additional LTM preparation procedure is a UE Context Modification procedure.

In some implementations, the CU 172 and S-DU 174A perform the procedure 380 with the UE 102, as described for FIG. 3. In the procedure 380, the CU 172 and S-DU 174A performs the procedure(s) 390 and/or 392 to prepare cell(s) of the S-DU 174A for LTM for the UE 102. In some implementations, the value N in the procedure 380 or described for FIG. 3 is the same as or different from the value N described for FIG. 4. In some implementations, in the procedure 390, the CU 172 receives the first DU-to-CU message, including the reference LTM configuration, from the S-DU 174A in the event 310. In other implementations, the CU 172 and S-DU 174A do not perform the procedure 380 with the UE 102. In some such cases, the CU 172 performs 488 a reference LTM configuration query procedure with the S-DU 174A to obtain a reference LTM configuration. In the procedure 488, the CU 172 transmits 460 a CU-to-DU message to the S-DU 174A to request or query a reference LTM configuration. In some implementations, the CU 172 includes an indication in the CU-to-DU message to request or query a reference LTM configuration. In response to the indication or CU-to-DU message 460, the S-DU 174A transmits 462 a DU-to-CU message, including a reference LTM configuration, to the CU 172. In some implementations, the indication is a reference LTM configuration query indication. In other implementations, the indication is an LTM indication, and the CU 172 includes a query indication (e.g., GNB-DU Configuration Query IE) in the CU-to-DU message. After receiving the reference LTM configuration (i.e., either in the procedure 390 or in the procedure 488), the CU 172 includes the reference LTM configuration (received from the S-DU 174A) in the CU-to-DU message in the LTM preparation procedure 490. The T-DU 174B generates the LTM configuration(s) 1, . . . , N based on the reference LTM configuration received from the CU 172. In such cases, the T-DU 174B does not include a reference LTM configuration in the DU-to-CU message in the procedure 490. In cases regarding the additional LTM preparation procedure, the T-DU 174B does not include a reference LTM configuration in the DU-to-CU message in the additional LTM preparation procedure. In some implementations, the CU 172 does not include the reference LTM configuration in a CU-to-DU message in the additional LTM preparation procedure with the T-DU 174B. In cases regarding the additional LTM preparation procedure, the T-DU 174B generates the LTM configuration(s) N+1, . . . , N+M based on the reference LTM configuration received from the CU 172.

In some implementations, the CU 172 does not provide a reference LTM configuration to the T-DU 174B in the LTM preparation procedure 490. In such cases, the T-DU 174B generates a reference LTM configuration and generates the LTM configuration(s) 1, . . . , N based on the reference LTM configuration. In such cases, the T-DU 174B includes the reference LTM configuration in the DU-to-CU message in the procedure 490. The CU 172 transmits the reference LTM configuration in the RRC reconfiguration message in the procedure 490. In cases regarding the additional LTM preparation procedure, the T-DU 174B generates the LTM configuration(s) N+1, . . . , N+M based on the reference LTM configuration. In some such cases, the T-DU 174B includes the reference LTM configuration in the DU-to-CU message in the additional LTM preparation procedure. In some implementations, the reference LTM configuration generated by the T-DU 174B is different from the reference LTM configuration generated by the S-DU 174A. In other implementations, the reference LTM configuration generated by the T-DU 174B is the same as the reference LTM configuration generated by the S-DU 174A.

In some implementations, the CU 172 assigns ID(s) 1, . . . , N identifying the LTM configuration(s) 1, . . . , N (received from the T-DU 174B), respectively, and performs the procedure 492 with the T-DU 174B to provide the ID(s) 1, . . . , N and/or cell ID(s) 1, . . . , N to the T-DU 174B, similar to the procedure 392. Thus, the T-DU 174B associates the ID(s) 1, . . . , N with the LTM configuration(s) 1, . . . , N and/or the cell ID(s) 1, . . . , N, respectively. In other implementations, the T-DU 174B assigns ID(s) 1, . . . , N identifying the LTM configuration(s) 1, . . . , N (generated by the T-DU 174B), respectively, and includes the ID(s) 1, . . . , N in the DU-to-CU message of the procedure 490, similar to the event 310. In some implementations, the CU 172 assigns ID(s) N+1, . . . , N+M, identifying the LTM configuration(s) N+1, . . . , N+M, respectively, and performs a procedure (similar to the procedure 492) with the T-DU 174B to provide the ID(s) N+1, . . . , N+M and/or cell ID(s) N+1, . . . , N+M to the T-DU 174B, similar to the procedure 392. Thus, the T-DU 174B associates the ID(s) N+1, . . . , N+M with the LTM configuration(s) N+1, . . . , N+M and/or the cell ID(s) N+1, . . . , N+M, respectively. In other implementations, the T-DU 174B assigns ID(s) N+1, . . . , N+M identifying the LTM configuration(s) N+1, . . . , N+M, respectively, and includes the ID(s) 1, . . . , N in the DU-to-CU message of the additional LTM preparation procedure, similar to the event 310.

In some implementations, the CU 172 transmits 412 a CU-to-DU message, including the ID(s) 1, . . . , N, to the S-DU 174A and receives 414 a DU-to-CU message from the S-DU 174A in response. The CU-to-DU message 412 and DU-to-CU message 414 are collectively referred to in FIG. 4 as an LTM ID transfer procedure 493 or an LTM cell index transfer procedure 493. In some implementations, the message 412 and message 414 are a UE Context Modification Request message and UE Context Modification Response message, respectively. In some implementations, the CU 172 includes the LTM configuration(s) 1, . . . , N and/or cell ID(s) 1, . . . , N in the CU-to-DU message 412. In some implementations, the CU 172 includes the ID(s) 1, . . . , N in the CU-to-DU message 412. In further implementations, the CU 172 includes the cell index(es) 1, . . . , N in the CU-to-DU message 412. In some alternative implementations, the CU 172 performs multiple LTM ID transfer procedures to transmit the ID(s) 1, . . . , N; cell ID(s) 1, . . . , N; and/or LTM configuration(s) 1, . . . , N to the S-DU 174A. In each of the procedures, the CU 172 includes particular portion of the ID(s) 1, . . . , N; cell ID(s) 1, . . . , N; and/or LTM configuration(s) 1, . . . , N in a CU-to-DU message similar to the message 412. Thus, the S-DU 174A associates the ID(s) 1, . . . , N with the LTM configuration(s) 1, . . . , N and/or the cell ID(s) 1, . . . , N, respectively. In other alternative implementations, the CU 172 performs multiple LTM cell index transfer procedures to transmit the cell index(es) 1, . . . , N; cell ID(s) 1, . . . , N; and/or LTM configuration(s) 1, . . . , N to the S-DU 174A. In each of the procedures, the CU 172 includes particular portion of the cell index(es) 1, . . . , N; cell ID(s) 1, . . . , N; and/or LTM configuration(s) 1, . . . , N in a CU-to-DU message similar to the message 412. Thus, the S-DU 174A associates the cell index(es) 1, . . . , N with the LTM configuration(s) 1, . . . , N and/or the cell ID(s) 1, . . . , N, respectively.

In some implementations, the CU 172 transmits a CU-to-DU message, including the ID(s) N+1, . . . , N+M, to the S-DU 174A and receives a DU-to-CU message from the S-DU 174A in response, similar to the CU-to-DU message 412 and the DU-to-CU message 414, respectively. In some implementations, the CU 172 includes the LTM configuration(s) N+1, . . . , N+M and/or cell ID(s) N+1, . . . , N+M in the CU-to-DU message. In some alternative implementations, the CU 172 performs multiple LTM ID transfer procedures to transmit the ID(s) N+1, . . . , N+M; cell ID(s) N+1, . . . , N+M; and/or LTM configuration(s) N+1, . . . , N+M to the S-DU 174A. In each of the procedures, the CU 172 includes particular portion(s) of the ID(s) N+1, . . . , N+M; cell ID(s) N+1, . . . , N+M; and/or LTM configuration(s) 1, . . . , N in a CU-to-DU message similar to the message 412. Thus, the S-DU 174A associates the ID(s) N+1, . . . , N+M with the LTM configuration(s) N+1, . . . , N+M and/or the cell ID(s) N+1, . . . , N+M, respectively.

In some implementations, in cases where the CU 172 and S-DU 174A perform the procedure 380 with the UE 102, value(s) of the ID(s) 1, . . . , N of the procedure 380 are different from value(s) of the ID(s) 1, . . . , N and the ID(s) N+1, . . . , N+M described for the scenario 400. In some implementations, in cases where the CU 172 and S-DU 174A perform the procedure 380 with the UE 102, value(s) of the cell ID(s) 1, . . . , N of the procedure 380are different from value(s) of the cell ID(s) 1, ...., N and the cell ID(s) N+1, . . . , N+M described for the scenario 400. In some implementations, in cases where the CU 172 and S-DU 174A perform the procedure 380 with the UE 102, value(s) of the cell index(es) 1, . . . , N of the procedure 380 are different from value(s) of the cell index(es) 1, . . . , N and the cell index(es) N+1, . . . , N+M described for the scenario 400.

In some implementations, later in time, the UE 102 transmits 424 at least one measurement report to the S-DU 174A, similar to the event 324. The at least one measurement report (e.g., L1 measurement report(s)) includes an event ID, first measurement result(s) for the cell 1 of the T-DU 174B and/or includes second measurement result(s) for the cell 124A. In some implementations, the first measurement result(s) are or include RSRP, RSRQ, and/or SINR that the UE 102 obtains from reference signal(s) transmitted on the cell 1. Likewise, in further implementations, the second measurement result(s) are or include RSRP, RSRQ, and/or SINR that the UE 102 obtains from reference signal(s) transmitted on the cell 124A. In some implementations, the event ID, RSRP, RSRQ, and/or SINR are an L1-event ID, L1-RSRP, L1-RSRQ, and/or L1-SINR, respectively. In some implementations, based on the first measurement result(s) and/or second measurement result(s), the S-DU 174A transmits 430 a first LTM command (i.e., LTM command 1) to the UE 102 to order the UE 102 to perform a serving cell change to the cell 1 of the T-DU 174B. In some implementations, the first LTM command includes the ID 1. In other implementations, the first LTM command includes the cell index 1. When the UE 102 receives the first LTM command, the UE 102 performs a serving cell change to the cell 1 from a serving cell in accordance with the LTM configuration 1. In some implementations, if a serving cell change occurs in the procedure 380, the serving cell is the cell 1 or cell 2 of the S-DU 174A. Otherwise, if no serving cell change occurs in the procedure 380 or the procedure 380 is not performed, the serving cell is the cell 124A. If the first LTM command includes the ID 1, the UE 102 identifies the LTM configuration 1 and/or cell ID 1 (i.e., the cell 1) based on the ID 1, as described for FIG. 3. If the first LTM command includes the cell index 1, the UE 102 identifies the LTM configuration 1, cell ID 1 (i.e., the cell 1), and/or LTM ID 1 based on the cell index 1, as described for FIG. 3. The UE 102 applies the LTM configuration 1 to communicate with the T-DU 174B after (e.g., in response to) receiving the first LTM command or successfully accessing the cell 1.

In some implementations, after (e.g., in response to) receiving the first LTM command, the UE 102 does or does not perform 432 a random access procedure with the T-DU 174B, similar to the event 332. In further implementations, after (e.g., in response to) receiving the first LTM command or completing the random access procedure 432, the UE 102 communicates 436 with the T-DU 174B on the first cell using the LTM configuration 1 and/or reference LTM configuration and communicates with the CU 172 via the T-DU 174B, similar to the event 336.

In some implementations, the resource release procedure 496 is similar to the procedure 396. Alternatively, in the resource release procedure 496, the CU 172 transmits a CU-to-DU message (e.g., a UE Context Release Command message) to the S-DU 174A to release a UE context of the UE 102. In response, the S-DU 174A releases a UE context of the UE 102 and transmits 440 a DU-to-CU message (e.g., a UE Context Release Complete message) to the CU-172.

The events 380, 404, 406, 490, 492, 494, 494, 424, 426, 428, 429, 430, 431, 432, 434, 436, 496, 498, 456 are collectively referred to in FIG. 4 as an LTM configuration and/or activation procedure 480.

Referring next to FIG. 5A, in a scenario 500A, the base station 106 operates as an MN, and the base station 104 operates as an SN. The SN 104 includes a CU 172 and a DU 174. The scenario 500A is similar to the scenario 300, except that the scenario 500A is a DC scenario and the scenario 300 is a single connectivity (SC) scenario. The MN 106 can include a CU and a DU similar to the base station 104 of FIG. 3.

Initially, the UE 102 in DC communicates with the MN 106 and with the SN 104. In the event 502, the UE 102 communicates with the DU 174 on cell 124A using a serving DU configuration and communicates with the CU 172 via the DU 174 using a serving CU configuration, similar to the event 302. In some alternative implementations, the UE 102 does not communicate with the CU 172 via the DU 174 in the event 302. In some implementations, the UE 102 in DC communicates 502 UL PDUs and/or DL PDUs with the MN 106 and/or SN 104 via radio bearers which, depending on the implementation, include SRBs and/or DRB(s). In some implementations, the MN 106 and/or the SN 104 configure the radio bearers to the UE 102. The UE 102 in DC communicates 502 UL PDUs and/or DL PDUs with the SN 104 on an SCG (i.e., SCG radio resources) that the SN 104 configures for communication with the UE 102. The UE 102 in DC communicates UL PDUs and/or DL PDUs with the MN 106 on an MCG (i.e., MCG radio resources) in accordance with an MN configuration (i.e., MCG configuration). In some implementations, the serving DU configuration is an SN configuration (i.e., SCG configuration). In the MN configuration, the MN 106 configures the MCG which includes at least one serving cell (e.g., the cell 126 and/or other cell(s)) operated by the MN 106. In the serving DU configuration, the SN 106A configures the SCG which includes at least one serving cell (e.g., the cell 124A and/or other cell(s)) operated by the SN 104. In some implementations, the MN configuration includes multiple configuration parameters, and the UE 102 receives the configuration parameters in one or more RRC messages from the MN 106. As described for FIG. 3, the serving DU configuration includes multiple configuration parameters. In some implementations, the UE 102 receives the configuration parameters in one or more RRC messages from the SN 104 (e.g., via the MN 106 and/or on an SRB (e.g., SRB3) that the MN 106 or SN 104 configures to exchange RRC messages between the UE 102 and the SN 104).

In some implementations, while the UE 102 communicates in DC with the MN 106 and SN 104, the MN 106 performs 580 an LTM configuration and/or activation procedure with the UE 102, similar to the procedures 380 and/or 480. In some implementations, while communicating in DC with the MN 106 and SN 104, the UE 102 transmits the at least one measurement report to the CU 172 via the DU 174 and cell 124A in the events 504 and 506, similar to the events 304 and 306, respectively. In other implementations, while communicating in DC with the MN 106 and SN 104, the UE 102 transmits 505 at least one measurement report to the MN 106 via the cell 126. The MN 106 in turn transmits 507 the at least one measurement report to the CU 172. In some implementations, the MN 106 generates at least one SN message, including the at least one measurement report, and transmits the at least one SN message to the CU 172 in the event 507. In some implementatoins, the at least one SN message include RRC Transfer message(s) and/or SN Modification Request message(s).

After (e.g., in response to) receiving the at least one measurement report or while the SN 104 communicates with the UE 102, the SN 104 determines to prepare the first cell for the UE 102, as described for FIG. 3. The events 590, 592, 594, 524, 526, 528, 529, 530, 531, 532, 534, 536, 596, 598, and 556 are similar to the events 390, 392, 394, 324, 326, 328, 329, 330, 331, 332, 334, 336, 396, 398, and 356, respectively. After receiving the first LTM command 530, transmitting the acknowledgement 531, or determining that the UE 102 successfully connects to the first cell 532 or 536, the UE 102 operating in DC with the MN 106 and SN 104 communicates 536 with the DU 174 on the first cell in accordance with the LTM configuration 1 and communicates 536 with the CU 172 via the DU 174, similar to the event 336. In some implementations, later in time, the DU 174 and/or CU 172 performs the LTM execution procedure 598 with the UE 102 to command the UE 102 to perform a cell change from the first cell to the second cell, similar to the procedure 398 or 498. As a result of the procedure 598, the UE 102 operating in DC with the MN 106 and SN 104 communicates 556 with the DU 174 on the second cell in accordance with the LTM configuration 2 and communicates 556 with the CU 172 via the DU 174, similar to the event 356.

The events 504, 506, 505, 507, 590, 592, 594, 594, 524, 526, 528, 529, 530, 531, 532, 534, 536, 596, 598, 556 are collectively referred to in FIG. 5A as an LTM configuration and/or activation procedure 581.

Referring next to FIG. 5B, a scenario 500B is generally similar to the scenario 500A, except that the SN 104 transmits 517, 519 the RRC reconfiguration message to the UE 102 via the MN 106 and receives 521, 523 the RRC reconfiguration complete message from the UE 102 via the MN 106. The RRC reconfiguration message 517, 519 is similar to the RRC reconfiguration message 316, 318. The RRC reconfiguration complete message 521, 523 is similar to the RRC reconfiguration message 320, 322. In some implementations, the SN 104 generates a first SN message (e.g., SN Modification Required message, SN Modification Required message, or RRC Transfer message), including the RRC reconfiguration message, and transmits the first SN message to the MN 106 in the event 517. The MN 106 generates an MN RRC message including the RRC reconfiguration message and transmits 519 the MN RRC message to the UE 102. In response, the UE 102 generates an MN RRC response message including the RRC reconfiguration complete message and transmits 521 the MN RRC response message to the MN 106. In some implementations, the MN 106 generates a second SN message (e.g., SN Reconfiguration Complete message or RRC Transfer message) including the RRC reconfiguration complete message and transmits the second SN message to the SN 104 in the event 523. In some implementations, the MN RRC message and MN RRC response message are an RRC reconfiguration message and an RRC reconfiguration complete message, respectively.

The events 504, 506, 505, 507, 590, 592, 594, 517, 519, 521, 523, 524, 526, 528, 529, 530, 531, 532, 534, 536, 596, 598, 556 are collectively referred to in FIG. 5B as an LTM configuration and/or activation procedure 582.

Referring next to FIG. 6A, in a scenario 600A, the base station 106 operates as an MN, and the base station 104 operates as an SN, similar to the scenarios 300-500B. The SN 104 includes a CU 172, an S-DU 174A and a T-DU 174B, similar to the base station 104 in the scenario 400. In some implementations, while the UE 102 communicates in DC with the MN 106 and SN 104, the MN 106 performs 680 an LTM configuration and/or activation procedure with the UE 102, similar to the procedures 380 and/or 480. In some implementations, while the UE 102 communicates in DC with the M-DU 174A and S-DU 174B, the CU 172 performs 681 an LTM configuration and/or activation procedure with the UE 102 via the M-DU 174A or S-DU 174B, similar to the procedure 581 or 582.

Referring next to FIG. 6B, a scenario 600B is similar to the scenarios 300-500B and 600A, except that that the SN 104 transmits 617, 619 the RRC reconfiguration message to the UE 102 via the MN 106 and receives 621, 623 the RRC reconfiguration complete message from the UE 102 via the MN 106.

Referring next to FIG. 7A, in a scenario 700A, the base station 104 operates as an MN and an SN, similar to the scenarios 300-600B. The base station 104 includes a CU 172, a master DU (M-DU) 174A and a secondary DU (S-DU) 174B. The CU 172 operates with the M-DU 174A as an MN, similar to the base station 104 in the FIG. 3 or the MN 106 in FIGS. 5A-6B, and the CU 172 operates with the S-DU 174B as an SN, similar to the SN 104 in FIGS. 5A-6B.

In the scenario 700A, the UE 102 initially communicates 702 in DC with the M-DU 174A and S-DU 174B and communicates 702 with the CU 172 via the M-DU 174A and S-DU 174B. In the event 702, the UE 102 communicates with the S-DU 174B on cell 124A using a serving DU configuration and communicates with the CU 172 via the S-DU 174B using a serving CU configuration, similar to the event 302. Events 704 and 706 are similar to the events 304 and 306. In some implementations, the UE 102 transmits 705 at least one measurement report to the M-DU 174A, similar to the event 304. The M-DU 174A in turn transmits 707 at least one DU-to-CU message including the at least one measurement report to the CU 172, similar to the event 306. In some implementations, while the UE 102 communicates in DC with the M-DU 174A and S-DU 174B, the CU 172 performs 780 an LTM configuration and/or activation procedure with the UE 102 via the M-DU 174A, similar to the procedure 380.

The events 704, 706, 705, 707, 790, 792, 794, 724, 726, 728, 729, 730, 731, 732, 734, 736, 796, 798, 756 are collectively referred to in FIG. 7A as an LTM configuration and/or activation procedure 781.

Referring next to FIG. 7B, a scenario 700B similar to the scenarios 300-600B and 700A, except that that the CU 172 transmits 717, 719 the RRC reconfiguration message to the UE 102 via the M-DU 174A and receives 721, 723 the RRC reconfiguration complete message from the UE 102 via the M-DU 174A.

The events 704, 706, 705, 707, 790, 792, 794, 717, 719, 721, 723, 724, 726, 728, 729, 730, 731, 732, 734, 736, 796, 798, 756 are collectively referred to in FIG. 7B as an LTM DU configuration and/or activation procedure 782.

Referring next to FIG. 8A, in a scenario 800A, the base station 104 operates as an MN and an SN, similar to the scenarios 300-700B. The base station 104 includes a CU 172, a master DU (M-DU) 174A, a secondary DU (S-DU) 174B and a target secondary DU (T-DU) 174C. The CU 172 operates with the M-DU 174A as a MN and operates with the S-DU 174B as a SN. In some implementations, while the UE 102 communicates in DC with the M-DU 174A and S-DU 174B, the CU 172 performs 880 an LTM configuration and/or activation procedure with the UE 102 via the M-DU 174A, similar to the procedure 380. In some implementations, while the UE 102 communicates in DC with the M-DU 174A and S-DU 174B, the CU 172 performs 881 an LTM configuration and/or activation procedure with the UE 102 via the S-DU 174A, similar to the procedure 581 or 582.

Referring next to FIG. 8B, a scenario 800B similar to the scenarios 300-700B and 800A, except that that the CU 172 transmits 817, 819 the RRC reconfiguration message to the UE 102 via the M-DU 174A and receives 821, 823 the RRC reconfiguration complete message from the UE 102 via the M-DU 174A.

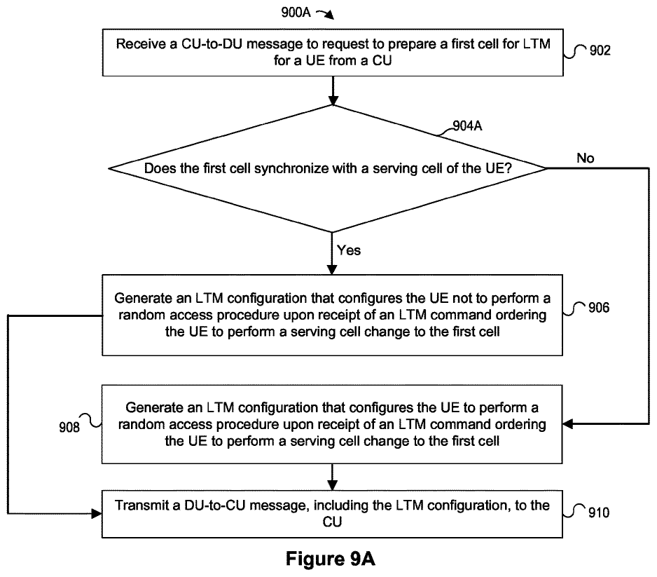

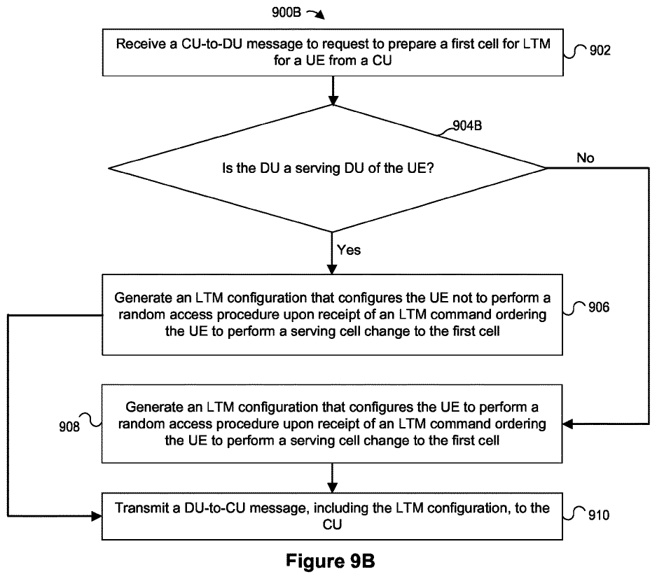

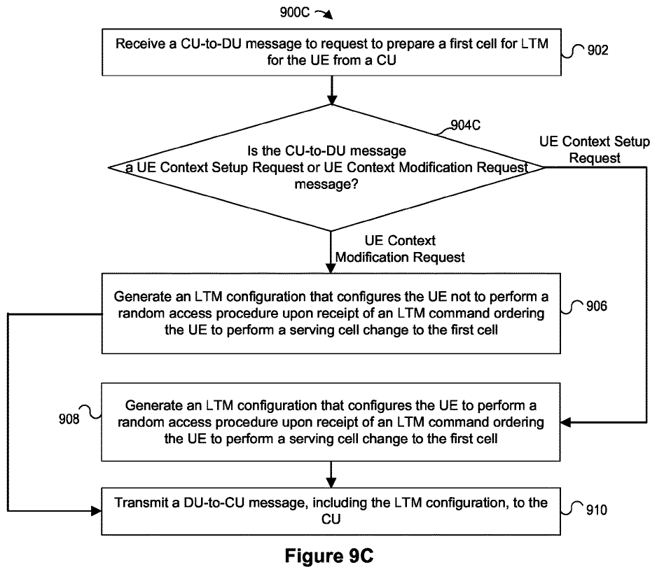

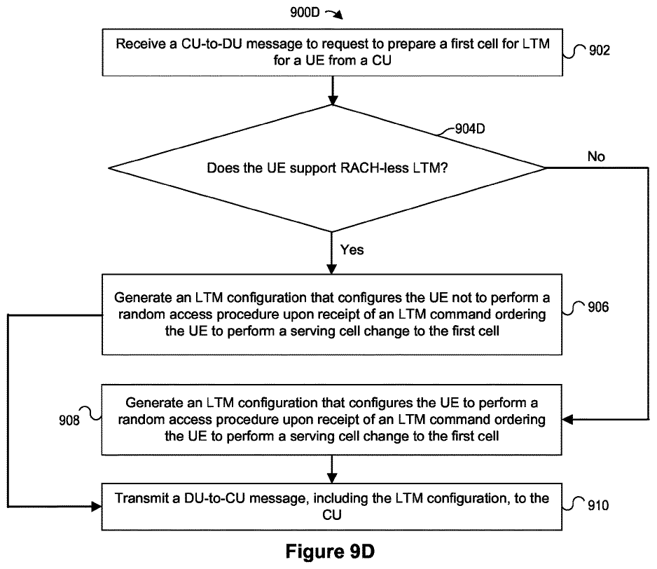

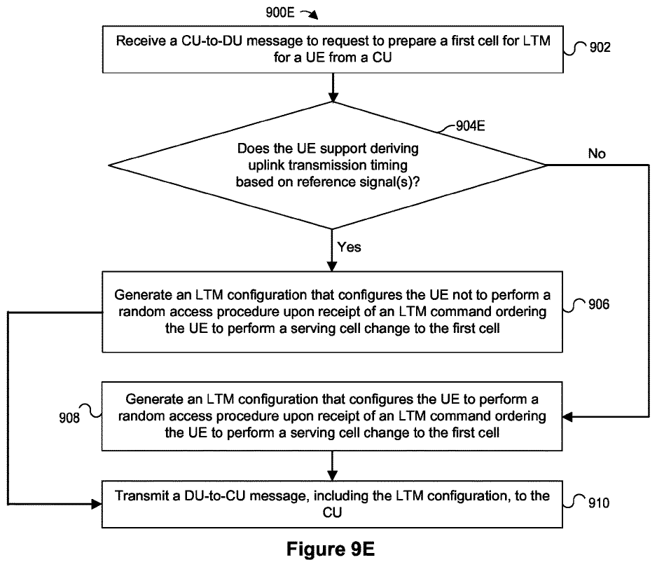

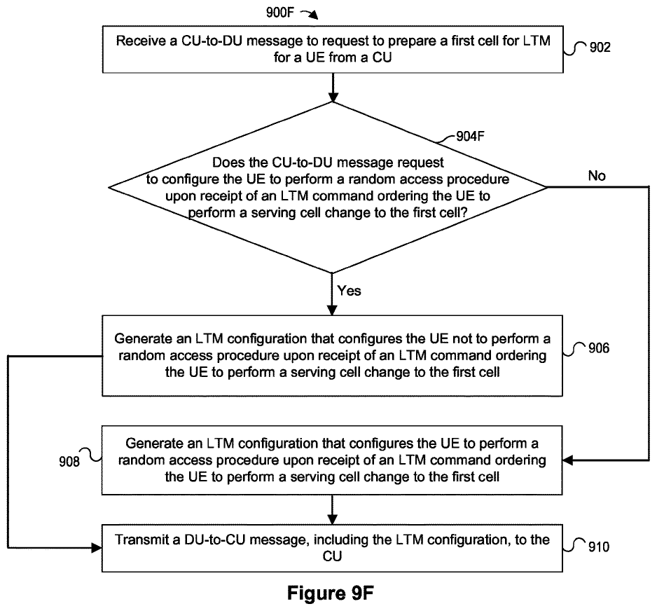

Next, several example methods, that can be implemented in a RAN such as a DU or a CU to support configuring a configuration for LTM, are discussed next with reference to FIGS. 9A-14B. Examples and implementations described for FIGS. 3-8B can apply to FIGS. 9A-14B.

FIG. 9A illustrates an example method 900A, which can be implemented by a RAN (e.g., the base station 104 or 106, the DU 174 of the base station 104 or 106, or the DU 174A, DU 174B and/or DU 174C of the base station 104), for configuring LTM with a UE (e.g., the UE 102).

The method 900A begins at block 902, where the DU receives a CU-to-DU message to request to prepare a first cell for LTM for a UE from a CU (e.g., events 308, 390, 380, 490, 480, 580, 590, 581, 582, 680, 690, 681, 682, 780, 790, 781, 782, 880, 890, 881, 882). At block 904A, the DU determines whether the first cell synchronizes with a serving cell of the UE. If the DU determines that the first cell synchronizes with a serving cell of the UE at block 904A, the flow proceeds to block 906. At block 906, the DU generates an LTM configuration that configures the first cell and the UE not to perform a random access procedure upon receipt of an LTM command ordering the UE to perform a serving cell change to the first cell (e.g., events 310, 390, 380, 490, 480, 580, 590, 581, 582, 680, 690, 681, 682, 780, 790, 781, 782, 880, 890, 881, 882). Otherwise, if the DU determines the first cell does not synchronize with a serving cell of the UE at block 904A, the flow proceeds to block 908. At block 908, the DU generates an LTM configuration that configures the UE to perform a random access procedure upon receipt of an LTM command ordering the UE to perform a serving cell change to the first cell (e.g., events 310, 390, 380, 490, 480, 580, 590, 581, 582, 680, 690, 681, 682, 780, 790, 781, 782, 880, 890, 881, 882). The flow proceeds to block 910 from 906 or 908. At block 910, the DU transmits a DU-to-CU message, including the LTM configuration, to the CU (e.g., events 310, 390, 380, 490, 480, 580, 590, 581, 582, 680, 690, 681, 682, 780, 790, 781, 782, 880, 890, 881, 882).

In some implementations, the DU is a serving DU that, depending on the implementation, is a master DU or a secondary DU. In other implementations, the DU is a non-serving DU (i.e., a target DU). In some implementations, the first cell is a candidate PCell or a candidate PSCell. In some implementations, the LTM configuration is a non-reference LTM configuration that configures the first cell for LTM, similar to the LTM configuration 1 configuring the cell 1 as described for FIGS. 3-8B. In some implementations, the DU includes a reference LTM configuration in the DU-to-CU message at block 910. Alternatively, the DU transmits another DU-to-CU message, including the reference LTM configuration, to the CU. In other implementations, the LTM configuration is a reference LTM configuration similar to the reference LTM configuration described for FIGS. 3-8B. In some implementations, the serving DU later transmits an LTM command to the UE to order the UE to perform a serving cell change to the first cell (e.g., events 330, 380, 480, 430, 580, 530, 581, 582, 680, 630, 681, 682, 780, 730, 781, 782, 880, 830, 881, 882). In some cases where the DU is a serving DU, the serving DU stops communicating with the UE via the serving cell after transmitting the LTM command. After detecting that the UE accesses the first cell, the DU applies the non-reference LTM configuration and at least a portion of the reference LTM configuration to communicate with the UE via the first cell (e.g., events 336, 380, 580, 536, 581, 582, 780, 736, 781, 782).

In some implementations, the LTM configuration in block 906 is the LTM configuration in block 1104 or 1105 (e.g., as described below). In some implementations, the LTM configuration in block 906 includes random access configuration parameters. In other implementations, the LTM configuration in block 906 does not include random access configuration parameters. In some implementations, the LTM configuration in block 908 includes random access configuration parameters.

FIG. 9B is a flow diagram of an example method 900B similar to the method 900A, except that the method 900B includes block 904B instead of block 904A. At block 904B, the DU determines whether the DU is a serving DU of the UE. If the DU determines that the DU is a serving DU of the UE at block 904B, the flow proceeds to block 906. Otherwise, if the DU determines that the DU is not a serving DU of the UE at block 904B, the flow proceeds to block 908.

FIG. 9C is a flow diagram of an example method 900C similar to the method 900A, except that the method 900C includes block 904C instead of block 904A. At block 904C, the DU determines whether the CU-to-DU message is a UE Context Setup Request or a UE Context Modification Request message. If the DU determines that the CU-to-DU message is a UE Context Modification Request message at block 904C, the flow proceeds to block 906. Otherwise, if the DU determines that the CU-to-DU message is a UE Context Setup Request at block 904C, the flow proceeds to block 908.

FIG. 9D is a flow diagram of an example method 900D similar to the method 900A, except that the method 900D includes block 904D instead of block 904A. At block 904D, the DU determines whether the UE supports RACH-less LTM. If the DU determines that the UE supports RACH-less LTM at block 904D, the flow proceeds to block 906. Otherwise, if the DU determines that the UE does not support RACH-less LTM at block 904D, the flow proceeds to block 908.

If the UE supports RACH-less LTM, the UE supports performing a serving cell change without performing a random access procedure upon receipt of an LTM command. In some implementations, the DU receives UE capabilities of the UE (e.g., UE-NR-Capability or UE-6G-Capability IE) from the CU. If the UE capabilities include an LTM capability indicating that the UE supports RACH-less LTM, the DU determines that the UE supports RACH-less LTM. Otherwise, if the UE capabilities do not include the LTM capability, the DU determines that the UE does not support RACH-less LTM. In some implementations, the UE capabilities include an LTM capability indicating that the UE supports LTM.

FIG. 9E is a flow diagram of an example method 900E similar to the method 900A, except that the method 900E includes block 904E instead of block 904A. At block 904E, the DU determines whether the UE supports deriving uplink transmission timing based on reference signal(s). If the DU determines that the UE supports deriving uplink transmission timing based on reference signal(s) at block 904E, the flow proceeds to block 906. Otherwise, if the DU determines that the UE does not support deriving uplink transmission timing based on reference signal(s) at block 904E, the flow proceeds to block 908.

In some implementations, if the UE supports deriving uplink transmission timing based on reference signal(s), the UE supports performing a serving cell change without performing a random access procedure upon receipt of an LTM command. In some implementations, the DU transmits, on the first cell, reference signal(s) for the UE to derive uplink transmission timing for uplink transmission on the first cell. When receiving the reference signal(s), the UE determines a DL timing difference between the first cell and the serving cell, and derives uplink transmission timing (e.g., a timing advance value) for uplink transmission on the first cell, based on the DL timing difference and uplink transmission timing (e.g., a timing advance value) for uplink transmission on the serving cell. In some implementations, the DU transmits, to the UE directly or via the CU, a DU configuration (e.g., CellGroupConfig IE) including configuration parameters configuring the reference signal(s) or reception of the reference signal(s). For example, in cases regarding transmitting the DU configuration via the CU, the DU transmits the DU configuration to the CU, and the CU transmits a message (e.g., RRC reconfiguration message), including the DU configuration, to the UE via the DU or another RAN node (e.g., another DU or a base station). In some implementations, when or upon receiving the configuration parameters, the UE starts receiving the reference signal(s). In other implementations, when or upon receiving the configuration parameters, the UE does not start receiving the reference signal(s). In such cases, the DU or another DU transmits a non-LTM command to the UE to order the UE to receive the reference signal(s). In some implementations, the non-LTM command is a reference signal (reception) activation command to activate reception of the reference signal(s). After (e.g., in response to) receiving the non-LTM command, the UE starts receiving the reference signal(s). In some implementations, if the DU determines that the UE supports deriving uplink transmission timing based on reference signal(s), the DU transmits the DU configuration to the UE. Otherwise, if the DU determines that the UE does not support deriving uplink transmission timing based on reference signal(s), the DU refrains from transmitting the DU configuration to the UE.

In some implementations, the DU receives UE capabilities of the UE (e.g., UE-NR-Capability or UE-6G-Capability IE) from the CU. If the UE capabilities include an LTM capability indicating that the UE supports deriving uplink transmission timing based on reference signal(s), the DU determines that the UE supports deriving uplink transmission timing based on reference signal(s). Otherwise, if the UE capabilities do not include the LTM capability, the DU determines that the UE does not support deriving uplink transmission timing based on reference signal(s). In some implementations, the UE capabilities include an LTM capability indicating that the UE supports LTM.

In some implementations, the reference signal(s) include tracking reference signal(s) (TRS), channel state information reference signal(s) (CSI-RS), and/or synchronization signal and/or physical broadcast channel block (SSB).

FIG. 9F is a flow diagram of an example method 900F similar to the method 900A, except that the method 900F includes block 904F instead of block 904A. At block 904F, the DU determines whether the CU-to-DU message requests to configure the UE to perform a random access procedure upon receipt of an LTM command ordering the UE to perform a serving cell change to the first cell. If the DU at block 904F determines that the CU-to-DU message requests to configure the UE to perform a random access procedure upon receipt of an LTM command ordering the UE to perform a serving cell change to the first cell, the flow proceeds to block 906. Otherwise, if the DU at block 904F determines that the CU-to-DU message does not request to configure the UE to perform a random access procedure upon receipt of an LTM command ordering the UE to perform a serving cell change to the first cell, the flow proceeds to block 908.

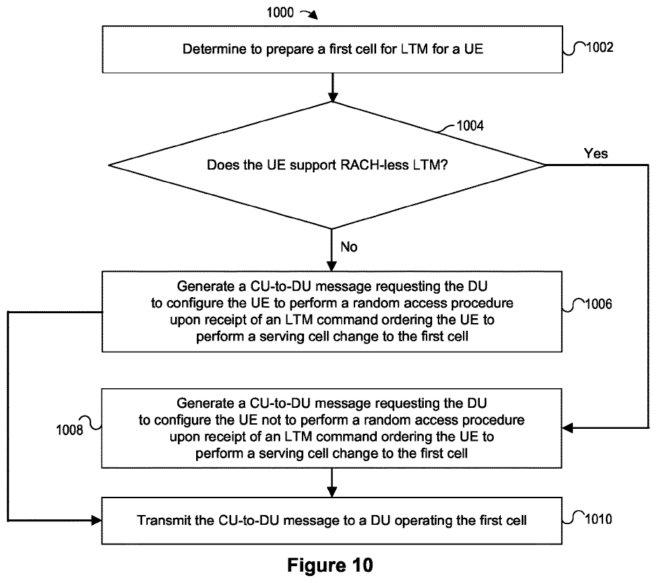

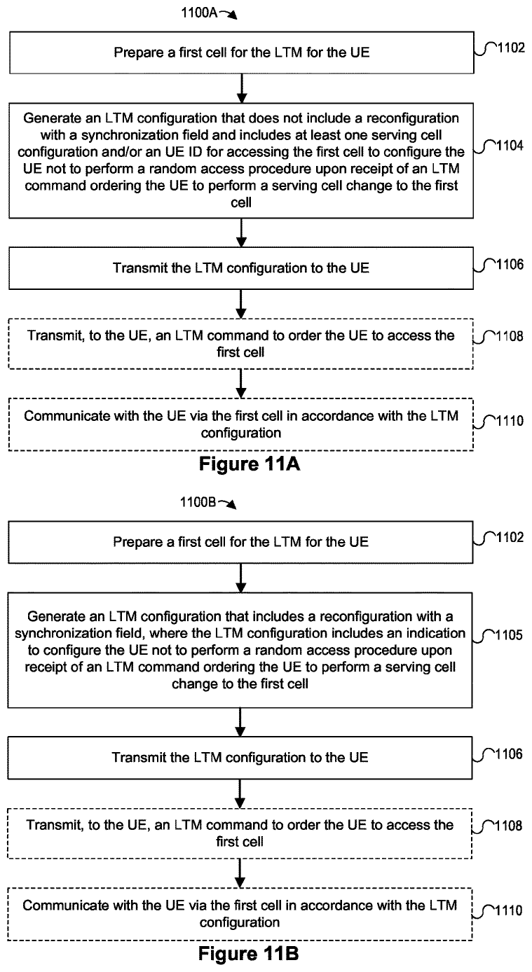

FIG. 10 illustrates an example method 1000, which a CU (e.g., the CU 172 of the base station 104 or 106) can implement, for configuring LTM with a UE (e.g., the UE 102).

The method 1000 begins at block 1002, where the CU determines to prepare a first cell for LTM for a UE. At block 1004, the CU determines whether the UE supports RACH-less LTM. If the CU determines that the UE does not support RACH-less LTM, the flow proceeds to block 1006. At block 1006, the CU generates a CU-to-DU message requesting the DU to configure the UE to perform a random access procedure upon receipt of an LTM command ordering the UE to perform a serving cell change to the first cell. Otherwise, if the CU determines that the UE supports RACH-less LTM, the flow proceeds to block 1008. At block 1008, the CU generates a CU-to-DU message requesting the DU to configure the UE not to perform a random access procedure upon receipt of an LTM command ordering the UE to perform a serving cell change to the first cell. The flow proceeds to block 1010 from 1006 or 1008. At block 1010, the CU transmits the CU-to-DU message to a DU operating the first cell (e.g., events 308, 390, 380, 490, 480, 580, 590, 581, 582, 680, 690, 681, 682, 780, 790, 781, 782, 880, 890, 881, 882).

In some implementations, the CU receives a DU-to-CU message, including an LTM configuration, from the DU in response to the CU-to-DU message (e.g., events 310, 390, 380, 490, 480, 580, 590, 581, 582, 680, 690, 681, 682, 780, 790, 781, 782, 880, 890, 881, 882). If the CU-to-DU message requests the DU not to configure the UE to perform a random access procedure upon receipt of an LTM command ordering the UE to perform a serving cell change to the first cell, the LTM configuration configures the UE not to perform a random access procedure upon receipt of an LTM command ordering the UE to perform a serving cell change to the first cell. If the CU-to-DU message requests the DU to configure the UE to perform a random access procedure upon receipt of an LTM command ordering the UE to perform a serving cell change to the first cell, the LTM configuration configures the UE to perform a random access procedure upon receipt of an LTM command ordering the UE to perform a serving cell change to the first cell.

In some implementations, the CU receives UE capabilities of the UE (e.g., UE-NR-Capability or UE-6G-Capability IE) from the UE or a core network node (e.g., AMF). If the UE capabilities include an LTM capability indicating that the UE supports RACH-less LTM, the CU determines that the UE supports RACH-less LTM. Otherwise, if the UE capabilities do not include the LTM capability, the CU determines that the UE does not support RACH-less LTM. In some implementations, the UE capabilities include an LTM capability indicating that the UE supports LTM.

FIG. 11A illustrates an example method 1100A, which a RAN (e.g., a RAN node such as the base station 104 or 106, the DU 174 of the base station 104 or 106, or the RAN 105) can implement, for configuring and triggering LTM with a UE (e.g., the UE 102).

The method 1100A begins at block 1102, where the RAN prepares a first cell for LTM for the UE (e.g., events 308, 310, 390, 380, 490, 480, 580, 590, 581, 582, 680, 690, 681, 682, 780, 790, 781, 782, 880, 890, 881, 882). At block 1104, the RAN generates an LTM configuration that does not include a reconfiguration with a synchronization field, and includes at least one serving cell configuration and/or a UE ID for accessing the first cell to configure the UE not to perform a random access procedure upon receipt of an LTM command ordering the UE to perform a serving cell change to the first cell (e.g., events 310, 390, 380, 490, 480, 580, 590, 581, 582, 680, 690, 681, 682, 780, 790, 781, 782, 880, 890, 881, 882). At block 1106, the RAN transmits the LTM configuration to the UE (e.g., events 316, 318, 394, 380, 480, 494, 580, 594, 581, 517, 519, 582, 680, 694, 681, 617, 619, 682, 780, 794, 781, 717, 719, 782, 880, 894, 881, 817, 819, 882). At block 1108, the RAN transmits, to the UE, an LTM command to order the UE to access the first cell (e.g., events 330, 380, 480, 430, 580, 530, 581, 582, 680, 630, 681, 682, 780, 730, 781, 782, 880, 830, 881, 882). At block 1110, the RAN communicates with the UE via the first cell in accordance with the LTM configuration (e.g., events 336, 380, 436, 480, 580, 536, 581, 582, 680, 636, 681, 682, 780, 736, 781, 782, 880, 836, 881, 882).

In some implementations, the first cell is a candidate PCell or PSCell. In some implementations, the RAN detects that the UE accesses the first cell in accordance with the LTM configuration (e.g., after transmitting the LTM command) (e.g., events 332, 380, 432, 480, 580, 532, 581, 582, 680, 636, 681, 682, 780, 736, 781, 782, 880, 836, 881, 882).

FIG. 11B is a flow diagram of an example method 1100B similar to the method 1100A, except that the method 1100B includes block 1105 instead of block 1104. At block 1105, the RAN generates an LTM configuration that includes a reconfiguration with a synchronization field, where the LTM configuration includes an indication to configure the UE not to perform a random access procedure upon receipt of an LTM command ordering the UE to perform a serving cell change to the first cell.

In some implementations, the RAN includes the indication in the reconfiguration with a synchronization field to include the indication in the LTM configuration. In other implementations, the RAN includes the indication in a field other than the reconfiguration with a synchronization field and includes the field in the LTM configuration.

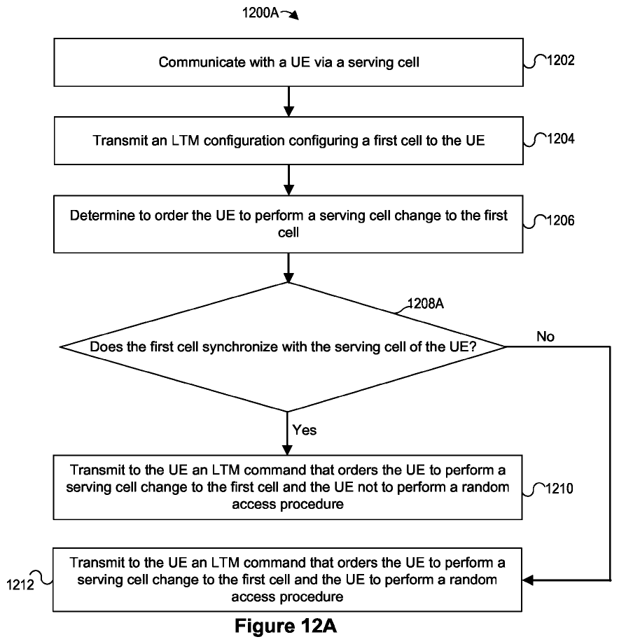

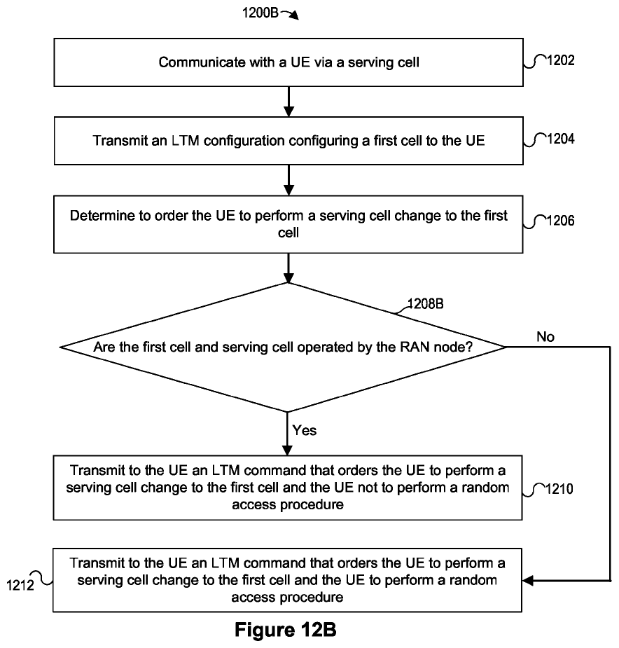

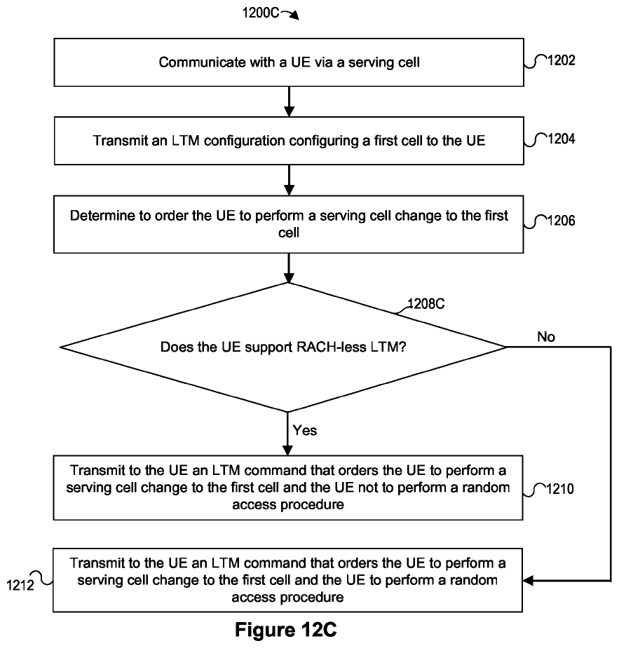

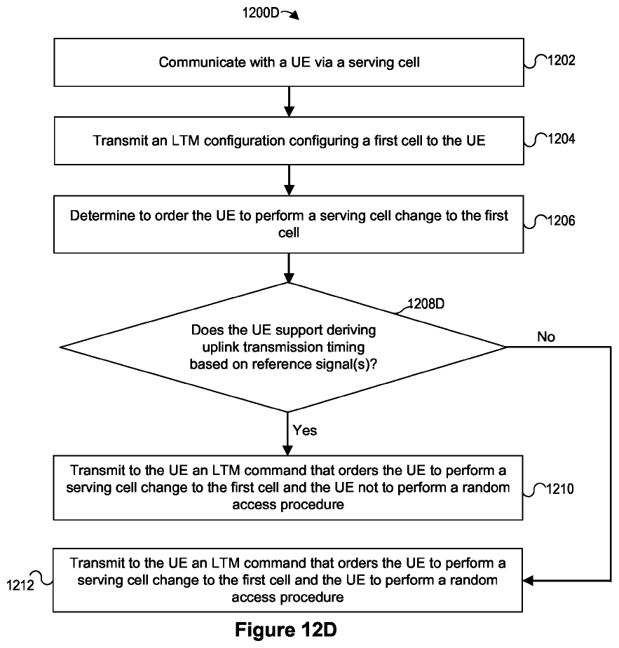

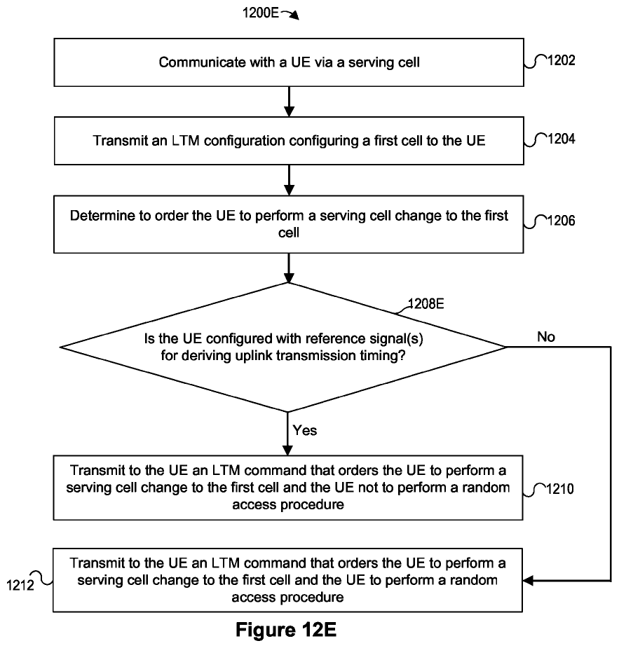

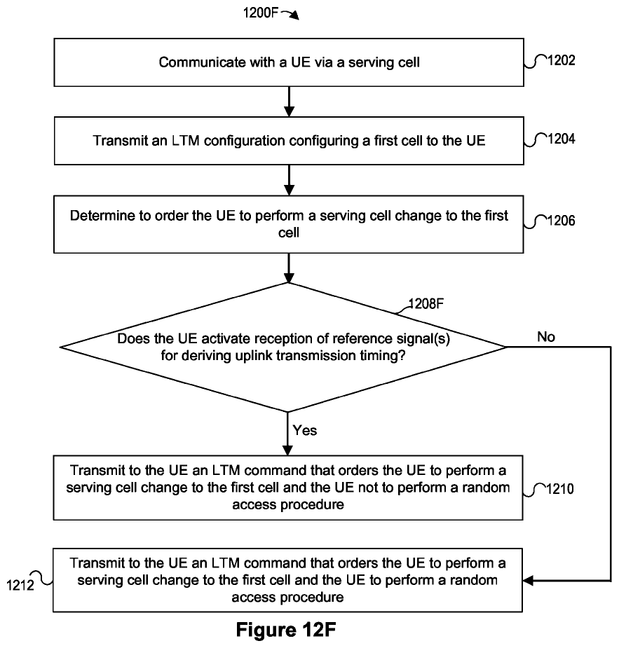

FIG. 12A illustrates an example method 1200A, which a RAN node (e.g., base station 104 or 106 or the DU 174 of the base station 104 or 106) can implement, for configuring and triggering LTM with a UE (e.g., the UE 102).

The method 1200A begins at block 1202, where the RAN node communicates with a UE via a serving cell (e.g., events 302, 402, 502, 602, 702, 802). At block 1204, the RAN node transmits an LTM configuration configuring a first cell to the UE (e.g., events 316, 318, 394, 380, 480, 494, 580, 594, 581, 517, 519, 582, 680, 694, 681, 617, 619, 682, 780, 794, 781, 717, 719, 782, 880, 894, 881, 817, 819, 882). At block 1206, the RAN node determines to order the UE to perform a serving cell change to the first cell. At block 1208A, the RAN node determines whether the first cell synchronizes with the serving cell of the UE. If the RAN node determines that the first cell synchronizes with the serving cell of the UE at block 1208A, the flow proceeds to block 1210. At block 1210, the RAN node transmits, to the UE, an LTM command that orders the UE to perform a serving cell change to the first cell and not to perform a random access procedure (e.g., events 330, 380, 480, 430, 580, 530, 581, 582, 680, 630, 681, 682, 780, 730, 781, 782, 880, 830, 881, 882). Otherwise, if the RAN node determines that the first cell does not synchronize with the serving cell of the UE at block 1208A, the flow proceeds to block 1212. At block 1212, the RAN node transmits, to the UE, an LTM command that orders the UE to perform a serving cell change to the first cell and to perform a random access procedure (e.g., events 330, 380, 480, 430, 580, 530, 581, 582, 680, 630, 681, 682, 780, 730, 781, 782, 880, 830, 881, 882).

In some implementations, after transmitting the LTM command, the RAN node stops communicating with the UE via the serving cell. If the RAN node operates the first cell, the RAN node applies the LTM configuration to communicate with the UE via the first cell when or after (i) transmitting the LTM command or (ii) detecting that the UE accesses the first cell (e.g., events 336, 380, 436, 480, 580, 536, 581, 582, 680, 636, 681, 682, 780, 736, 781, 782, 880, 836, 881, 882).

In some implementations, the first cell is a candidate PCell or a candidate PSCell. In some implementations, the LTM configuration is a non-reference LTM configuration similar to the LTM configuration 1 configuring the cell 1 as described for FIGS. 3-8B. In some implementations, the RAN node transmits a reference LTM configuration to the UE (e.g., events 316, 318, 394, 380, 480, 494, 580, 594, 581, 517, 519, 582, 680, 694, 681, 617, 619, 682, 780, 794, 781, 717, 719, 782, 880, 894, 881, 817, 819, 882). If the RAN node operates the first cell, the RAN node applies the non-reference LTM configuration and at least a portion of the reference LTM configuration to communicate with the RAN via the first cell after transmitting the LTM command or detecting that the UE accesses the first cell (e.g., events 336, 380, 436, 480, 580, 536, 581, 582, 680, 636, 681, 682, 780, 736, 781, 782, 880, 836, 881, 882).

FIG. 12B is a flow diagram of an example method 1200B similar to the method 1200A, except that the method 1200B includes block 1208B instead of block 1208A. At block 1208B, the RAN node determines whether the first cell and serving cell are operated by the same RAN node (e.g., a DU). If the RAN determines that the first cell and serving cell are operated by the same RAN node at block 1208B, the flow proceeds to block 1210. Otherwise, if the RAN determines that the first cell and serving cell are operated by different RAN nodes at block 1208B, the flow proceeds to block 1212.

FIG. 12C is a flow diagram of an example method 1200C similar to the method 1200A, except that the method 1200C includes block 1208C instead of block 1208A. At block 1208C, the RAN node determines whether the UE supports RACH-less LTM. If the RAN node determines that the UE supports RACH-less LTM at block 1208C, the flow proceeds to block 1210. Otherwise, if the RAN node determines that the UE does not support RACH-less LTM at block 1208C, the flow proceeds to block 1212.

Examples and implementations described for FIG. 9D can apply to FIG. 12C.

FIG. 12D is a flow diagram of an example method 1200D similar to the method 1200A, except that the method 1200D includes block 1208D instead of block 1208A. At block 1208D, the RAN node determines whether the UE supports deriving uplink transmission timing based on reference signal(s). If the RAN node determines that the UE supports deriving uplink transmission timing based on reference signal(s) at block 1208D, the flow proceeds to block 1210. Otherwise, if the RAN node determines that the UE does not support deriving uplink transmission timing based on reference signal(s) at block 1208D, the flow proceeds to block 1212.

FIG. 12E is a flow diagram of an example method 1200E similar to the method 1200A, except that the method 1200E includes block 1208E instead of block 1208A. At block 1208E, the RAN node determines whether the UE is configured with reference signal(s) for deriving uplink transmission timing. If the RAN node determines that the UE is configured with reference signal(s) for deriving uplink transmission timing at block 1208E, the flow proceeds to block 1210. Otherwise, if the RAN node determines that the UE is not configured with reference signal(s) for deriving uplink transmission timing at block 1208E, the flow proceeds to block 1212.

FIG. 12F is a flow diagram of an example method 1200F similar to the method 1200A, except that the method 1200F includes block 1208F instead of block 1208A. At block 1208F, the RAN node determines whether the UE activates reception of reference signal(s) for deriving uplink transmission timing. If the RAN node determines that the UE activates reception of reference signal(s) for deriving uplink transmission timing at block 1208F, the flow proceeds to block 1210. Otherwise, if the RAN node determines that the UE does not activate reception of reference signal(s) for deriving uplink transmission timing at block 1208F, the flow proceeds to block 1212.

Examples and implementations described for FIG. 9E can apply to FIGS. 12D-12F.

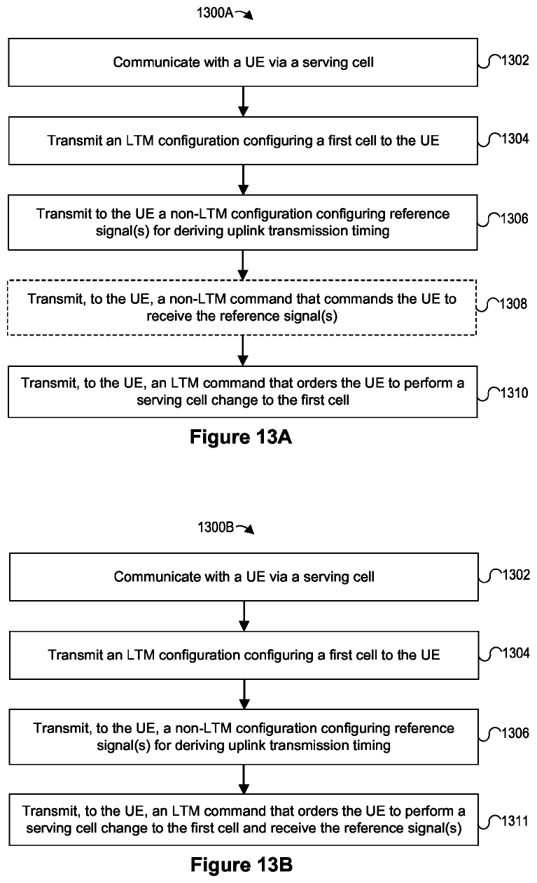

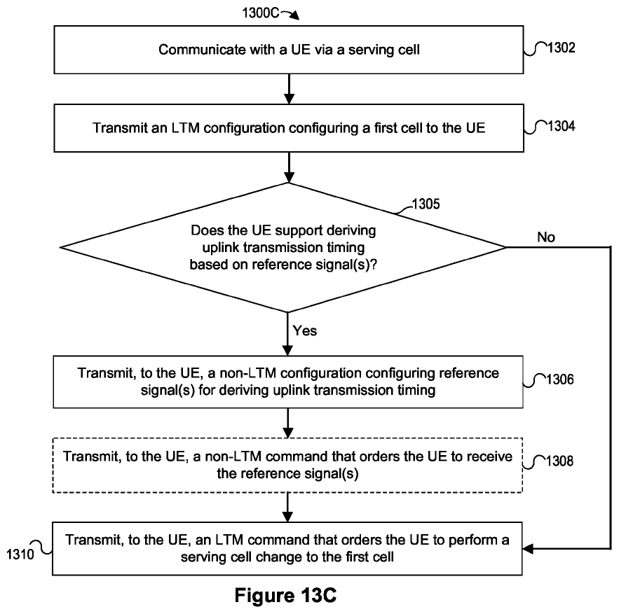

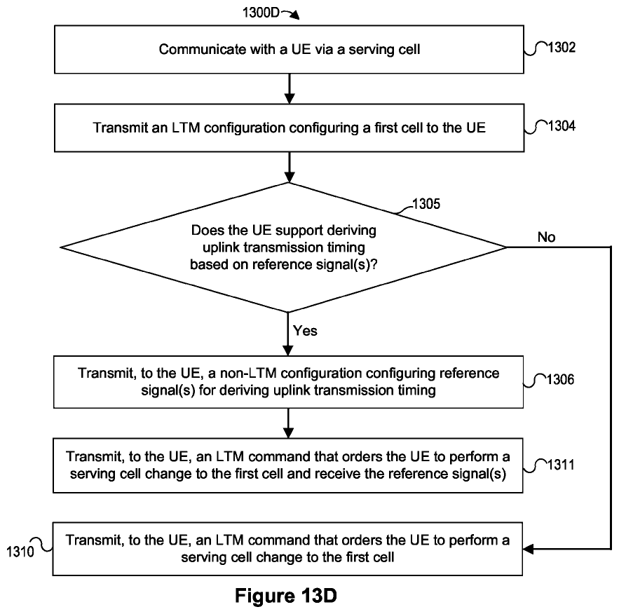

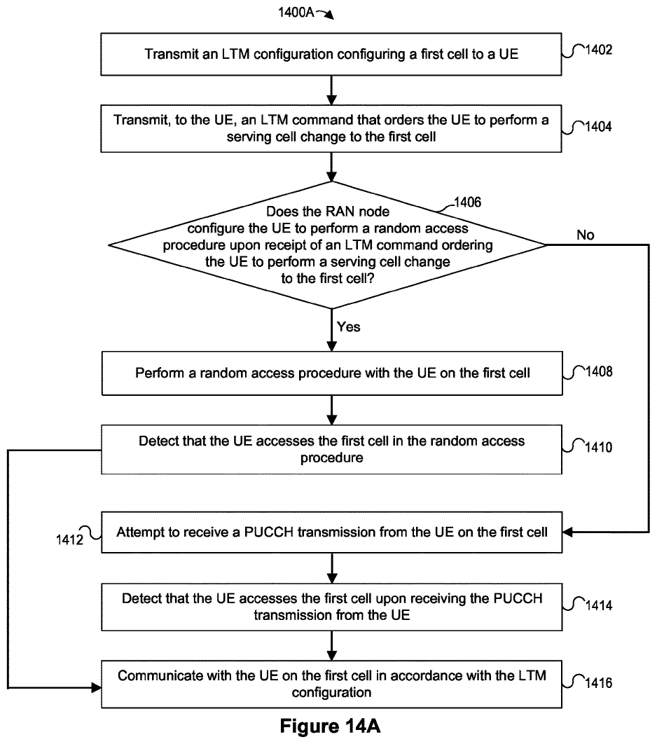

FIG. 13A illustrates an example method 1300A, which a RAN node (e.g., the DU 174 of the base station 104 or 106, or the base station 104 or 106) can implement, for configuring and triggering LTM with a UE (e.g., the UE 102).

The method 1300A begins at block 1302, where the RAN node communicates with a UE via a serving cell (e.g., events 302, 402, 502, 602, 702, 802). At block 1304, the RAN node transmits an LTM configuration configuring a first cell to the UE (e.g., events 310, 390, 316, 318, 394, 380, 490, 494, 480, 580, 590, 594, 581, 517, 519, 582, 680, 690, 694, 681, 617, 619, 682, 780, 790, 794, 781, 717, 719, 782, 880, 890, 894, 881, 817, 819, 882). At block 1306, the RAN node transmits, to the UE, one or more non-LTM configurations configuring reference signal(s) for deriving uplink transmission timing. At block 1308, the RAN node transmits, to the UE, a non-LTM command that orders the UE to receive the reference signal(s). At block 1310, the RAN node transmits, to the UE, an LTM command that orders the UE to perform a serving cell change to the first cell (e.g., events 330, 380, 480, 430, 580, 530, 581, 582, 680, 630, 681, 682, 780, 730, 781, 782, 880, 830, 881, 882).

In some implementations, if the non-LTM configuration configures the UE to start receiving the reference signal(s), block 1308 is omitted. Otherwise, the RAN node transmits the non-LTM command, and the UE starts receiving the reference signal(s) in response to the non-LTM command. In some implementations, the non-LTM command is a reference signal (reception) activation command to activate reception of the reference signal(s).

In some implementations, the RAN node transmits the non-LTM command and the LTM command to the UE in a slot (i.e., the same slot). In other implementations, the UE transmits the non-LTM command and the LTM command to the UE in a first slot and a second slot, respectively. In other implementations, the RAN transmits a MAC PDU, including the non-LTM command and the LTM command, to the UE. In other implementations, the RAN node transmits a first MAC PDU, including the non-LTM command, to the UE and transmits a second MAC PDU, including the LTM command, to the UE. In some implementations, the LTM command is a first MAC CE, and the non-LTM command is a second MAC CE. In such cases, the RAN node transmits a MAC PDU including the first MAC CE, a first subheader for the first MAC CE, the second MAC CE, and a second subheader for the second MAC CE to the UE. Alternatively, the RAN node transmits a first MAC PDU, including the first MAC CE and a first subheader for the first MAC CE, to the UE and transmits a second MAC PDU, including the second MAC CE and a second subheader for the second MAC CE, to the UE.

FIG. 13B is a flow diagram of an example method 1300B similar to the method 1300A, except that the method 1300B includes block 1311 instead of block 1308 and 1310. At block 1311, the RAN node transmits, to the UE, an LTM command that orders the UE to perform a serving cell change to the first cell and receive the reference signal(s).

In some implementations, the LTM command is a MAC CE. The RAN node transmits a MAC PDU, including the MAC CE and a subheader for the MAC CE, to the UE at block 1311.

FIG. 13C is a flow diagram of an example method 1300C similar to the method 1300A, except that the method 1300C includes block 1305. At block 1305, the RAN node determines whether the UE supports deriving uplink transmission timing based on reference signal(s). If the RAN node determines that the UE supports deriving uplink transmission timing based on reference signal(s) at block 1305, the flow proceeds to block 1306. Otherwise, if the RAN node determines that the UE does not support deriving uplink transmission timing based on reference signal(s) at block 1305, the flow proceeds to block 1310. The flow proceeds to block 1310 from block 1305 as well as block 1306 or block 1308.

FIG. 13D is a flow diagram of an example method 1300D similar to the methods 1300A-1300C, except that the method 1300D includes block 1311 instead of block 1308.

Examples and implementations described for FIGS. 9A-9F and FIGS. 12A-12F can apply to FIGS. 13A-13D.

The following descriptions apply to FIGS. 13A-13D.

In some implementations, the RAN node (e.g., a first RAN node) or a second RAN node transmits the reference signal(s) in accordance with the non-LTM configuration. In some implementations, the RAN node transmits the reference signal(s) before or upon transmitting the non-LTM configuration, the non-LTM command, or the LTM command to the UE. When the UE receives the reference signal(s), the UE derives the second uplink transmission timing from the received RS(s). In some implementations, the UE performs AGC adjustment and/or time/frequency synchronization based on the received reference signal(s).

In some implementations, the reference signal(s) (RS(s)) include CSI-RS(s) or tracking reference signal(s) for automatic gain control (AGC) adjustment and/or time/frequency synchronization with a SpCell. In some implementations, the CSI-RS(s) are configured or used specifically for tracking (i.e., the CSI-RS(s) for tracking (TRS)). In further implementations, the CSI-RS(s) are configured or used for tracking and other purpose(s) (e.g., CSI report). In some implementations, the non-LTM configuration(s) (e.g., CellGroupConfig IE(s)) include one or more RS configurations for one or more (candidate) special cells (SpCell(s)). Each of the RS configuration(s) configures the RS(s) and includes an RS configuration ID and/or quasi-colocation (QCL) information of the RS(s) (e.g., for a serving cell change (i.e., SpCell change)). The RS configuration ID in each of the RS configuration(s) uniquely identifies the corresponding RS configuration. In some implementations, each of the RS configuration(s) includes a resource set ID (e.g., NZP-CSI-RS-ResourceSetId) to configure RS(s). The resource set ID indicates resources of RS(s), such as a set of RS resources. The first RAN node, the second RAN node, or a CU of the first RAN node transmits, to the UE, one or more resource set configurations (e.g., NZP-CSI-RS-ResourceSet IE(s)), where each configures a set of RS resources (i.e., a resource set) and a resource set ID identifying the set of RS resources. The resource set ID in each of the RS configuration(s) indicates a particular set of RS resource(s) used for automatic gain control (AGC) adjustment and/or time/frequency synchronization with an SpCell. In some implementations, the set of RS resources includes at least one non-zero power (NZP) RS resource (e.g., NZP CSI-RS resource) in at least one slot. For example, a set of RS resources includes four non-zero power NZP CSI-RS resources two consecutive slots with two NZP CSI-RS resources in each slot. In some implementations, RS(s) associated with a set of the RS resources are located in a bandwidth part (BWP) addressed by a BWP ID (e.g., firstActiveDownlinkBWP-Id). The first RAN node, the second RAN node, or the CU transmits a BWP configuration configuring the BWP and BWP ID to the UE.

In some implementations, the QCL information (e.g., qcl-Info, qcl-Info-v1800 or qcl-Info-r18) references to a TCI-State for providing the QCL source and QCL type for each RS resource (e.g., NZP-CSI-RS-Resource) in a resource configuration (e.g., NZP-CSI-RS-Resources) in a resource set (e.g., NZP-CSI-RS-ResourceSet) indicated by the resource set ID. The QCL information includes a TCI state ID (e.g., TCI-StateId) that refers to a transmission control indicator (TCI) state configuration (e.g., TCI-State) identified by the TCI state ID. In some implementations, the first RAN node, the second RAN node, or the CU transmits the TCI state configuration, configuring the TCI state and including the TCI state ID, to the UE. In further implementations, the first RAN node, the second RAN node, or the CU transmits a list of TCI state configurations (e.g., tciStatesToAddModList) to the UE. Each of the TCI state configurations includes a TCI state ID.

In FIGS. 13A and 13C, in some implementations, the non-LTM command includes an RS configuration ID to order the UE to start receiving RS(s) configured in an RS configuration identified by the RS configuration ID. When the UE revives the non-LTM command, the UE identifies an RS configuration based on the RS configuration ID and starts receiving RS(s) in the RS configuration identified by the RS configuration ID, in response to the non-LTM command. In some such cases, the non-LTM command is a TRS activation command. In some implementations, the LTM command in FIGS. 13B and 13D includes an RS configuration ID to order the UE to start receiving RS(s) configured in an RS configuration identified by the RS configuration ID. When the UE receives the LTM command, the UE identifies an RS configuration based on the RS configuration ID and starts receiving RS(s) in the RS configuration in response to the LTM command.

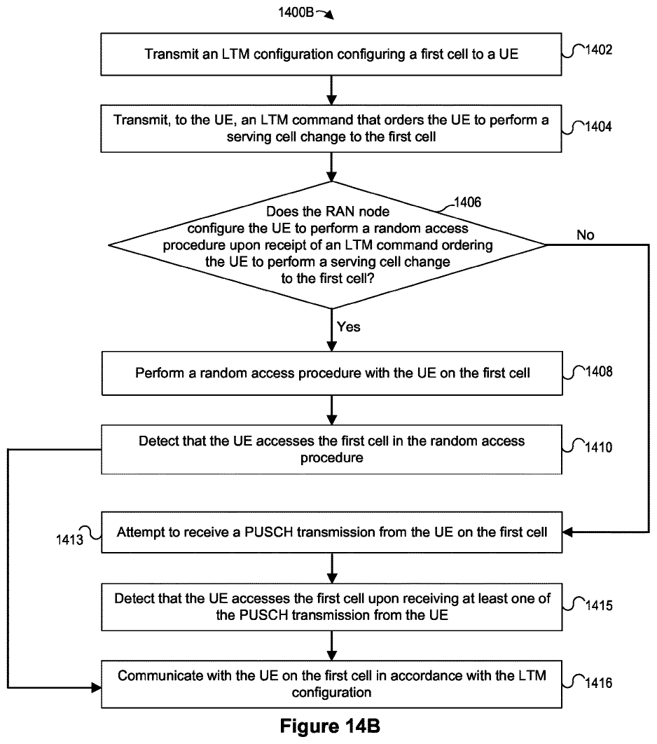

FIG. 14A illustrates an example method 1400A, which a RAN node (e.g., the base station 104 or 106, the DU 174 of the base station 104 or 106, or the S-DU 174A, T-DU 174B, M-DU 174A, S-DU 174B, or T-DU 174C) can implement, for configuring and triggering LTM with a UE (e.g., the UE 102).

The method 1400A begins at block 1402, where the RAN node transmits an LTM configuration configuring a first cell to the UE (e.g., events 316, 318, 394, 380, 480, 494, 580, 594, 581, 517, 519, 582, 680, 694, 681, 617, 619, 682, 780, 794, 781, 717, 719, 782, 880, 894, 881, 817, 819, 882). At block 1404, the RAN node transmits, to the UE, an LTM command that orders the UE to perform a serving cell change to the first cell (e.g., events 330, 380, 480, 430, 580, 530, 581, 582, 680, 630, 681, 682, 780, 730, 781, 782, 880, 830, 881, 882). At block 1406, the RAN node determines whether the RAN node configures the UE to perform a random access procedure upon receipt of an LTM command ordering the UE not to perform a serving cell change to the first cell. If the RAN node at block 1406 determines that the RAN node configures the UE to perform a random access procedure upon receipt of an LTM command ordering the UE not to perform a serving cell change to the first cell, the flow proceeds to block 1408. At block 1408, the RAN node performs a random access procedure with the UE on the first cell. At block 1410, the RAN node detects that the UE accesses the first cell in the random access procedure. Otherwise, if the RAN node at block 1406 determines that the RAN node configures the UE not to perform a random access procedure upon receipt of an LTM command ordering the UE not to perform a serving cell change to the first cell, the flow proceeds to block 1412. At block 1412, the RAN node attempts to receive a PUCCH transmission from the UE on the first cell. In some implementations, the RAN node attempts to receive a PUCCH transmission from the UE on the first cell after transmitting the LTM configuration or transmitting LTM command. At block 1414, the RAN node detects that the UE accesses the first cell upon receiving the PUCCH transmission from the UE. The flow proceeds to block 1416 from block 1412 as well as block 1414. At block 1416, the RAN node communicates with the UE on the first cell in accordance with the LTM configuration.

In some implementations, the RAN node receives an ID of the UE in the random access at block 1408. Upon receiving the ID, the RAN detects that the UE accesses the first cell. In some implementations, the RAN node includes or configures the ID in the LTM configuration. In some implementations, the ID is a dedicated preamble, and the RAN node receives the dedicated preamble in the random access procedure. In further implementations, the ID is a C-RNTI of the UE, and the RAN node receives the C-RNTI in a Message A or Message 3 in the random access procedure.

In some implementations, the RAN node attempts to receive the PUCCH transmission from the UE on PUCCH resource(s) on the first cell at block 1412. In some implementations, the RAN node includes configuration parameters configuring the PUCCH resources in the LTM configuration. After (e.g., in response to) receiving the LTM command, the UE transmits PUCCH transmission(s) on the PUCCH resource(s) in accordance with the configuration parameters. In other implementations, the RAN node transmits one or more DCIs on PDCCH(s) to the UE on the first cell, after transmitting the LTM configuration or transmitting the LTM command. The one or more DCIs assigns or configures the PUCCH resources. After (e.g., in response to) receiving the LTM command, the UE transmits PUCCH transmission(s) on the PUCCH resources in accordance with the one or more DCIs. If the RAN node receives one of the PUCCH transmission(s) on the PUCCH resource(s), the RAN node detects that the UE accesses the first cell.

FIG. 14B is a flow diagram of an example method 1400B similar to the method 1400A, except that the method 1400B includes blocks 1413 and 1415 instead of blocks 1412 and 1414. At block 1413, the RAN node attempts to receive a PUSCH transmission from the UE on the first cell. In some implementations, the RAN node attempts to receive a PUSCH transmission from the UE on the first cell after transmitting the LTM configuration or transmitting LTM command. At block 1415, the RAN node detects that the UE accesses the first cell upon receiving the PUSCH transmission from the UE. The flow proceeds to block 1416 from block 1413 as well as block 1415.

In some implementations, the RAN node attempts to receive the PUSCH transmission from the UE on PUSCH resource(s) on the first cell at block 1413. In some implementations, the RAN node includes configuration parameters configuring the PUSCH resources in the LTM configuration. After (e.g., in response to) receiving the LTM command, the UE transmits PUSCH transmission(s) on the PUSCH resource(s) in accordance with the configuration parameters. In other implementations, the RAN node transmits one or more DCIs on PDCCH(s) to the UE on the first cell, after transmitting the LTM configuration or transmitting the LTM command. The one or more DCIs assigns or configures the PUSCH resources. After (e.g., in response to) receiving the LTM command, the UE transmits PUSCH transmission(s) on the PUSCH resources in accordance with the one or more DCIs. If the RAN node receives one of the PUSCH transmission(s) on the PUSCH resource(s), the RAN node detects that the UE accesses the first cell.

Examples and implementations described for FIGS. 9A-9F and FIGS. 12A-12F can apply to FIGS. 14A-14B.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, the “LTM command” can be replaced by “serving cell change command”, “Layer 1/Layer 2 switching command”, “lower layer switching command” or “lower layer serving cell change command”. In some implementations, “some” means “one or more”. In some implementations, “at least one” means “one or more”. In some implementations, the “DU configuration” can be replaced by “cell group configuration”. In some implementations, the “cell index” can be replaced with “candidate cell index”, “serving cell index”, “LTM cell index”, “special cell (SpCell) index”, “PCell index” or “PSCell index”. In some implementations, the “cell ID” can be replaced with a name such as “candidate cell ID”, “serving cell ID”, “SpCell ID”, “LTM cell ID”, “PCell ID” or “PSCell ID”. In some implementations, the “cell ID” in a CU-to-DU message and the “cell ID” can be replaced with different names listed above.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method implemented in a radio access network (RAN) node, the method comprising:
transmitting, to a user equipment (UE) communicatively coupled to the RAN node via a serving cell, a lower layer triggered mobility (LTM) configuration to configure a non-serving cell for the UE;
determining whether the UE supports LTM without a random access procedure;
in a first instance, when the non-serving cell is synchronized with the serving cell:
transmitting, to the UE, a first indication for the UE to perform a serving cell change to the non-serving cell and refrain from performing a random access procedure, and
receiving a physical uplink shared channel transmission from the UE when the UE is to refrain from performing the random access procedure; and
in a second instance, when the non-serving cell is not synchronized with the serving cell:
transmitting, to the UE, a second indication for the UE to perform the serving cell change and perform the random access procedure.

2. The method of claim 1, wherein:
the first indication is a first LTM indication; and
the second indication is a second LTM indication.

3. The method of claim 1, wherein:
the first indication is a first LTM command; and
the second indication is a second LTM command.

4. The method of claim 1 wherein:
the LTM configuration includes a reconfiguration with sync configuration.

5. The method of claim 4, wherein:
the reconfiguration with sync configuration is a Reconfiguration WithSync information element (IE).

6. The method of claim 1 wherein the determining whether the UE supports LTM without a random access procedure includes:
receiving, from the UE, a capability indication of whether the UE supports LTM without a random access procedure.

7. The method of claim 6, wherein:
the transmitting the first indication is responsive to determining that the UE supports LTM without a random access procedure.

8. (canceled)

9. The method of claim 1, further comprising:
receiving a physical uplink control channel transmission from the UE when the UE is to refrain from performing the random access procedure.

10. (canceled)

11. A method implemented in a user equipment (UE), the method comprising:
receiving, at the UE from a radio access network (RAN) node communicatively coupled to UE via a serving cell, a lower layer triggered mobility (LTM) configuration to configure a non-serving cell for the UE;
transmitting an indication of whether the UE supports LTM without a random access procedure;
in a first instance, when the non-serving cell is synchronized with the serving cell:
receiving, from the RAN node, a first indication to perform a serving cell change to the non-serving cell and refrain from performing a random access procedure, and
transmitting a physical uplink shared channel transmission to the RAN node when the UE is to refrain from performing the random access procedure; and
in a second instance, when the non-serving cell is not synchronized with the serving cell;
receiving, from the RAN node, a second indication to perform the serving cell change and perform the random access procedure.

12. The method of claim 11, wherein:
the first indication is a first LTM indication; and
the second indication is a second LTM indication.

13. The method of claim 11, wherein:
the first indication is a first LTM command; and
the second indication is a second LTM command.

14. The method of claim 11, wherein:
the LTM configuration includes a reconfiguration with sync configuration.

15. (canceled)

16. An apparatus, operating as a radio access network (RAN) node, comprising:
processing hardware configured to:
transmit, to a user equipment (UE) communicatively coupled to the RAN node via a serving cell, a lower layer triggered mobility (LTM) configuration to configure a non-serving cell for the UE;
determine whether the UE supports LTM without a random access procedure;
in a first instance, when the non-serving cell is synchronized with the serving cell:
transmit, to the UE, a first indication for the UE to perform a serving cell change to the non-serving cell and refrain from performing a random access procedure, and
receive a physical uplink shared channel transmission from the UE when the UE is to refrain from performing the random access procedure; and
in a second instance, when the non-serving cell is not synchronized with the serving cell:
transmit, to the UE, a second indication for the UE to perform the serving cell change and perform the random access procedure

17. The apparatus of claim 16, wherein:
the first indication is a first LTM indication; and
the second indication is a second LTM indication.

18. The apparatus of claim 16, wherein:
the first indication is a first LTM command; and
the second indication is a second LTM command.

19. The apparatus of claim 16, wherein:
the LTM configuration includes a reconfiguration with sync configuration.

20. The apparatus of claim 19, wherein:
the reconfiguration with sync configuration is a Reconfiguration WithSync information element (IE).

21. The apparatus of claim 16, wherein the processing hardware configured to determine whether the UE supports LTM without a random access procedure is further configured to:
receive, from the UE, a capability indication of whether the UE supports LTM without a random access procedure.

22. The apparatus of claim 21, wherein the processing hardware configured to transmit the first indication is further configured to:
transmit the first indication responsive to determining that the UE supports LTM without a random access procedure.

23. The apparatus of claim 16, wherein the processing hardware is further configured to:
receive a physical uplink control channel transmission from the UE when the UE is to refrain from performing the random access procedure.
